(19) United States
(12) Patent Application Publication
(10) Pub. No.: US 2026/0025414 A1
(43) Pub. Date: Jan. 22, 2026

(54) DATA PROCESSING SYSTEMS AND METHODS FOR PERFORMING ASSESSMENTS AND MONITORING OF NEW VERSIONS OF COMPUTER CODE FOR COMPLIANCE

(71) Applicant: OneTrust, LLC, Atlanta, GA (US)

(72) Inventors: Kabir A. Barday, Atlanta, GA (US); Mihir S. Karanjkar, Marietta, GA (US); Steven W. Finch, Kennesaw, GA (US); Ken A. Browne, Johns Creek, GA (US); Aakash H. Patel, Norcross, GA (US); Jason L. Sabourin, Brookhaven, GA (US); Richard L. Daniel, Atlanta, GA (US); Dylan D. Patton-Kuhl, Atlanta, GA (US); Jonathan Blake Brannon, Smyrna, GA (US)

(21) Appl. No.: 19/256,898

(22) Filed: Jul. 1, 2025

Related U.S. Application Data
(63) Continuation of application No. 17/749,732, filed on May 20, 2022, now Pat. No. 12,381,915.
Application No. 17/749,732 is a continuation-in-part of application No. 17/334,948, filed on May 31, 2021, now Pat. No. 11,343,284.
Application No. 17/334,948 is a continuation-in-part of application No. 17/034,355, filed on Sep. 28, 2020, now Pat. No. 11,025,675.
Application No. 17/034,355 is a continuation-in-part of application No. 16/798,818, filed on Feb. 24, 2020, now Pat. No. 10,791,150.
Application No. 16/798,818 is a continuation of application No. 16/404,405, filed on May 6, 2019, now Pat. No. 10,574,705.
Application No. 16/404,405 is a continuation of application No. 16/041,468, filed on Jul. 20, 2018, now Pat. No. 10,284,604.
Application No. 16/041,468 is a continuation-in-part of application No. 15/883,041, filed on Jan. 29, 2018, now Pat. No. 10,158,676.
Application No. 15/883,041 is a continuation of application No. 15/671,073, filed on Aug. 7, 2017, now Pat. No. 9,882,935.
Application No. 15/671,073 is a division of application No. 15/254,901, filed on Sep. 1, 2016, now Pat. No. 9,729,583.
(60) Provisional application No. 62/348,695, filed on Jun. 10, 2016.
(60) Provisional application No. 62/353,802, filed on Jun. 23, 2016.
(60) Provisional application No. 62/360,123, filed on Jul. 8, 2016.
(60) Provisional application No. 62/537,839, filed on Jul. 27, 2017.

(51) Int. Cl. H04L 9/40; G06Q 10/06

(52) U.S. Cl. CPC H04L 63/20; G06Q 10/06; H04L 63/04

(57) ABSTRACT

In various embodiments, a data map generation system is configured to receive a request to generate a privacy-related data map for particular computer code, and, at least partially in response to the request, determine a location of the particular computer code, automatically obtain the particular computer code based on the determined location, and analyze the particular computer code to determine privacy-related attributes of the particular computer code, where the privacy-related attributes indicate types of personal information that the particular computer code collects or accesses. The system may be further configured to generate and display a data map of the privacy-related attributes to a user.

### CROSS-REFERENCE TO RELATED APPLICATIONS

This application is a continuation of U.S. patent application Ser. No. 17/749,732, filed May 20, 2022, which is a continuation-in-part of U.S. patent application Ser. No. 17/334,948, filed May 31, 2021, now U.S. Pat. No. 11,343,284 issued May 24, 2022, which is a continuation-in-part of U.S. patent application Ser. No. 17/034,355, filed Sep. 28, 2020, now U.S. Pat. No. 11,025,675, issued Jun. 1, 2021, which is a continuation-in-part of U.S. patent application Ser. No. 16/798,818, filed Feb. 24, 2020, now U.S. Pat. No. 10,791,150, issued Sep. 29, 2020, which is a continuation of U.S. patent application Ser. No. 16/404,405, filed May 6, 2019, now U.S. Pat. No. 10,574,705, issued Feb. 25, 2020, which is a continuation of U.S. patent application Ser. No. 16/041,468, filed Jul. 20, 2018, now U.S. Pat. No. 10,284,604, issued May 7, 2019, which claims priority from U.S. Provisional Patent Application Ser. No. 62/537,839, filed Jul. 27, 2017, and is also a continuation-in-part of U.S. patent application Ser. No. 15/883,041, filed Jan. 29, 2018, now U.S. Pat. No. 10,158,676, issued Dec. 18, 2018, which is a continuation of U.S. patent application Ser. No. 15/671,073, filed Aug. 7, 2017, now U.S. Pat. No. 9,882,935, issued Jan. 30, 2018, which is a divisional of U.S. patent application Ser. No. 15/254,901, filed Sep. 1, 2016, now U.S. Pat. No. 9,729,583, issued Aug. 8, 2017, which claims priority from U.S. Provisional Patent Application Ser. No. 62/360,123, filed Jul. 8, 2016; U.S. Provisional Patent Application Ser. No. 62/353,802, filed Jun. 23, 2016; and U.S. Provisional Patent Application Ser. No. 62/348,695, filed Jun. 10, 2016. The disclosures of all of the above patents and patent applications are hereby incorporated herein by reference in their entirety.

### TECHNICAL FIELD

This disclosure relates to data processing systems and methods for performing assessments and monitoring new versions of computer code for updated features and conditions that relate to compliance with policies, regulations, and/or standards related to privacy aspects, responsible artificial intelligence (AI) aspects, and/or the like.

### BACKGROUND

Over the past years, policies, regulations, and standards related to privacy and security concerns and concerns of using AI in a manner that is considered unfair and/or unethical, and related operations have become increasingly important. For example, breaches in security, leading to the unauthorized access of personal data (which may include sensitive personal data) have become more frequent among companies and organizations of all sizes. Such personal data may include, but is not limited to, personally identifiable information (PII), which may be information that directly (or indirectly) identifies an individual or entity. Examples of PII include names, addresses, dates of birth, social security numbers, and biometric identifiers such as a person's fingerprints or picture. Other personal data may include, for example, customers' Internet browsing habits, purchase history, or even their preferences (i.e., likes and dislikes, as provided or obtained through social media). While not all personal data may be sensitive, in the wrong hands, this kind of information may have a negative impact on the individuals or entities whose sensitive personal data is collected, including identity theft and embarrassment. Not only would a breach have the potential of exposing individuals to malicious wrongdoing, fallout from the breach may also result in damage to reputation, potential liability, and costly remedial action for the organizations who collected the information and were under an obligation to maintain its confidentiality and security.

As another example, many organizations have incorporated AI (e.g., AI functionality) to interface with customers or other users in a variety of ways. As a specific example, an organization may provide AI on its website in the form of a chatbot to conduct online chat sessions with customers visiting the website to purchase a product. However, introduction of AI for certain applications can be considered unfair and/or unethical. For example, introduction of AI that performs biometric identification in public areas is considered by many as an unethical use of such technology. In addition, introduction of bias into AI can lead to the AI producing inaccurate results and/or causing computing systems, devices, or other systems that rely on AI outputs to function incorrect and/or operate in a manner that is unsuitable for their intended purpose. Accordingly, fallout of operating AI under such circumstances can result in mistrust of its use, damage to reputation, potential liability, and costly remedial action for the organizations.

As a result, many organizations have begun to address these issues. For example, to manage personal data, many organizations have attempted to implement operational policies and processes that comply with legal requirements, such as Canada's Personal Information Protection and Electronic Documents Act (PIPEDA) or the U.S.'s Health Insurance Portability and Accountability Act (HIPPA) protecting a patient's medical information. For many companies handling personal data, privacy audits, whether performed according to AICPA Generally Accepted Privacy Principles or ISACA's IT Standards, Guidelines, and Tools and Techniques for Audit Assurance and Control Professionals, are not just a best practice but are a requirement. The same can be said with many organizations' use of AI that can leave many organizations' systems vulnerable to unacceptable, undesired, unfair, and/or unethical use of such functionality.

However, lack of transparency or clarity into where personal data comes from and/or where it is stored or transferred, who is developing AI (e.g., AI functionality) and how, who is using personal data and/or AI, and for what purpose is personal data and/or AI being used, can oftentimes bog down many conventional audit (e.g., compliance and/or adequacy audit) practices, processes, and the like and can leave many organizations' systems vulnerable to privacy-related data incidents such as data breaches, as well as vulnerable to unintended, undesired, unfair, unethical, and/or misuse of AI. Accordingly, many of these vulnerabilities can be rooted in vulnerabilities found in software code utilized by these organizations for privacy and/or AI related purposes.

In light of the above, there is currently a need for improved systems and methods for assessing computer code such as, for example, mobile applications, websites, and other computer code for features and conditions that may have an impact on a company's compliance with various policies, regulations, and/or standards related to privacy and responsible AI use, as well as an impact on creating vulnerabilities to privacy-related incidents and/or use of AI in an unintended, undesired, unfair, and/or unethical manner.

### SUMMARY

In general, various aspects of the present disclosure provide methods, apparatuses, systems, computing devices, computing entities, and/or the like for gathering information for new functionality introduced into a new instance of computer code. In accordance with various aspects, a method is provided that comprises: monitoring, by computing hardware, a location where computer code is located; identifying, by the computing hardware, a new instance of the computer code at the location; comparing, by the computing hardware, the new instance of the computer code with a previous instance of the computer code to identify a change has been made to the computer code; responsive to identifying the change, analyzing, by the computing hardware, the new instance of the computer code to determine an attribute of the new instance of the computer code, wherein the attribute identifies new functionality that the new instance of the computer code performs over the previous instance of the computer code; providing, by the computing hardware, a graphical user interface for display, wherein the graphical user interface is configured to prompt for information regarding the new functionality; and communicating, by the computing hardware, the information regarding the new functionality for use in conducting an assessment of the computer code.

In some aspects, the new functionality is configured to perform at least one of (i) collecting or accessing personal data or (ii) artificial intelligence. In some aspects, analyzing the new instance of the computer code to determine the attribute comprises detecting use by the computer code of at least one of a location-based capability to detect a location of a user computing device, an encryption capability, a call to third party computer code, a communication log, or a cookie to track user behavior. In some aspects, analyzing the new instance of the computer code to determine the attribute comprises detecting performance by the computer code of at least one of an image analysis, speech recognition, use of a machine-learning algorithm, pattern recognition, or voice-to-text conversion.

In some aspects, the information identifies at least one of a reason or purpose for the new functionality, data that is used in training the new functionality, a procedure used in maintaining the new functionality, or a procedure used in monitoring a performance of the new functionality. In some aspects, the method further comprises: determining, by the computing hardware and based on the information, at least one of a type of the personal data or a type of the artificial intelligence; and determining, by the computing hardware and based on at least one of the type of the personal data or the type of the artificial intelligence, a risk rating associated with the computer code performing the new functionality, wherein the risk rating is communicated along with the information. In some aspects, the risk rating provides a measure of the computer code performing the new functionality in at least one of an unintended manner, an undesired manner, or an inappropriate manner as defined by an entity associated with the computer code.

In accordance with various aspects, a system is provided comprising a non-transitory computer-readable medium storing instructions and a processing device communicatively coupled to the non-transitory computer-readable medium. In particular aspects, the processing device is configured to execute the instructions and thereby perform operations that, upon a new instance of a computer code being identified at a location being monitored where the computer code is located, comprise: comparing the new instance of the computer code with a previous instance of the computer code to identify a change has been made to the computer code; responsive to identifying the change, analyzing the new instance of the computer code to determine an attribute of the new instance of the computer code, wherein the attribute identifies new functionality that the new instance of the computer code performs over the previous instance of the computer code; providing a graphical user interface for display, wherein the graphical user interface is configured to prompt for information regarding the new functionality; and communicating the information regarding the new functionality for use in conducting an assessment of the computer code.

In some aspects, the new functionality is configured to perform at least one of (i) collecting or accessing personal data or (ii) artificial intelligence. In some aspects, analyzing the new instance of the computer code to determine the attribute comprises detecting use by the computer code of at least one of a location-based capability to detect a location of a user computing device, an encryption capability, a call to third party computer code, a communication log, or a cookie to track user behavior. In some aspects, analyzing the new instance of the computer code to determine the attribute comprises detecting performance by the computer code of at least one of an image analysis, speech recognition, use of a machine-learning algorithm, pattern recognition, or voice-to-text conversion.

In some aspects, the information identifies at least one of a reason or purpose for the new functionality, data that is used in training the new functionality, a procedure used in maintaining the new functionality, or a procedure used in monitoring a performance of the new functionality. In some aspects, the operations further comprise: determining, based on the information, at least one of a type of the personal data or a type of the artificial intelligence; and determining, based on at least one of the type of the personal data or the type of the artificial intelligence, a risk rating associated with the computer code performing the new functionality, wherein the risk rating is communicated along with the information. In some aspects, the risk rating provides a measure of the computer code performing the new functionality in at least one of an unintended manner, an undesired manner, or an inappropriate manner as defined by an entity associated with the computer code.

In addition in accordance with various aspects, a non-transitory computer-readable medium having program code that is stored thereon. In particular aspects, the program code is executable by one or more processing devices and performs operations that, upon a new instance of a computer code being identified at a location being monitored where the computer code is located, comprise: comparing the new instance of the computer code with a previous instance of the computer code to identify a change has been made to the computer code; responsive to identifying the change, analyzing the new instance of the computer code to determine an attribute of the new instance of the computer code, wherein the attribute identifies new functionality that the new instance of the computer code performs over the previous instance of the computer code; providing a graphical user interface for display, wherein the graphical user interface is configured to prompt for information regarding the new functionality; and communicating the information regarding the new functionality for use in conducting an assessment of the computer code.

In some aspects, the new functionality is configured to perform at least one of (i) collecting or accessing personal data or (ii) artificial intelligence. In some aspects, analyzing the new instance of the computer code to determine the attribute comprises detecting use by the computer code of at least one of a location-based capability to detect a location of a user computing device, an encryption capability, a call to third party computer code, a communication log, or a cookie to track user behavior. In some aspects, analyzing the new instance of the computer code to determine the attribute comprises detecting performance by the computer code of at least one of an image analysis, speech recognition, use of a machine-learning algorithm, pattern recognition, or voice-to-text conversion.

In some aspects, the information identifies at least one of a reason or purpose for the new functionality, data that is used in training the new functionality, a procedure used in maintaining the new functionality, or a procedure used in monitoring a performance of the new functionality. In some aspects, the operations further comprise: determining, based on the information, at least one of a type of the personal data or a type of the artificial intelligence; and determining, based on at least one of the type of the personal data or the type of the artificial intelligence, a risk rating associated with the computer code performing the new functionality, wherein the risk rating is communicated along with the information.

### BRIEF DESCRIPTION OF THE DRAWINGS

Various embodiments of a system and method for operationalizing privacy compliance and assessing risk of privacy campaigns are described below. In the course of this description, reference will be made to the accompanying drawings, which are not necessarily drawn to scale, and wherein:

FIG. 1 is a diagram illustrating an exemplary network environment in which various embodiments of the present system and methods for operationalizing compliance may operate.

FIG. 2 is a schematic diagram of a computer (such as the server 120, or user device 140, 150, 160, 170, 180, 190) that is suitable for use in various embodiments.

FIG. 3 is a diagram illustrating an example of the different types of individuals that may be involved in compliance.

FIG. 4 is a flow chart showing an example of a process for performed by the Main Compliance Module.

FIG. 5 is a flow chart showing an example of a process for performed by the Risk Assessment Module.

FIG. 6 is a flow chart showing an example of a process for performed by the Audit Module.

FIG. 7 is a flow chart showing an example of a process for performed by the Data Flow Diagram Module.

FIG. 8 is an example of a GUI showing a dialog that allows for entry of description information related to a privacy campaign.

FIG. 9 shows example of a notification that a business representative (e.g., owner) related to his/her assignment of a campaign.

FIG. 10 is an example of a GUI showing a dialog allows entry of the type of personal data that is being collected for a campaign.

FIG. 11 is an example of a GUI that shows a dialog that allows collection of campaign data regarding the subject from whom the personal data was collected.

FIG. 12 is an example of a GUI that shows a dialog for inputting information regarding where the personal data related to a campaign is stored.

FIG. 13 is an example of a GUI that shows information regarding the access of the personal data related to a campaign.

FIG. 14 is an example of an instant messaging session overlaid on top of a GUI, wherein the GUI contains prompts for the entry or selection of campaign data.

FIG. 15 is an example of a graphical user interface (GUI) showing an inventory page.

FIG. 16 is an example of a GUI showing campaign data, including a data flow diagram.

FIG. 17 is an example of a GUI showing a page that allows editing of campaign data.

FIG. 18 is a flow chart showing an example of a process performed by the system's Assessment Module.

FIG. 19 is a flow chart showing an example of a process performed by the system's Monitoring Module.

FIG. 20A is an example of a graphical user interface that shows the identification of the location of computer code.

FIG. 20B is an example of a graphical user interface that shows the identification of the location of computer code the results of an assessment.

FIG. 21 is an example of a graphical user interface that shows the results of the ongoing monitoring of computer code.

FIG. 22 depicts a data model generation and population system according to particular embodiments.

FIG. 23 is a schematic diagram of a computer (such as the data model generation server 2210, or data model population server 2220) that is suitable for use in various embodiments of the data model generation and population system shown in FIG. 22.

FIG. 24 is a flowchart showing an example of steps performed by a Data Model Generation Module according to particular embodiments.

FIGS. 25-31 depict various exemplary visual representations of data models according to particular embodiments.

FIG. 32 is a flowchart showing an example of steps performed by a Data Model Population Module.

FIG. 33 is a flowchart showing an example of steps performed by a Data Population Questionnaire Generation Module.

FIG. 34 is a process flow for populating a data inventory according to a particular embodiment using one or more data mapping techniques.

FIGS. 35-46 depict exemplary screen displays and graphical user interfaces (GUIs) according to various embodiments of the system, which may display information associated with the system or enable access to, or interaction with, the system by one or more users (e.g., to configure a questionnaire for populating one or more inventory attributes for one or more data models, complete one or more assessments, etc.).

FIG. 47 is a flowchart showing an example of steps performed by an Intelligent Identity Scanning Module.

FIG. 48 is schematic diagram of network architecture for an intelligent identity scanning system according to a particular embodiment.

FIG. 49 is a schematic diagram of an asset access methodology utilized by an intelligent identity scanning system in various embodiments of the system.

FIG. 50 is a flowchart showing an example of a processes performed by a Data Subject Access Request Fulfillment Module according to various embodiments.

FIGS. 51-52 depict exemplary screen displays and graphical user interfaces (GUIs) according to various embodiments of the system, which may display information associated with the system or enable access to, or interaction with, the system by one or more users (e.g., for the purpose of submitting a data subject access request or other suitable request).

FIGS. 53-56 depict exemplary screen displays and graphical user interfaces (GUIs) according to various embodiments of the system, which may display information associated with the system or enable access to, or interaction with, the system by one or more users (e.g., for the purpose of flagging one or more risks associated with one or more particular questionnaire questions).

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview and Technical Contributions of Various Embodiments

As previously mentioned, many organizations that obtain, use, stored, transfer, and/or the like personal data, including sensitive personal data, have begun to address privacy and security concerns associated with handling such data. Likewise, many organizations that have implemented AI in conducting business have begun to address concerns with operating such functionality in a responsible manner. For example, to manage personal data, many companies have attempted to implement operational policies and processes that comply with legal requirements such as, for example, PIPEDA or HIPPA. However, when the time comes to perform audits related to the use of personal data and/or the use of AI, the lack of transparency or clarity into where personal data comes from, where personal data is stored or transferred, where AI is being employed, who is using the personal data and/or AI, and for what purpose is the personal data and/or AI being used, oftentimes results in bogging down many conventional audit processes. Accordingly, inadequate audits can lead to these organizations with systems that are vulnerable to privacy-related data incidents (e.g., data breach) and/or operating in an unintended and/or undesirable manner.

Many of these issues are rooted in vulnerabilities that are found in software applications, websites, and/or other computer code that involves the use of personal data and/or AI (e.g., AI functionality). Accordingly, such computer code may be, for example, an in-house application or solution or one provided by a third party. When an organization's auditors conduct an audit or assessment, they typically direct questions to individuals such as software developers, systems engineers, network administrators, and/or the like in an attempt to obtain answers they need to address compliance with any applicable standards and to identify any potential vulnerabilities to privacy-related data incidents and/or use of AI that may result in operation of the AI in an unintended, undesired, and/or inappropriate (e.g., unfair and/or unethical) manner that may exist with respect to using the computer code. Unfortunately, auditors and developers, systems engineers, network administrators, and/or the like do not always use the same vernacular or technical language. For example, an auditor might ask a developer, “list for me all the personal data that you collect,” or “are you using any third-party code?” The developer, when responding, might not understand, for example, that a user's Internet Protocol (IP) address is considered personal data, especially according to various laws. In addition, the developer might not understand that third party code includes, for example, snippets of HTML for a hosted library from Google's hosted library, or the use of other software development kits (SDKs) may introduce AI functionality being performed in the background. With multitudes of questions during the audit process, the disconnect or language barrier may lead to vulnerabilities. Thus, auditors may ask a multitude of questions, but the disconnect from the language barrier might not lead to the identification or resolution of many privacy-related and/or AI-related issues because the auditors are not obtaining the right answers to those questions.

Furthermore, changes may be made to computer code once the code has been implemented that can lead to noncompliant and/or improperly functioning systems, as well as create vulnerabilities in such systems to experiencing privacy-related data incidents and/or use of AI that results in operating the AI in an unintended, undesired, and/or inappropriate manner. For instance, the layout of a website for an organization may be rearranged at the request of the marketing department to better align the website with marketing goals. For example, the marketing department may request to have a tracking mechanism (e.g., cookie) incorporated into the website to track visitors' movements around the website so that the marketing department can evaluate what advertising placed on the website is generating more traffic. However, the marketing department may not realize that tracking visitors' movements (behavior) can be viewed as collecting personal data under certain privacy standards and/or regulations. Therefore, the marketing department's incorporation of the tracking mechanism into the website without providing visitors with an option to not have their movements track (e.g., opt-out) can create liability for the organization (without the knowledge of proper personnel such as a privacy officer) in that the organization can be viewed as not operating the website in conformance with the applicable privacy standards and/or regulations.

In another instance, an organization may be making use of a data management application to transfer data to various systems, storage (e.g., repositories), and/or the like that the organization collects from customers. In this instance, some of the collected data may be viewed as personal data. For example, the organization may be collecting home addresses of customers that are used for shipping online purchases made by the customers, as well as credit card information of the customers who make the purchases. Here, the organization may decide to warehouse some of the products with a third-party vendor who is then responsible for the actual shipment of the products to customers once purchased. As a result, a developer in the company may update (change) the data management application to transfer the addresses of customers who have purchased the products warehoused by the vendor to a system of the vendor so that the vendor can then ship the purchased products to the customers. However, the transfer of addresses may be made over an unsecured network or the vendor's system may not have the proper mechanisms in place to securely store the addresses. Therefore, as a result, the change made to the data management application may create a vulnerability to a potential occurrence of a privacy-related data incident for the organization. Even worse, the vulnerability (which is likely unintentional) may have been created without the knowledge of the proper personnel (e.g., privacy officer) for the organization.

Yet, in another instance, an organization may provide AI on its website in the form of a chatbot to conduct online chat sessions with customers visiting the website to purchase a product. Here, the chatbot may be configured to generate responses (e.g., predicting responses) to answer questions asked by customers through the chat sessions to mimic agents (e.g., humans) conducting the chats with the customers. However, a developer may not appreciate that certain precautions should be taken in training the machine-learning algorithm used by the chatbot in generating the responses as to ensure not to introduce bias into the chatbot. For example, the developer should take precautions to ensure that an unbiased data set is used in training the machine-learning algorithm. Training the machine-learning algorithm using a biased data set can lead to an improperly trained and/or configured machine-learning algorithm, which can lead to errors in the performance of the AI functionality. That is to say, an improperly trained and/or configured machine-learning algorithm can lead to generating incorrect and/or inaccurate results (output) that are then applied by the chatbot, resulting in the chatbot operating in a manner that may be unintended, undesired, and/or inappropriate.

Accordingly, various embodiments of present disclosure overcome many of the technical challenges associated with monitoring compliance with policies, regulations, and/or standards applicable to privacy and/or AI use, as well as ensuring vulnerabilities to privacy-related data incidents and/or vulnerabilities to AI misuse are addressed appropriately as described above. Specifically, various embodiments of the disclosure involve a system for operationalizing compliance that comprises one or more servers and client computing devices configured for executing software modules to facilitate various functions to address these technical challenges.

For instance, various embodiments involve the use of a Main Compliance Module. In these particular embodiments, the Main Compliance Module is operable to allow a user to initiate the creation of a campaign that may involve the use of personal data and/or AI (i.e., a business function, system, product, technology, process, project, engagement, initiative, campaign, etc., that may utilize personal data collected from one or more persons or entities and/or utilize AI in providing certain functionality). The user can input information such as the name and description of the campaign. The user may also select whether he/she will take ownership of the campaign (i.e., be responsible for providing the information needed to create the campaign and oversee the conducting of audits related to the campaign), or assign the campaign to one or more other persons. The Main Compliance Module can generate a sequence or series of GUI windows that facilitate the entry of campaign data representative of attributes related to the campaign (e.g., attributes that might relate to the description of the personal data or AI, what personal data is collected, stored, and/or accessed, what output is generated via the AI, whom the data is collected from or is using the AI, etc.).

Based on the information input, a Risk Assessment Module may be operable to take into account Weighting Factors and Relative Risk Ratings associated with the campaign in order to calculate a numerical Risk Level associated with the campaign, as well as an Overall Risk Assessment for the campaign (e.g., low-risk, medium risk, or high risk). For example, the Risk Level may be indicative of the likelihood of a privacy-related incident occurring that involves personal data related to the campaign being compromised (e.g., lost, stolen, accessed without authorization, inadvertently disclosed, maliciously disclosed, etc.). In another example, the Risk Level may be indicative of the AI being used in an unintended, undesired, and/or inappropriate manner. Here, the entity conducting the campaign may identify what constitutes an unintended, undesired, and/or inappropriate use of AI. For example, the entity may identify that using AI functionality that recognizes individuals in a public setting, such as a store, may be viewed as an undesired (unethical) use of such AI. An inventory page can visually depict the Risk Level for one or more campaigns. Accordingly, Risk Levels may be used in various embodiments in identifying campaigns having attributes with vulnerabilities to potential occurrences of privacy-related incidents (e.g., data breaches) of use of AI in an unintended, undesired, and/or inappropriate manner.

After the Risk Assessment Module has determined a Risk Level for a campaign, an Audit Module may be operable to use the Risk Level to determine an audit schedule for the campaign. The audit schedule may be editable, and the Audit Module may also facilitate the audit process by sending alerts when an audit is impending, or sending alerts when an audit is overdue. Accordingly, the audit schedule can be used in various embodiments to ensure the campaign is operated with minimal risk of experiencing a privacy-related data incident such as a data breach or performing AI functioning in a manner that is unintended, undesired, and/or inappropriate.

In various embodiments, the system may also include a Data Flow Diagram Module for generating a data flow diagram associated with a campaign. For example, such a diagram can be used in identifying and assessing potential vulnerabilities to an occurrence of a privacy-related incident (e.g., a data breach) associated with the campaign. Here, in particular embodiments, an exemplary data flow diagram displays one or more shapes representing the source from which data associated with the campaign is derived, the destination (or location) of that data, and which departments, software, systems, and/or the like may have access to the data. The Data Flow Diagram Module may also generate one or more security indicators for display. The indicators may include, for example, an “eye” icon to indicate that the data is confidential, a “lock” icon to indicate that the data, and/or a particular flow of data, is encrypted, or an “unlocked lock” icon to indicate that the data, and/or a particular flow of data, is not encrypted. Data flow lines may be colored differently to indicate whether the data flow is encrypted or unencrypted.

In various embodiments, the system may also provide for a Communications Module that facilitates the creation and transmission of notifications and alerts (e.g., via email). The Communications Module may also instantiate an instant messaging session and overlay the instant messaging session over one or more portions of a GUI in which a user is presented with prompts to enter or select information.

In addition, various embodiments of the disclosure overcome various technical challenges in ensuring computer code (e.g., source code or compiled code) operates in compliance with various policies (e.g., standards and/or regulations) and without creating vulnerabilities to potential occurrences of privacy-related data incidents such as data breaches. In addition, various embodiments of the disclosure overcome various technical challenges in ensuring computer code involving AI operates in a manner that is not unintended, undesired, and/or inappropriate (e.g., unfair, unethical, and/or the like). As discussed further herein, particular embodiments may operate with or without obtaining information from various users regarding the computer code, as well as operate in an automated fashion to detect changes in computer code and evaluate the changes accordingly.

As mentioned above, disconnects and differences in vernacular can lead to wrong answers to questions during an audit or assessment and thus lead to noncompliant systems, as well as create vulnerabilities in such systems that can lead to occurrences of privacy-related data incidents or AI operating in an unintended, undesired, and/or inappropriate manner. In addition, changes to computer code can also lead to noncompliant systems and/or systems with vulnerabilities that can lead to occurrences of privacy-related data incidents or AI operating in an unintended, undesired, and/or inappropriate manner. To address these issues, various embodiments of the disclosure are directed to a system (e.g., by executing an Assessment Module) that is configured to determine whether an organization (e.g., systems thereof) is complying with one or more aspects of one or more policies that are related to privacy and/or use of AI, as well as operating while minimizing risk (e.g., vulnerabilities) to experiencing a privacy-related data incident or AI operating in an unintended, undesired, and/or inappropriate manner. For instance, the system in particular embodiments (e.g., during the audit process) may be configured to: (1) obtain a copy of computer code (e.g., a software application or an “app,” website, and/or the like) that is collecting and/or using sensitive/personal information or associated with performing AI and then (2) analyze the computer code to determine whether the operation of the computer code is complying with the terms of a campaign (the assessment standards at issue) that govern the use of the computer code.

In particular embodiments, the system is configured to allow a user to provide the location of the computer code (e.g., source code or compiled code) to be analyzed. This location may be, for example, a location (e.g., in local memory or on a third-party server, such as a server associated with an app store, such as Apple's App Store, or the Microsoft Store) of a particular software application or file. If the software code to be analyzed is that of a website, then the location may be, for example, the website's URL.

In various embodiments, after the system receives the location of the code, the system may obtain the code by, for example, uploading the code from the specified location, or by scraping the relevant code from a specified website. The system may then analyze the code to determine, for example, whether the code includes any functionality, capabilities, and/or the like that would be relevant to one or more policies, which involve the use of personal data or AI, and/or create a vulnerability to potentially experiencing a privacy-related data incident or unintended, undesired, and/or inappropriate use of AI. For example, the system may determine whether the code, when executed, collects personal data in a way that is contrary to one or more applicable laws, and/or contrary to one or more other privacy policies that apply to the code. Accordingly, executing the code in such a manner may create one or more vulnerabilities to potentially experiencing a privacy-related data incident. In another example, the system may determine whether the code, when executed, performs some type of AI functionality that may be inappropriate for the circumstances. As a specific example, the system may determine whether the code, when executed, predicts the creditworthiness of a user. Accordingly, executing the code in such a manner that can be viewed as an inappropriate use of AI. Therefore, the system may determine whether the code is performing AI (e.g., a particular type of AI) in an environment that may be viewed as using the AI in an unintended, undesired, and/or inappropriate manner.

As a particular example, the system in particular embodiments may analyze the computer code to determine whether the code, when executed, performs functionality that collects, stores, transfers, processes, and/or the like any personal information (such as sensitive personal information) regarding a user and/or functionality that performs AI in a manner that is contrary to: (1) any applicable law; (2) a policy of a campaign that the software code is being implemented in conjunction with (See U.S. Provisional Patent Application 62/348,695, which, as noted above, is incorporated herein by reference in its entirety, for a more detailed discussion of campaigns); (3) a general policy of an organization implementing the computer code; and/or (4) any contractual provisions (e.g., software terms and conditions) that apply to the code. In addition, in particular embodiments, the system may analyze the computer code to determine whether the code, when executed, performs functionality that collects, stores, transfers, processes, and/or the like any personal information regarding a user in a manner that may lead to creating a vulnerability to potentially experiencing an occurrence of a privacy-related data incident. Further, in particular embodiments, the system may analyze the computer code to determine whether the code, when executed, performs AI (e.g., some type of AI functionality) in an unintended, undesired, and/or inappropriate manner.

In various embodiments, upon determining that particular code involves functionality that collects, stores, transfers, processes, and/or the like personal information and/or functionality that performs AI, the system may send a request to a first user for information as to why the code includes the functionality, capability, and/or the like at issue and whether the functionality, capability, and/or the like could potentially be omitted and/or modified to address any concerns. For example, if the system determines that the code, when executed, tracks the user's location (e.g., the user's longitude and latitude, the zip code that they're located in, etc.) or web browsing habits, the system may present one or more prompts to a user to input: (1) why the system is tracking the user's location; (2) whether the location-tracking functionality could be omitted from the code, or modified to reduce the resolution of the location-tracking functionality (e.g., reduced from tracking the user's precise longitude and latitude to more generally tracking the zip code or other territorial boundary that they are located in) without having a negative impact on the purpose of the code; (3) why the system is tracking the user's browsing habits; and/or (4) whether the browser-tracking functionality could be omitted from the code without having a negative impact on the purpose of the code. The system may present such questions to any suitable user such as, for example: (a) a software developer that is associated with developing the code; (b) an “owner” of a software campaign associated with the code; (c) a privacy officer; (d) an ethics officer; (c) an auditor; (f) and/or the like.

In some embodiments, the system may be configured to transmit an alert to one or more specified individuals (e.g., indicating that the code includes functionality, capabilities, and/or the like that may be in violation of one or more applicable policies, create vulnerabilities to potential privacy-related data incidents, result in the use of AI that may be viewed as unintended, undesired, and/or inappropriate), along with the answers to the questions referenced above. The specified individuals may then use the answers to determine whether to coordinate modifying the code to comply with the applicable policies (e.g., privacy laws or internal privacy policies), eliminate and/or minimize the vulnerabilities, and/or eliminate and/or modify the use of the AI.

In particular embodiments, the system may include a Monitoring Module for monitoring a particular computer code to determine whether the computer code has changed. If the computer code has changed, the system may, for example: (1) send an alert to an appropriate individual (e.g., a privacy officer) indicating that the computer code has changed (e.g., a new version of the computer code has been released); and/or (2) analyze the new instance (e.g., version) of the computer code (e.g., as described above) to determine whether the new instance of the computer code violates any applicable policies, creates vulnerabilities to potential occurrences of privacy-related data incidents, creates uses of AI in a manner that may be unintended, undesired, and/or inappropriate. The appropriate individual may then take any necessary action to assure compliance with the applicable policies, eliminate and/or minimize the vulnerabilities (e.g., coordinate revision of the code and/or a downgrade to the immediate previous version of the code), and/or eliminate and/or modify the use of the AI.

In particular embodiments, the system may also, or alternatively, be adapted to scan predetermined computer code to determine whether the computer code, when executed, performs functionality that collects, stores, transfers, processes, and/or the like personal information (e.g., sensitive personal information) and/or functionality that performs AI and, if so, what types of personal information are being collected, stored, transferred, processed, what purpose is the AI performed for, and/or the like. In various embodiments, in response to determining that the computer code performs functionality that collects, stores, transfers, processes, and/or the like certain predetermined types of personal information and/or performs AI functionality for a particular purpose, the system may associate a particular risk level with the computer code (and/or a campaign associated with the code) and/or flag the computer code (and/or a campaign associated with the code) to indicate that, before the computer code is placed into use (e.g., publicly launched and/or a non-testing version of the computer code is launched), the computer code needs to: (1) be modified with respect to the functionality; and/or (2) be reviewed and approved by an appropriate individual or group (e.g., the individual or group must approve the computer code including the attribute). Such risk levels and flags may be communicated to users within the context of a risk assessment system, such as one or more of the systems described in U.S. Provisional Patent Application Ser. No. 62/348,695, entitled “Data Processing Systems and Methods for Operationalizing Privacy Compliance and Assessing the Risk of Various Respective Privacy Campaigns and Related Systems and Methods”, which was filed on Jun. 10, 2016, and which, as noted above, is incorporated herein by reference in its entirety.

Thus, various embodiments of the disclosure address several of the technical challenges associated with monitoring compliance with corporate policies, as well as ensuring vulnerabilities to privacy-related incidents (e.g., potential occurrences thereof) and/or unintended, undesired, and/or inappropriate uses of AI are addressed appropriately. In addition, various embodiments of the disclosure address several of the technical challenges associated with ensuring computer code operates in compliance with various policies and without creating vulnerabilities to privacy-related data incidents or use of AI in an unintended, undesired, and/or inappropriate manner.

Accordingly, various embodiments of disclosure provided herein are more effective, efficient, and accurate in monitoring compliance with corporate policies than conventional practices, systems, and infrastructures used for such purposes found in many industries today. In addition, various embodiments of the disclosure provided herein can facilitate identifying and addressing vulnerabilities to privacy-related incidents (e.g., occurrences of data breaches) and/or unintended, undesired, and/or inappropriate uses of AI introduced into systems of organizations resulting from the installment of new and/or changed computer code into the systems. In doing so, various embodiments of the present disclosure can ensure organizations operate systems and perform computational tasks using personal data and/or AI in a compliant manner and with minimal risk of exposing the personal data to a possible privacy-related incident (e.g., a data breach) or using the AI in an unintended, undesired, and/or inappropriate manner.

Furthermore, various embodiments of the present disclosure make major technical contributions in providing automated systems that are better secure, efficient, and effective in handling personal data and/or using AI functionality. Accordingly, the solutions provided herein can reduce the computational load of various systems used in processing personal data and/or performing AI while marginally affecting the effective throughput of these systems. In addition, various embodiments of the present invention enhance the efficiency and speed of various systems used in processing of personal data and/or performing AI and make important contributions to various computational tasks that utilize real-time/expediated processing of personal data and/or performance of AI. For instance, various embodiments of the present disclosure can ensure that computer code (e.g., software applications, websites, and/or the like) is installed and operated within various systems in a secure, efficient, and effective manner that processes personal data and/or performs AI in compliance with various policies and/or while minimizing the risk of the personal data being exposed to a privacy-related data incident and/or using AI in an unintended, undesired, and/or inappropriate manner. As a result, various embodiments lead to improving the computational efficiency and reliability of various automated systems and computational tasks that involve functionality that collects, processes, contains, stores, transfers, and/or the like personal data and/or functionality that performs AI. This in turn translates to more computationally efficient software systems. Further detail is now provided for different aspects of various embodiments of the disclosure.

### Exemplary Technical Platforms

As will be appreciated by one skilled in the relevant field, a system for operationalizing compliance and assessing risk of campaigns may be, for example, embodied as a computer system, a method, or a computer program product. As will be appreciated by one skilled in the relevant field, a system for performing assessments and monitoring new versions of computer code for updated features and conditions that relate to compliance with regulations and/or standards may be embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of, for example, web, mobile, or wearable computer-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each step of the block diagrams and flowchart illustrations, and combinations of steps in the block diagrams and flowchart illustrations, respectively, may be implemented by a computer executing computer program instructions. These computer program instructions may be loaded onto a general-purpose computer, special purpose computer, or other programmable data processing apparatus to produce a machine, such that the instructions which execute on the computer or other programmable data processing apparatus to create means for implementing the functions specified in the flowchart step or steps.

These computer program instructions may also be stored in a computer-readable memory that may direct a computer or other programmable data processing apparatus to function in a particular manner such that the instructions stored in the computer-readable memory produce an article of manufacture that is configured for implementing the function specified in the flowchart step or steps. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart step or steps.

Accordingly, steps of the block diagrams and flowchart illustrations support combinations of mechanisms for performing the specified functions, combinations of steps for performing the specified functions, and program instructions for performing the specified functions. It should also be understood that each step of the block diagrams and flowchart illustrations, and combinations of steps in the block diagrams and flowchart illustrations, may be implemented by special purpose hardware-based computer systems that perform the specified functions or steps, or combinations of special purpose hardware and other hardware executing appropriate computer instructions.

### Example System Architecture

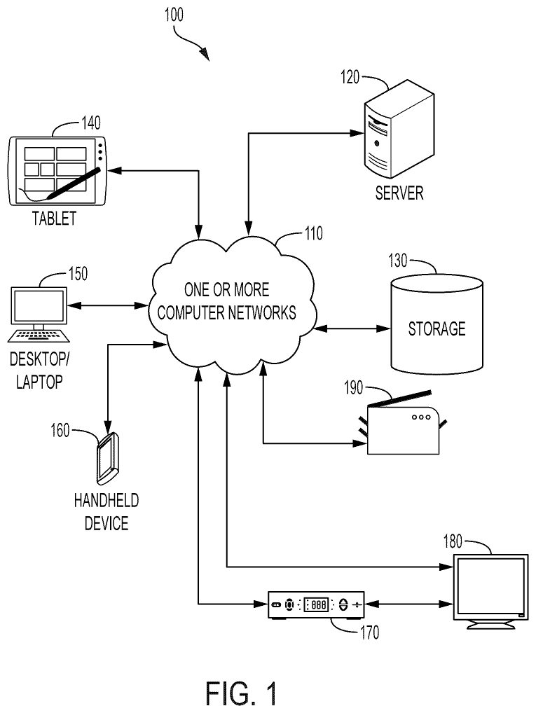

FIG. 1 is a block diagram of a System 100 according to a particular embodiment. As may be understood from this figure, the System 100 includes one or more computer networks 110, a Server 120, a Storage Device 130 (which may contain one or more databases of information), one or more remote client computing devices such as a tablet computer 140, a desktop or laptop computer 150, or a handheld computing device 160, such as a cellular phone, browser and Internet capable set-top boxes 170 connected with a TV 180, or a smart TV 180 having browser and Internet capability. The client computing devices attached to the network may also include copiers/printers 190 having hard drives. The Server 120, client computing devices, and Storage Device 130 may be physically located in a central location, such as the headquarters of the organization, for example, or in separate facilities. The devices may be owned or maintained by employees, contractors, or other third parties (e.g., a cloud service provider). In particular embodiments, the one or more computer networks 110 facilitate communication between the Server 120, one or more client computing devices 140, 150, 160, 170, 180, 190, and Storage Device 130.

The one or more computer networks 110 may include any of a variety of types of wired or wireless computer networks such as the Internet, a private intranet, a public switched telephone network (PSTN), or any other type of network. The communication link between the Server 120, one or more client computing devices 140, 150, 160, 170, 180, 190, and Storage Device 130 may be, for example, implemented via a Local Area Network (LAN) or via the Internet.

Example Computer Architecture Used within the System

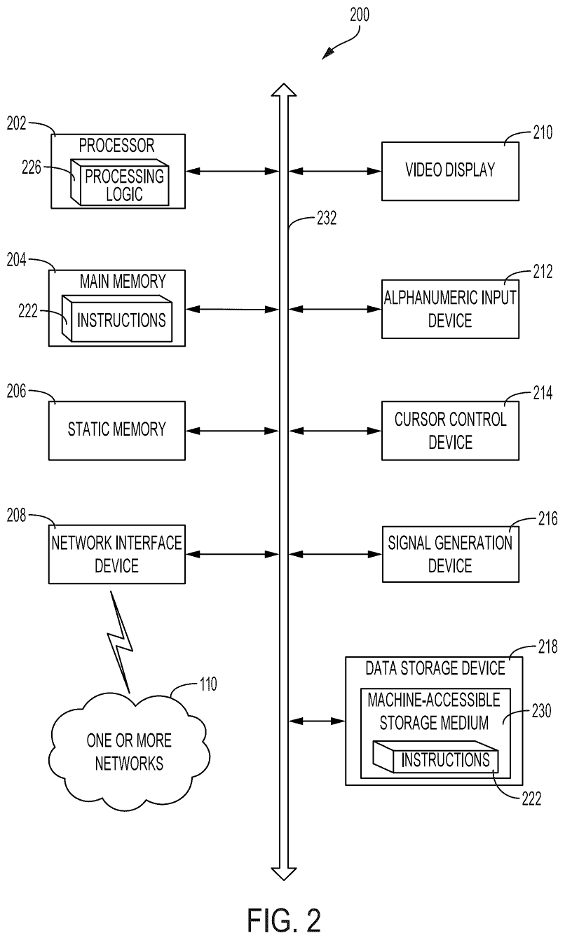

FIG. 2 illustrates a diagrammatic representation of the architecture of a computer 200 that may be used within the System 100, for example, as a client computer (e.g., one of computing devices 140, 150, 160, 170, 180, 190, shown in FIG. 1), or as a server computer (e.g., Server 120 shown in FIG. 1). In exemplary embodiments, the computer 200 may be suitable for use as a computer within the context of the System 100 that is configured to operationalize compliance and assess the risk of campaigns. In particular embodiments, the computer 200 may be connected (e.g., networked) to other computers in a LAN, an intranet, an extranet, and/or the Internet. As noted above, the computer 200 may operate in the capacity of a server or a client computer in a client-server network environment, or as a peer computer in a peer-to-peer (or distributed) network environment. The computer 200 may be a personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform, for example, any one or more of the methodologies discussed herein.

An exemplary computer 200 includes a processing device 202, a main memory 204 (e.g., read-only memory (ROM), flash memory, dynamic random-access memory (DRAM) such as synchronous DRAM (SDRAM) or Rambus DRAM (RDRAM)), a static memory 206 (e.g., flash memory or static random-access memory (SRAM)), and a data storage device 218, which communicate with each other via a bus 232.

The processing device 202 represents one or more general-purpose processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 200 may further include a network interface device 208. The computer 200 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker). The data storage device 218 may include a non-transitory computer-readable storage medium 230 (also known as a non-transitory computer-readable storage medium or a non-transitory computer-readable medium) on which is stored one or more sets of instructions 222 (e.g., software, software modules) embodying any one or more of the methodologies or functions described herein. The instructions 222 may also reside, completely or at least partially, within main memory 204 and/or within processing device 202 during execution thereof by computer 200—main memory 204 and processing device 202 also constituting computer-accessible storage media. The instructions 222 may further be transmitted or received over a network 110 via a network interface device 208.

While the computer-readable storage medium 230 is shown in an exemplary embodiment to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding, or carrying a set of instructions for execution by the computer and that cause the computer to perform, for example, any one or more of the methodologies of the present invention. The term “computer-readable storage medium” should accordingly be understood to include, but not be limited to, solid-state memories, optical and magnetic media, etc.

### Exemplary System Platform

According to various embodiments, the processes and logic flows described in this specification may be performed by a system (e.g., System 100) that includes, but is not limited to, one or more programmable processors (e.g., processing device 202) executing one or more computer program modules to perform functions by operating on input data and generating output, thereby tying the process to a particular machine (e.g., a machine programmed to perform the processes described herein). This includes processors located in one or more of client computers (e.g., client computers 140, 150, 160, 170, 180, 190 of FIG. 1). These devices connected to network 110 may access and execute one or more Internet browser-based program modules that are “served up” through the network 110 by one or more servers (e.g., server 120 of FIG. 1), and the data associated with the program may be stored on one or more storage devices, which may reside within a server or computing device (e.g., Main Memory 204, Static Memory 206), be attached as a peripheral storage device to the one or more servers or computing devices, or attached to the network (e.g., Storage 130).

The System 100 may facilitate the acquisition, storage, maintenance, use, and retention of campaign data associated with a plurality of campaigns within an organization. In doing so, various aspects of the System 100 initiate and create a plurality of individual data campaign records that are associated with a variety of privacy-related attributes and/or AI-related attributes and assessment-related metadata for each campaign. These data elements may include, for example: the subjects of the personal data, purpose for performing certain AI functionality, the respective person or entity responsible for each campaign (e.g., the campaign's “owner”), the location where the personal data will be stored, the entity or entities that will access the personal data and/or AI, the parameters according to which the personal data and/or AI will be used and retained, the Risk Level associated with a particular campaign (as well as assessments from which the Risk Level is calculated), an audit schedule, and other attributes and metadata.

The System 100 may also be adapted to facilitate the setup and auditing of each campaign. Suitable modules for performing this functionality may include, for example, an Assessment Module and a Monitoring Module (examples of which are described below). It is to be understood that these are examples of modules of various embodiments, but the functionalities performed by each module as described may be performed by more (or fewer) modules. Further, the functionalities described as being performed by one module may be performed by one or more other modules.

A. Example Elements Related to Privacy and/or Use of AI

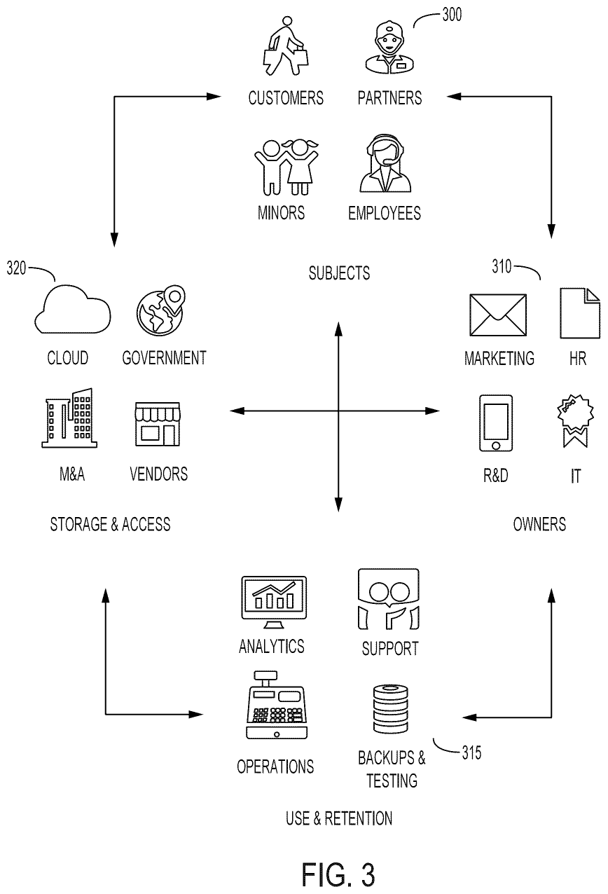

FIG. 3 provides a high-level visual overview of example “subjects” for particular assessments that may performed for privacy purposes and/or AI use purposes, exemplary “owners,” various elements related to the storage and access of personal data, and elements related to the use and retention of the personal data and/or AI. Each of these elements may, in various embodiments, be accounted for by the System 100 as it facilitates the implementation of an organization's compliance policy with respect to privacy and/or use of AI.

As may be understood from FIG. 3, sensitive information such as personal data may be collected by an organization from one or more subjects 300. Further, one or more subjects 300 may interact with AI provided by the organization through various applications. Subjects 300 may include customers whose information has been obtained by the organization. For example, if the organization is selling goods to a customer, the organization may have been provided with a customer's credit card or banking information (e.g., account number, bank routing number), social security number, or other sensitive information. Subjects 300 may include customers who encounter AI (e/g., AI functionality) while engaging with the organization. For example, the organization may have provided the customers with AI functionality through a website that interacts with the customers in facilitating purchases of products through the website.

An organization may also possess personal data originating from one or more of its business partners and/or provide AI through one or more of its business partners. Examples of business partners are vendors that may be data controllers or data processors (which have different legal obligations under EU data protection laws). Vendors may supply a component or raw material to the organization, which may include software applications or database programs, or a website. Accordingly, such software applications, database programs, and/or websites may use AI. Vendors may also be outside contractors responsible, for example, for the marketing or legal work of the organization. The personal data acquired from the partner may be that of the partners, or even that of other entities collected by the partners. For example, a marketing agency may collect personal data on behalf of the organization and transfer that information to the organization. Moreover, the organization may share personal data with one of its partners. For example, the organization may provide a marketing agency with the personal data of its customers so that it may conduct further research.

Other subjects 300 include the organization's own employees. Organizations with employees often collect personal data from their employees, including address and social security information, usually for payroll purposes, or even prior to employment, for conducting credit checks. In addition, organizations with employees often provide their employees with applications that may use AI such as, for example, human resources applications that may allow employees to define their benefits through the applications automatically. The subjects 300 may also include minors. It is noted that various corporate policies or laws may require that organizations take additional steps to protect the sensitive privacy of minors.

Still referring to FIG. 3, within an organization, one or more particular individuals (or a particular group of individuals) may be designated to be an “owner” who is in charge of particular “campaigns.” A campaign may be, for example, an organized effort to manage personal data obtained from a particular initiative, such as a particular business initiative, which may utilize personal data collected from one or more persons or entities. A campaign may be, for example, an organized effort to implement a particular application that interfaces with customers or employees that uses AI functionality. The owners 310 may have any suitable role within the organization. For example, in various embodiments, an owner of a particular campaign involving privacy will have primary responsibility for the campaign and will serve as a resident expert regarding the personal data obtained through the campaign, and the way that the data is obtained, stored, and/or accessed. As shown in FIG. 3, an owner may be a member of any suitable department, including the organization's marketing, human resources, research and development, or information technology department. As will be described below, in exemplary embodiments, the owner can always be changed, and owners can sub-assign other owners (and other collaborators) to individual sections of campaign data input and operations. As will be described below, an organization may employ personnel from a privacy team and/or ethics team, who typically operate under personnel of the organization such as a chief privacy officer, a chief ethics officers, or auditors, to carry out assessments or audits.

Referring still to FIG. 3, this figure shows that the use and retention 315 of personal data and/or AI functionality may include how personal data is analyzed and used within the organization's operations, whether personal data is backed up, how AI is used within the organization's operations, what processes are performed in developing and/or maintaining AI functionality, which parties within the organization are supporting the campaign, and/or the like.

The system may also be configured to help manage the storage and access 320 of personal data and/or AI (and components thereof such as machine-learning algorithms, data sets used for training, and/or the like). As shown in FIG. 3, a variety of different parties may access the personal data and/or AI, and the data and/or AI may be stored in any of a variety of different locations, including on-site, or in “the cloud”, i.e., on remote servers that are accessed via the Internet or other suitable network.

### B. Main Compliance Module

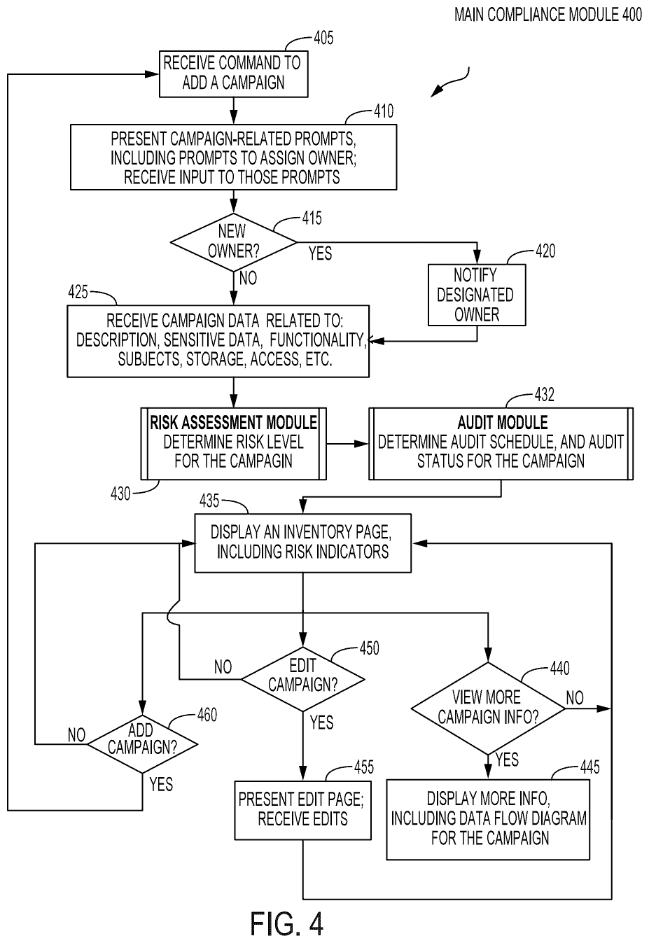

FIG. 4 illustrates an exemplary process for operationalizing compliance. Main Compliance Module 400, which may be executed by one or more computing devices of System 100, may perform this process. In exemplary embodiments, a server (e.g., server 140) in conjunction with a client computing device having a browser, execute the Main Compliance Module (e.g., computing devices 140, 150, 160, 170, 180, 190) through a network (network 110). In various exemplary embodiments, the Main Compliance Module 400 may call upon other modules to perform certain functions. In exemplary embodiments, the software may also be organized as a single module to perform various computer executable routines.

### I. Adding a Campaign

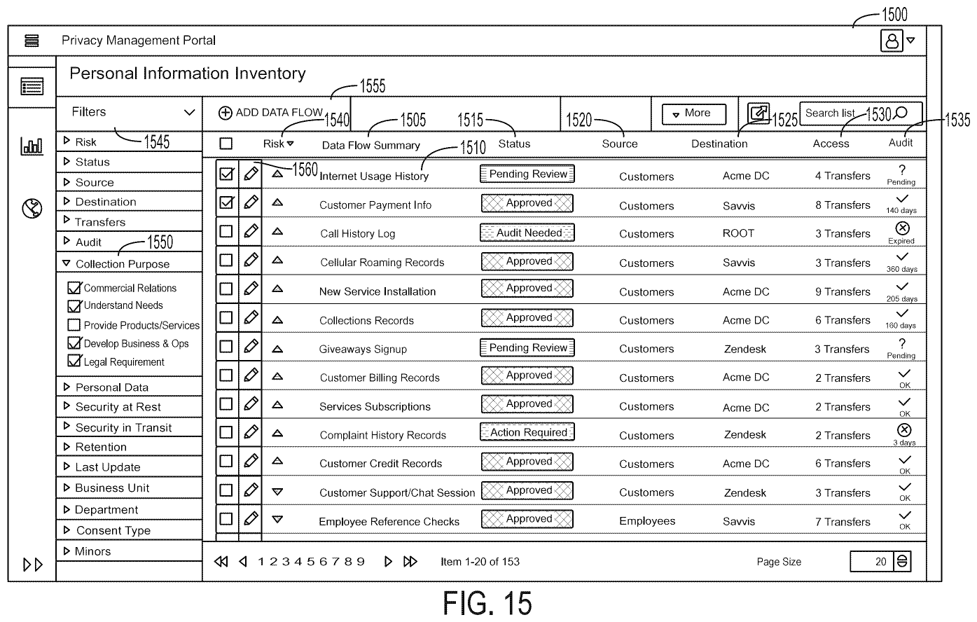

The process may begin at step 405, wherein the Main Compliance Module 400 of the System 100 receives a command to add a campaign. In exemplary embodiments, the user selects an on-screen button (e.g., the Add Data Flow button 1555 of FIG. 15) that the Main Compliance Module 400 displays on a landing page, which may be displayed in a graphical user interface (GUI), such as a window, dialog box, or the like. The landing page may be, for example, the inventory page 1500 below. The inventory page 1500 may display a list of one or more campaigns that have already been input into the System 100. As mentioned above, a campaign may represent, for example, a business operation that the organization is engaged in, or some business record, that may require the use of personal data, which may include the personal data of a customer or some other entity. Examples of campaigns might include Internet Usage History, Customer Payment Information, Call History Log, Cellular Roaming Records, etc. For the campaign “Internet Usage History,” a marketing department may need customers' on-line browsing patterns to run analytics. This might entail retrieving and storing customers' IP addresses, MAC address, URL history, subscriber ID, and other information that may be considered personal data (and even sensitive personal data).

In another example, a campaign may involve an organization's implementation of some application for used by customers or employees of the organization that involves AI functionality. As a specific example, a campaign may involve the organization implementing a chatbot application that is to be made available on the organization's website that assists visitors to the website in identifying products of interest on the website. Here, the chatbot application may use AI functionality in determining (predicting) what questions to ask a particular visitor in assisting him or her with identifying products. Examples of campaigns might include Chatbot Application, Image Recognition Application, Automated Employee Benefits Assistant, etc.

As will be described herein, the System 100, through the use of one or more modules, including the Main Compliance Module 400, creates a record for each campaign. Data elements of campaign data may be associated with each campaign record that represents attributes such as: the type of personal data and/or AI associated with the campaign; the subjects having access to the personal data and/or AI; the person or persons within the company that take ownership (e.g., business owner) for ensuring compliance for the personal data and/or AI associated with the campaign; the location of the personal data and/or AI; the entities having access to the personal data and/or AI; the various computer systems and software applications that use the personal data and/or AI; and the Risk Level (see below) associated with the campaign.

### II. Entry of Campaign Related Information, Including Owner

At step 410, in response to the receipt of the user's command to add a campaign record, the Main Compliance Module 400 initiates a routine to create an electronic record for a campaign, and a routine for the entry data inputs of information related to the campaign. The Main Compliance Module 400 may generate one or more graphical user interfaces (e.g., windows, dialog pages, etc.), which may be presented one GUI at a time. Each GUI may show prompts, editable entry fields, check boxes, radial selectors, etc., where a user may enter or select campaign data. In exemplary embodiments, the Main Compliance Module 400 displays on the graphical user interface a prompt to create an electronic record for the campaign. A user may choose to add a campaign, in which case the Main Compliance Module 400 receives a command to create the electronic record for the campaign, and in response to the command, creates a record for the campaign and digitally stores the record for the campaign. The record for the campaign may be stored in, for example, storage 130, or a storage device associated with the Main Compliance Module 400 (e.g., a hard drive residing on Server 120, or a peripheral hard drive attached to Server 120).

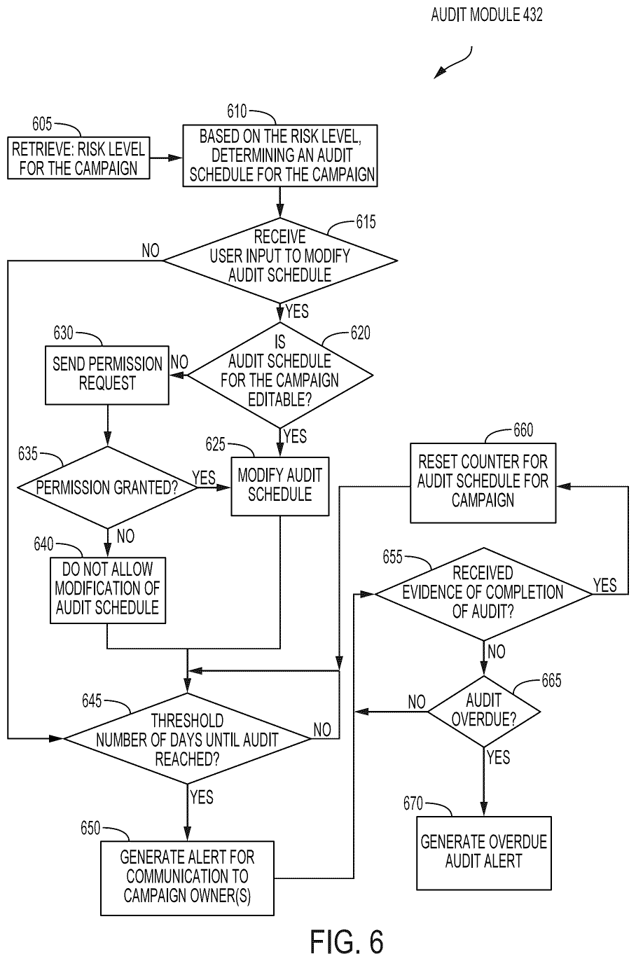

For example, the user may be a person who works in the Chief Privacy Officer's organization (e.g., a privacy office rep, or privacy officer). The privacy officer may be the user that creates the campaign record, and enters initial portions of campaign data (e.g., “high level” data related to the campaign), for example, a name for the campaign, a description of the campaign, and a business group responsible for administering the operations related to that campaign (for example, though the GUI shown in FIG. 6). The Main Compliance Module 400 may also prompt the user to enter a person or entity responsible for each campaign (e.g., the campaign's “owner”). The owner may be tasked with the responsibility for ensuring or attempting to ensure that the policies or laws associated with the campaign (e.g., the personal data and/or AI related to a particular campaign) are being complied with. In exemplary embodiments, the default owner of the campaign may be the person who initiated the creation of the campaign. For example, that owner may be a person who works in the Chief Privacy Officer's organization (e.g., a privacy office rep, or privacy officer) or a person who works in Chief Ethics Officer's organization (e.g., an ethics office rep, or ethics officer). The initial owner of the campaign may designate someone else to be the owner of the campaign. The designee may be, for example, a representative of some business unit within the organization (a business rep). Additionally, more than one owner may be assigned. For example, the user may assign a primary business rep, and may also assign a privacy office rep as owners of the campaign.

In many instances, some or most of the required information related to the campaign record might not be within the knowledge of the default owner (i.e., the privacy office rep). The Main Compliance Module 400 can be operable to allow the creator of the campaign record (e.g., a privacy officer rep) to designate one or more other collaborators to provide at least one of the data inputs for the campaign data. Different collaborators, which may include the one or more owners, may be assigned to different questions, or to specific questions within the context of the campaign. Additionally, different collaborators may be designated to respond to parts of questions. Thus, portions of campaign data may be assigned to different individuals.

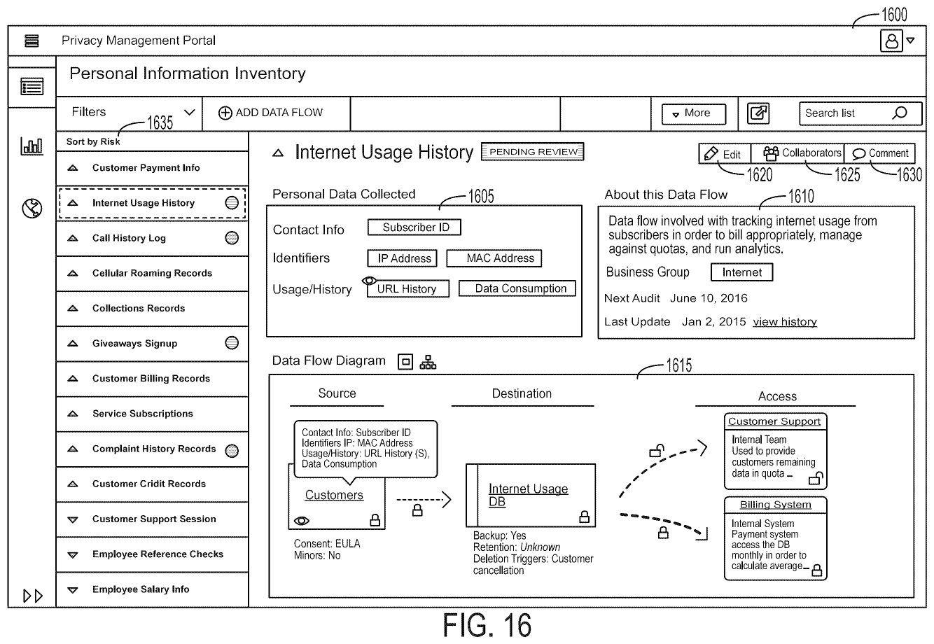

Still referring to FIG. 4, if at step 415 the Main Compliance Module 400 has received an input from a user to designate a new owner for the campaign that was created, then at step 420, the Main Compliance Module 400 may notify that individual via a suitable notification that the campaign has been assigned to him or her. Prior to notification, the Main Compliance Module 400 may display a field that allows the creator of the campaign to add a personalized message to the newly assigned owner of the campaign to be included with that notification. In exemplary embodiments, the notification may be in the form of an email message. The email may include the personalized message from the assignor, a standard message that the campaign has been assigned to him/her, the deadline for completing the campaign entry, and instructions to log in to the system to complete the campaign entry (along with a hyperlink that takes the user to a GUI providing access to the Main Compliance Module 400. Also included may be an option to reply to the email if an assigned owner has any questions, or a button that when clicked on, opens up a chat window (i.e., instant messenger window) to allow the newly assigned owner and the assignor a GUI in which they are able to communicate in real-time. An example of such a notification appears in FIG. 16 below. In addition to owners, collaborators that are assigned to input portions of campaign data may also be notified through similar processes. In exemplary embodiments, The Main Compliance Module 400 may, for example through a Communications Module, be operable to send collaborators emails regarding their assignment of one or more portions of inputs to campaign data. Or through the Communications Module, selecting the commentators button brings up one or more collaborators that are on-line (with the off-line users still able to see the messages when they are back on-line. Alerts indicate that one or more emails or instant messages await a collaborator.

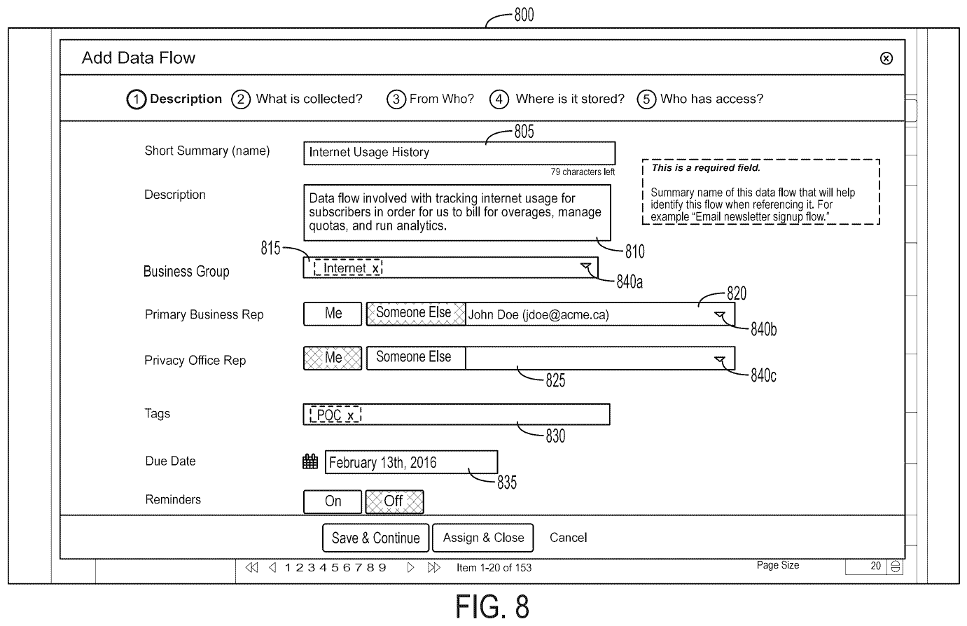

At step 425, regardless of whether the owner is the user (i.e., the creator of the campaign), “someone else” assigned by the user, or other collaborators that may be designated with the task of providing one or more items of campaign data, the Main Compliance Module 400 may be operable to electronically receive campaign data inputs from one or more users related to the personal data and/or AI related to a campaign through a series of displayed computer-generated graphical user interfaces displaying a plurality of prompts for the data inputs. In exemplary embodiments, through a step-by-step process, the Main Compliance Module 400 may receive from one or more users' data inputs that include campaign data like: (1) a description of the campaign; (2) one or more types of personal data to be collected and stored and/or AI employed as part of the campaign; (3) individuals from whom the personal data is to be collected and/or who interacts with the AI; (4) the storage location of the personal data and/or the AI, and (5) information regarding who will have access to the personal data and/or output and/or purpose of the AI. These inputs may be obtained, for example, through the graphical user interfaces shown in FIGS. 8 through 13, wherein the Main Compliance Module 400 presents on sequentially appearing GUIs the prompts for the entry of each of the enumerated campaign data above. Note that the graphical user interfaces shown in FIGS. 8 through 13 are associated with a campaign involving privacy (e.g., personal data). However, similar graphical user interfaces may be provided for a campaign involving the use of the AI. The Main Compliance Module 400 may process the campaign data by electronically associating the campaign data with the record for the campaign and digitally storing the campaign data with the record for the campaign. The campaign data may be digitally stored as data elements in a database residing in a memory location in the server 120, a peripheral storage device attached to the server, or one or more storage devices connected to the network (e.g., storage 130). If campaign data inputs have been assigned to one or more collaborators, but those collaborators have not input the data yet, the Main Compliance Module 400 may, for example through the Communications Module, sent an electronic message (such as an email) alerting the collaborators and owners that they have not yet supplied their designated portion of campaign data.

### III. Campaign Information Display

At step 430, the Main Compliance Module 400 may, in exemplary embodiments, call upon a Risk Assessment Module 430 that may determine and assign a Risk Level for the campaign, based wholly or in part on the information that the owner(s) have input. The Risk Assessment Module 430 is discussed in more detail below.

At step 432, the Main Compliance Module 400 may in exemplary embodiments, call upon an Audit Module 432 that may determine an audit schedule for each campaign, based, for example, wholly or in part on the campaign data that the owner(s) have input, the Risk Level assigned to a campaign, and/or any other suitable factors. The Audit Module 432 may also be operable to display the status of an audit for each campaign. The Audit Module 432 is discussed in more detail below.

At step 435, the Main Compliance Module 400 may generate and display a GUI showing an inventory page (e.g., inventory page 1500) that includes information associated with each campaign. That information may include information input by a user (e.g., one or more owners), or information calculated by the Main Compliance Module 400 or other modules. Such information may include for example, the name of the campaign, the status of the campaign, the source of the campaign, the storage location of the personal data and/or applications utilizing the AI functionality related to the campaign, etc. The inventory page 1500 may also display an indicator representing the Risk Level (as mentioned, determined for each campaign by the Risk Assessment Module 430), and audit information related to the campaign that was determined by the Privacy Audit Module (see below). The inventory page 1500 may be the landing page displayed to users that access the system. Based on the login information received from the user, the Main Compliance Module 400 may determine which campaigns and campaign data the user is authorized to view and display only the information that the user is authorized to view. Also, from the inventory page 1500, a user may add a campaign (discussed above in step 405), view more information for a campaign, or edit information related to a campaign (see, e.g., FIGS. 15, 16, 17).

If other commands from the inventory page are received (e.g., add a campaign, view more information, edit information related to the campaign), then step 440, 445, and/or 450 may be executed.

At step 440, if a command to view more information has been received or detected, then at step 445, the Main Compliance Module 400 may present more information about the campaign, for example, on a suitable campaign information page. At this step, the Main Compliance Module 400 may invoke a Data Flow Diagram Module (described in more detail below). For example, the Data Flow Diagram Module may generate a flow diagram that shows visual indicators indicating whether personal data involved in the campaign is confidential and/or encrypted (see, e.g., FIG. 1600 below).

At step 450, if the system has received a request to edit a campaign, then, at step 455, the system may display a dialog page that allows a user to edit information regarding the campaign (e.g., edit campaign dialog 1700).

At step 460, if the system has received a request to add a campaign, the process may proceed back to step 405.

### C. Risk Assessment Module

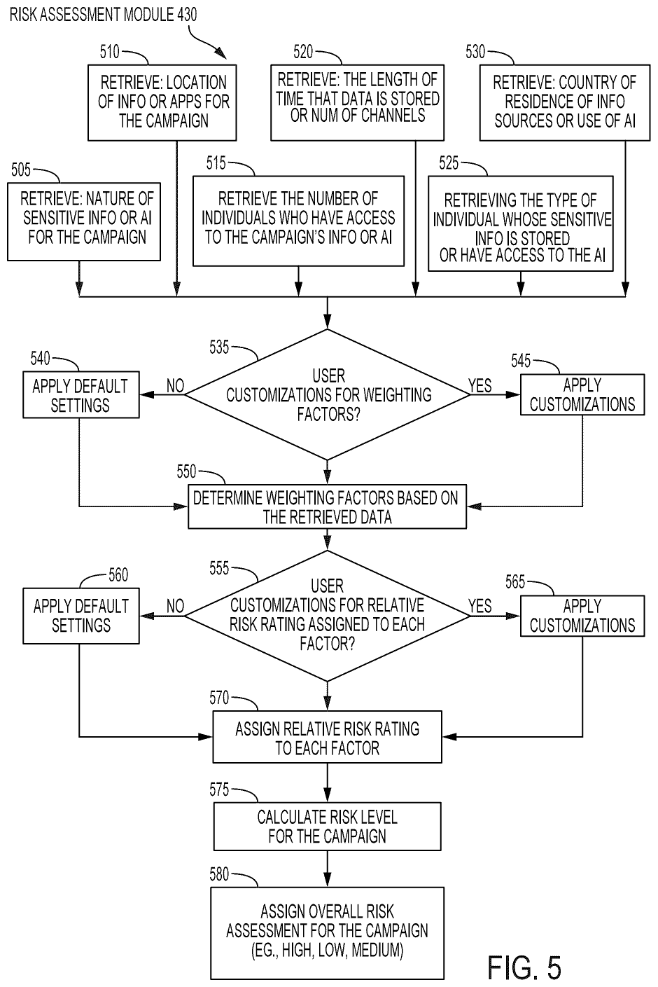

FIG. 5 illustrates an exemplary process for determining a Risk Level and Overall Risk Assessment for a particular campaign performed by Risk Assessment Module 430.

### I. Determining Risk Level

In exemplary embodiments, the Risk Assessment Module 430 may be operable to calculate a Risk Level for a campaign based on the campaign data related to the personal data and/or AI associated with the campaign. The Risk Assessment Module may associate the Risk Level with the record for the campaign and digitally store the Risk Level with the record for the campaign.

The Risk Assessment Module 430 may calculate this Risk Level based on any of various factors associated with the campaign. The Risk Assessment Module 430 may determine a plurality of weighting factors based upon, for example: (1) the nature of the personal data collected as part of the campaign (e.g., campaigns in which medical information, financial information or non-public personal identifying information is collected may be indicated to be of higher risk than those in which only public information is collected, and thus may be assigned a higher numerical weighting factor) and/or the nature or purpose of the AI involved in the campaign (e.g., campaigns in which AI is being performed to identify individuals may be indicated to be of higher risk than those in which AI is being performed for inventory management); (2) the location in which the personal data is stored (e.g., campaigns in which personal data is stored in the cloud may be deemed higher risk than campaigns in which the personal data is stored locally) and/or the applications involved with using the AI (e.g., campaigns in which applications that are using AI and are available to the public may be deemed higher risk than campaigns in which applications that are using AI are only available to employees); (3) the number of individuals who have access to the personal data (e.g., campaigns that permit relatively large numbers of individuals to access the personal data may be deemed more risky than those that allow only small numbers of individuals to access the personal data) and/or the number of individuals who have access to the AI (e.g., campaigns in which the AI is available for use by relatively large numbers of individuals may be deemed more risky than those in which the AI is only available for use by small numbers of individuals); (4) the length of time that the personal data will be stored within the system (e.g., campaigns that plan to store and use the personal data over a long period of time may be deemed more risky than those that may only hold and use the personal data for a short period of time) and/or the number of different channels through which the AI is made available (e.g., campaigns that provide multiple channels of access to the AI may be deemed more risky than those that may only provide a single channel of access); (5) the individuals whose personal data will be stored (e.g., campaigns that involve storing and using personal data of minors may be deemed of greater risk than campaigns that involve storing and using the personal data of adults) and/or the individuals who are expected to use the AI (e.g., campaigns that involve AI expected to be used exclusively by females may be deemed more risky than those that involve AI expected to be used by both females and males); (6) the country of residence of the individuals whose personal data will be stored (e.g., campaigns that involve collecting personal data from individuals that live in countries that have relatively strict privacy laws may be deemed more risky than those that involve collecting personal data from individuals that live in countries that have relative lax privacy laws) and/or the country in which the AI is to be performed (e.g., campaigns that involve AI to be performed in countries that have relatively strict responsible AI laws and/or standards may be deemed more risky than those that involve AI to be performed in countries that have relatively lax responsible AI laws and/or standards). It should be understood that any other suitable factors may be used to assess the Risk Level of a particular campaign, including any new inputs that may need to be added to the risk calculation.

In particular embodiments, one or more of the individual factors may be weighted (e.g., numerically weighted) according to the deemed relative importance of the factor relative to other factors (i.e., Relative Risk Rating).

These weightings may be customized from organization to organization, and/or according to different applicable laws, regulations, standards, and/or the like. For example, in particular embodiments, the nature of the personal data will be weighted higher than the storage location of the data, or the length of time that the data will be stored.

In various embodiments, the system uses a numerical formula to calculate the Risk Level of a particular campaign. This formula may be, for example: Risk Level for campaign=(Weighting Factor of Factor 1)*(Relative Risk Rating of Factor 1)+(Weighting Factor of Factor 2)*(Relative Risk Rating of Factor 2)+ . . . (Weighting Factor of Factor N)*(Relative Risk Rating of Factor N). As a simple example, the Risk Level for a campaign that only collects publicly available information for adults and that stores the information locally for a short period of several weeks might be determined as Risk Level=(Weighting Factor of Nature of Sensitive Information) (Relative Risk Rating of Particular Sensitive Information to be Collected)+(Weighting Factor of Individuals from which Information is to be Collected)*(Relative Risk Rating of Individuals from which Information is to be Collected)+(Weighting Factor of Duration of Data Retention)*(Relative Risk Rating of Duration of Data Retention)+(Weighting Factor of Individuals from which Data is to be Collected)*(Relative Risk Rating of Individuals from which Data is to be Collected). In this example, the Weighting Factors may range, for example from 1-5, and the various Relative Risk Ratings of a factor may range from 1-10. However, the system may use any other suitable ranges.

In particular embodiments, the Risk Assessment Module 430 may have default settings for assigning Overall Risk Assessments to respective campaigns based on the numerical Risk Level value determined for the campaign, for example, as described above. The organization may also modify these settings in the Risk Assessment Module 430 by assigning its own Overall Risk Assessments based on the numerical Risk Level. For example, the Risk Assessment Module 430 may, based on default or user assigned settings, designate: (1) campaigns with a Risk Level of 1-7 as “low risk” campaigns, (2) campaigns with a Risk Level of 8-15 as “medium risk” campaigns; (3) campaigns with a Risk Level of over 16 as “high risk” campaigns. As show below, in an example inventory page 1500, the Overall Risk Assessment for each campaign can be indicated by up/down arrow indicators, and further, the arrows may have different shading (or color, or portions shaded) based upon this Overall Risk Assessment. The selected colors may be conducive for viewing by those who suffer from color blindness.

Thus, the Risk Assessment Module 430 may be configured to automatically calculate the numerical Risk Level for each campaign within the system, and then use the numerical Risk Level to assign an appropriate Overall Risk Assessment to the respective campaign. For example, a campaign with a Risk Level of 5 may be labeled with an Overall Risk Assessment as “Low Risk”. The system may associate both the Risk Level and the Overall Risk Assessment with the campaign and digitally store them as part of the campaign record.

### II. Exemplary Process for Assessing Risk

Accordingly, as shown in FIG. 5, in exemplary embodiments, the Risk Assessment Module 430 electronically retrieves from a database (e.g., storage device 130) the campaign data associated with the record for the campaign. It may retrieve this information serially, or in parallel. At step 505, the Risk Assessment Module 430 retrieves information regarding (1) the nature of the sensitive information (e.g., personal data) collected as part of the campaign and/or nature and/or purpose of the AI employed as part of the campaign. At step 510, the Risk Assessment Module 430 retrieves information regarding the (2) the location in which the sensitive information related to the campaign is stored and/or the applications that use the AI. At step 515, the Risk Assessment Module 430 retrieves information regarding (3) the number of individuals who have access to the sensitive information and/or AI. At step 520, the Risk Assessment Module retrieves information regarding (4) the length of time that the sensitive information associated with a campaign will be stored within the System 100 and/or the number of channels through which the AI may be made available by the System 100. At step 525, the Risk Assessment Module retrieves information regarding (5) the individuals whose sensitive information will be stored and/or who may have access to the AI. At step 530, the Risk Assessment Module retrieves information regarding (6) the country of residence of the individuals whose sensitive information will be stored and/or the country in which the AI will be performed.

At step 535, the Risk Assessment Module takes into account any user customizations to the weighting factors related to each of the retrieved factors from steps 505, 510, 515, 520, 525, and 530. At steps 540 and 545, the Risk Assessment Module applies either default settings to the weighting factors (which may be based on privacy laws), or customizations to the weighting factors. At step 550, the Risk Assessment Module determines a plurality of weighting factors for the campaign. For example, for the factor related to the nature of the sensitive information collected as part of the campaign, a weighting factor of 1-5 may be assigned based on whether non-public personal identifying information is collected.

At step 555, the Risk Assessment Module takes into account any user customizations to the Relative Risk assigned to each factor, and at step 560 and 565, will either apply default values (which can be based on privacy laws) or the customized values for the Relative Risk. At step 570, the Risk Assessment Module assigns a relative risk rating for each of the plurality of weighting factors. For example, the relative risk rating for the location of the information of the campaign may be assigned a numerical number (e.g., from 1-10) that is lower than the numerical number assigned to the Relative Risk Rating for the length of time that the sensitive information for that campaign is retained.

At step 575, the Risk Assessment Module 430 calculates the relative risk assigned to the campaign based upon the plurality of Weighting Factors and the Relative Risk Rating for each of the plurality of factors. As an example, the Risk Assessment Module 430 may make this calculation using the formula of Risk Level=(Weighting Factor of Factor 1)*(Relative Risk Rating of Factor 1)+(Weighting Factor of Factor 2)*(Relative Risk Rating of Factor 2)+ . . . (Weighting Factor of Factor N)*(Relative Risk Rating of Factor N).

At step 580, based upon the numerical value derived from step 575, the Risk Assessment Module 430 may determine an Overall Risk Assessment for the campaign. The Overall Risk Assessment determination may be made for the campaign may be assigned based on the following criteria, which may be either a default or customized setting: (1) campaigns with a Risk Level of 1-7 as “low risk” campaigns, (2) campaigns with a Risk Level of 8-15 as “medium risk” campaigns; (3) campaigns with a Risk Level of over 16 as “high risk” campaigns. The Overall Risk Assessment is then associated and stored with the campaign record.

### D. Audit Module

The System 100 may determine an audit schedule for each campaign, and indicate, in a particular graphical user interface (e.g., inventory page 1500), whether an audit is coming due (or is past due) for each particular campaign and, if so, when the audit is/was due. The System 100 may also be operable to provide an audit status for each campaign, and alert personnel of upcoming or past due audits. To further the retention of evidence of compliance, the System 100 may also receive and store evidence of compliance. An Audit Module 432 may facilitate these functions.

### I. Determining an Audit Schedule and Monitoring Compliance

In exemplary embodiments, the Audit Module 432 is adapted to automatically schedule audits and manage compliance with the audit schedule. In particular embodiments, the system may allow a user to manually specify an audit schedule for each respective campaign. The Audit Module 432 may also automatically determine, and save to memory, an appropriate audit schedule for each respective campaign, which in some circumstances, may be editable by the user.

The Audit Module 432 may automatically determine the audit schedule based on the determined Risk Level of the campaign. For example, all campaigns with a Risk Level less than 10 may have a first audit schedule and all campaigns with a Risk Level of 10 or more may have a second audit schedule. The Audit Module 432 may also be operable determine the audit schedule based on the Overall Risk Assessment for the campaign (e.g., “low risk” campaigns may have a first predetermined audit schedule, “medium risk” campaigns may have a second predetermined audit schedule, “high risk” campaigns may have a third predetermined audit schedule, etc.).

In particular embodiments, the Audit Module 432 may automatically facilitate and monitor compliance with the determined audit schedules for each respective campaign. For example, the system may automatically generate one or more reminder emails to the respective owners of campaigns as the due date approaches. The system may also be adapted to allow owners of campaigns, or other users, to submit evidence of completion of an audit (e.g., by for example, submitting screen shots that demonstrate that the specified parameters of each campaign are being followed). In particular embodiments, the system is configured for, in response to receiving sufficient electronic information documenting completion of an audit, resetting the audit schedule (e.g., scheduling the next audit for the campaign according to a determined audit schedule, as determined above).

### II. Exemplary Audit Process

FIG. 6 illustrates an exemplary process performed by an Audit Module 432 for assigning an audit schedule and facilitating and managing compliance for a particular campaign. At step 605, the Audit Module 432 retrieves the Risk Level associated with the campaign. In exemplary embodiments, the Risk Level may be a numerical number, as determined above by the Risk Assessment Module 430. If the organization chooses, the Audit Module 432 may use the Overall Risk Assessment to determine which audit schedule for the campaign to assign.

At step 610, based on the Risk Level of the campaign (or the Overall Risk Assessment), or based on any other suitable factor, the Audit Module 432 can assign an audit schedule for the campaign. The audit schedule may be, for example, a timeframe (i.e., a certain amount of time, such as number of days) until the next audit on the campaign to be performed by the one or more owners of the campaign. The audit schedule may be a default schedule. For example, the Audit Module 432 can automatically apply an audit schedule of 120 days for any campaign having Risk Level of 10 and above. These default schedules may be modifiable. For example, the default audit schedule for campaigns having a Risk Level of 10 and above can be changed from 120 days to 150 days, such that any campaign having a Risk Level of 10 and above is assigned the customized default audit schedule (i.e., 150 days). Depending on laws, default policies, authority overrides, or the permission level of the user attempting to modify this default, the default might not be modifiable.

At step 615, after the audit schedule for a particular campaign has already been assigned, the Audit Module 432 determines if a user input to modify the audit schedule has been received. If a user input to modify the audit schedule has been received, then at step 620, the Audit Module 432 determines whether the audit schedule for the campaign is editable (i.e., can be modified). Depending on laws, default policies, authority overrides, or the permission level of the user attempting to modify the audit schedule, the campaign's audit schedule might not be modifiable.

At step 625, if the audit schedule is modifiable, then the Audit Module 432 will allow the edit and modify the audit schedule for the campaign. If at step 620 the Audit Module 432 determines that the audit schedule is not modifiable, in some exemplary embodiments, the user may still request permission to modify the audit schedule. For example, the Audit Module 432 can at step 630 provide an indication that the audit schedule is not editable, but also provide an indication to the user that the user may contact through the system one or more persons having the authority to grant or deny permission to modify the audit schedule for the campaign (i.e., administrators) to gain permission to edit the field. The Audit Module 432 may display an on-screen button that, when selected by the user, sends a notification (e.g., an email) to an administrator. The user can thus make a request to modify the audit schedule for the campaign in this manner.

At step 635, the Audit Module 432 may determine whether permission has been granted by an administrator to allow a modification to the audit schedule. It may make this determination based on whether it has received input from an administrator to allow modification of the audit schedule for the campaign. If the administrator has granted permission, the Audit Module 432 at step 635 may allow the edit of the audit schedule. If at step 640, a denial of permission is received from the administrator, or if a certain amount of time has passed (which may be customized or based on a default setting), the Audit Module 432 retains the audit schedule for the campaign by not allowing any modifications to the schedule, and the process may proceed to step 645. The Audit Module 432 may also send a reminder to the administrator that a request to modify the audit schedule for a campaign is pending.

At step 645, the Audit Module 432 determines whether a threshold amount of time (e.g., number of days) until the audit has been reached. This threshold may be a default value, or a customized value. If the threshold amount of time until an audit has been reached, the Audit Module 432 may at step 650 generate an electronic alert. The alert can be a message displayed to the collaborator the next time the collaborator logs into the system, or the alert can be an electronic message sent to one or more collaborators, including the campaign owners. The alert can be, for example, an email, an instant message, a text message, or one or more of these communication modalities. For example, the message may state, “This is a notification that an audit for Campaign Internet Browsing History is scheduled to occur in 90 days.” More than one threshold may be assigned, so that the owner of the campaign receives more than one alert as the scheduled audit deadline approaches. If the threshold number of days has not been reached, the Audit Module 432 will continue to evaluate whether the threshold has been reached (i.e., back to step 645).

In exemplary embodiments, after notifying the owner of the campaign of an impending audit, the Audit Module 432 may determine at step 655 whether it has received any indication or confirmation that the audit has been completed. In example embodiments, the Audit Module 432 allows for evidence of completion to be submitted, and if sufficient, the Audit Module 432 at step 660 resets the counter for the audit schedule for the campaign. For example, an audit may be confirmed upon completion of required electronic forms in which one or more collaborators verify that their respective portions of the audit process have been completed. Additionally, users can submit photos, screen shots, or other documentation that show that the organization is complying with that user's assigned portion of the campaign. For example, a database administrator may take a screen shot showing that all personal data from the campaign is being stored in the proper database and submit that to the system to document compliance with the terms of the campaign.

If at step 655, no indication of completion of the audit has been received, the Audit Module 432 can determine at step 665 whether an audit for a campaign is overdue (i.e., expired). If it is not overdue, the Audit Module 432 will continue to wait for evidence of completion (e.g., step 655). If the audit is overdue, the Audit Module 432 at step 670 generates an electronic alert (e.g., an email, instant message, or text message) to the campaign owner(s) or other administrators indicating that the audit is overdue, so that the organization can take responsive or remedial measures.

In exemplary embodiments, the Audit Module 432 may also receive an indication that an audit has begun (not shown), so that the status of the audit when displayed on inventory page 1500 shows the status of the audit as pending. While the audit process is pending, the Audit Module 432 may be operable to generate reminders to be sent to the campaign owner(s), for example, to remind the owner of the deadline for completing the audit.

### E. Data Flow Diagram Module

The system 100 may be operable to generate a data flow diagram based on the campaign data entered and stored, for example in the manner described above.

### I. Display of Security Indicators and Other Information

In various embodiments, a Data Flow Diagram Module is operable to generate a flow diagram for display containing visual representations (e.g., shapes) representative of one or more parts of campaign data associated with a campaign involving privacy (e.g., a privacy campaign involving the use of personal data), and the flow of that information from a source (e.g., customer), to a destination (e.g., an internet usage database), to which entities and computer systems have access (e.g., customer support, billing systems). Data Flow Diagram Module may also generate one or more security indicators for display. The indicators may include, for example, an “eye” icon to indicate that the data is confidential, a “lock” icon to indicate that the data, and/or a particular flow of data, is encrypted, or an “unlocked lock” icon to indicate that the data, and/or a particular flow of data, is not encrypted. In the example shown in FIG. 16, the dotted arrow lines generally depict respective flows of data, and the locked or unlocked lock symbols indicate whether those data flows are encrypted or unencrypted. The color of dotted lines representing data flows may also be colored differently based on whether the data flow is encrypted or non-encrypted, with colors conducive for viewing by those who suffer from color blindness.

### II. Exemplary Process Performed by Data Flow Diagram Module

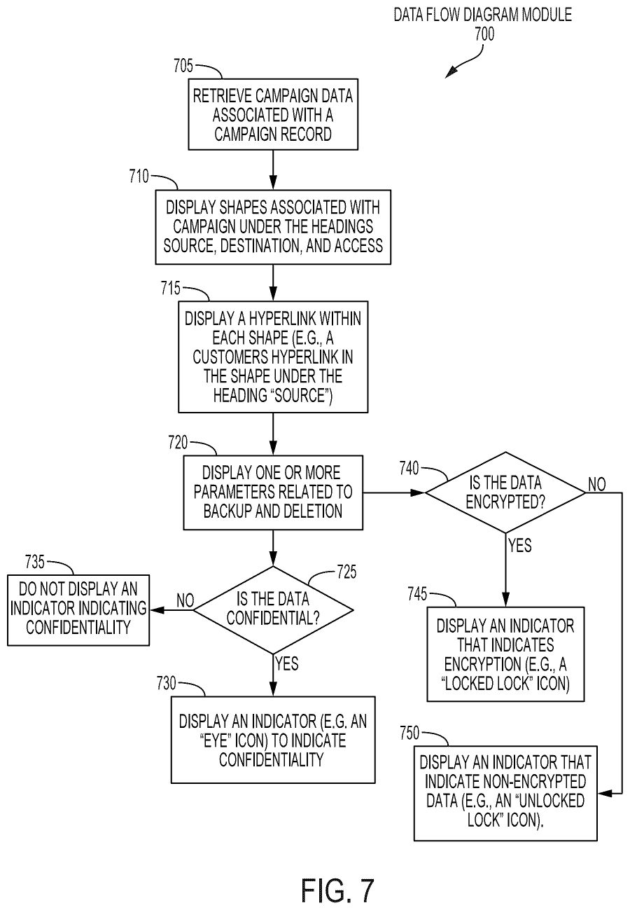

FIG. 7 shows an example process performed by the Data Flow Diagram Module 700.

At step 705, the Data Flow Diagram retrieves campaign data related to a privacy campaign record. The campaign data may indicate, for example, that the sensitive information related to the privacy campaign contains confidential information, such as the social security numbers of a customer.

At step 710, the Data Flow Diagram Module 700 is operable to display on-screen objects (e.g., shapes) representative of the Source, Destination, and Access, which indicate that information below the heading relates to the source of the personal data, the storage destination of the personal data, and access related to the personal data. In addition to campaign data regarding Source, Destination, and Access, the Data Flow Diagram Module 700 may also account for user defined attributes related to personal data, which may also be displayed as on-screen objects. The shape may be, for example, a rectangular box (see, e.g., FIG. 16). At step 715, the Data Flow Diagram Module 700 may display a hyperlink label within the on-screen object (e.g., as shown in FIG. 16, the word “Customer” may be a hyperlink displayed within the rectangular box) indicative of the source of the personal data, the storage destination of the personal data, and access related to the personal data, under each of the respective headings. When a user hovers over the hyperlinked word, the Data Flow Diagram is operable to display additional campaign data relating to the campaign data associated with the hyperlinked word. The additional information may also be displayed in a pop up, or a new page. For example, FIG. 16 shows that if a user hovers over the words “Customer,” the Data Flow Diagram Module 700 displays what customer information is associated with the campaign (e.g., the Subscriber ID, the IP and Mac Addresses associated with the Customer, and the customer's browsing and usage history). The Data Flow Diagram Module 700 may also generate for display information relating to whether the source of the data includes minors, and whether consent was given by the source to use the sensitive information, as well as the manner of the consent (for example, through an End User License Agreement (EULA)).

At step 720, the Data Flow Diagram Module 700 may display one or more parameters related to backup and retention of personal data related to the campaign, including in association with the storage destination of the personal data. As an example, Data Flow Diagram 1615 of FIG. 16 displays that the information in the Internet Usage database is backed up, and the retention related to that data is Unknown.

At 725, the Data Flow Diagram Module 700 determines, based on the campaign data associated with the campaign, whether the personal data related to each of the hyperlink labels is confidential. At Step 730, if the personal data related to each hyperlink label is confidential, the Data Flow Diagram Module 700 generates visual indicator indicating confidentiality of that data (e.g., an “eye” icon, as show in Data Flow Diagram 1615). If there is no confidential information for that box, then at step 735, no indicators are displayed. While this is an example of the generation of indicators for this particular hyperlink, in exemplary embodiments, any user defined campaign data may visual indicators that may be generated for it.

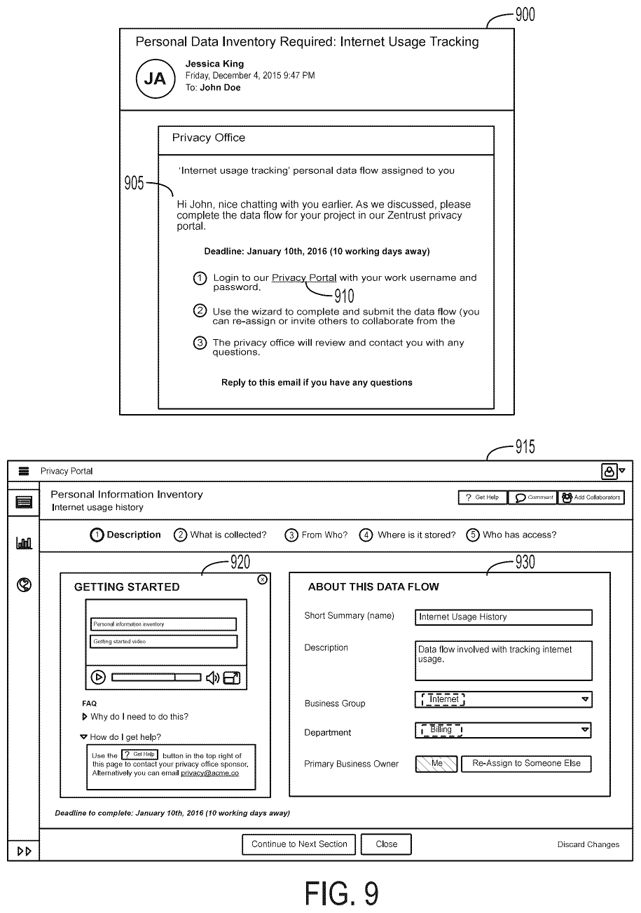

At step 740, the Data Flow Diagram Module 700 determined whether any of the data associated with the source, stored in a storage destination, being used by an entity or application, or flowing to one or more entities or systems (i.e., data flow) associated with the campaign is designated as encrypted. If the data is encrypted, then at step 745 the Data Flow Diagram Module 700 may generate an indicator that the personal data is encrypted (e.g., a “lock” icon). If the data is non-encrypted, then at step 750, the Data Flow Diagram Module 700 displays an indicator to indicate that the data or particular flow of data is not encrypted. (e.g., an “unlocked lock” icon). An example of a data flow diagram is depicted in FIG. 9. Additionally, the data flow diagram lines may be colored differently to indicate whether the data flow is encrypted or unencrypted, wherein the colors can still be distinguished by a color-blind person.

### F. Communications Module

In exemplary embodiments, a Communications Module of the System 100 may facilitate the communications between various owners and personnel related to a campaign. The Communications Module may retain contact information (e.g., emails or instant messaging contact information) input by campaign owners and other collaborators. The Communications Module can be operable to take a generated notification or alert (e.g., alert in step 670 generated by the Audit Module 432) and instantiate an email containing the relevant information. As mentioned above, the Main Compliance Module 400 may, for example through a Communications Module, be operable to send collaborators emails regarding their assignment of one or more portions of inputs to campaign data. Or through the Communications Module, selecting the commentators button brings up one or more collaborators that are on-line.

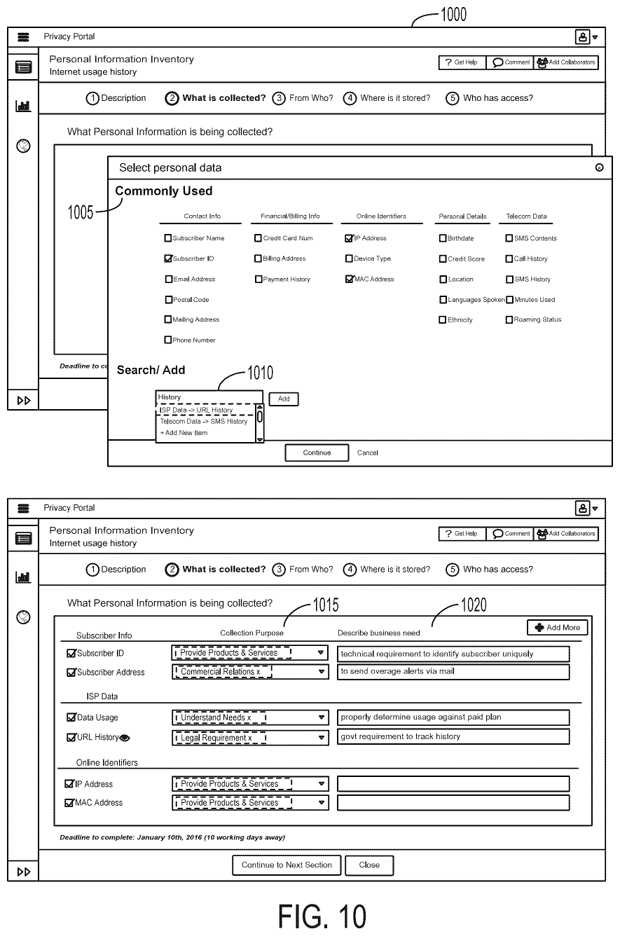

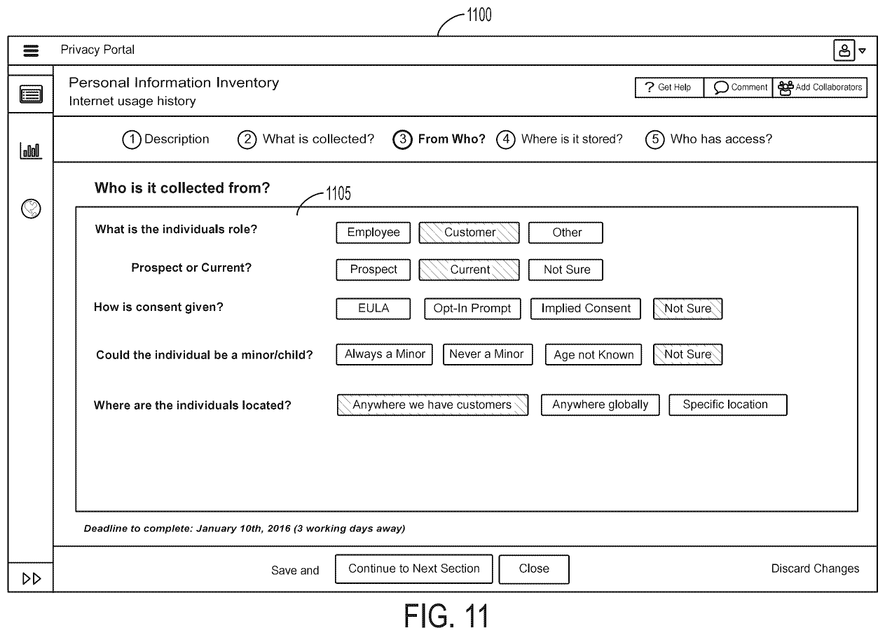

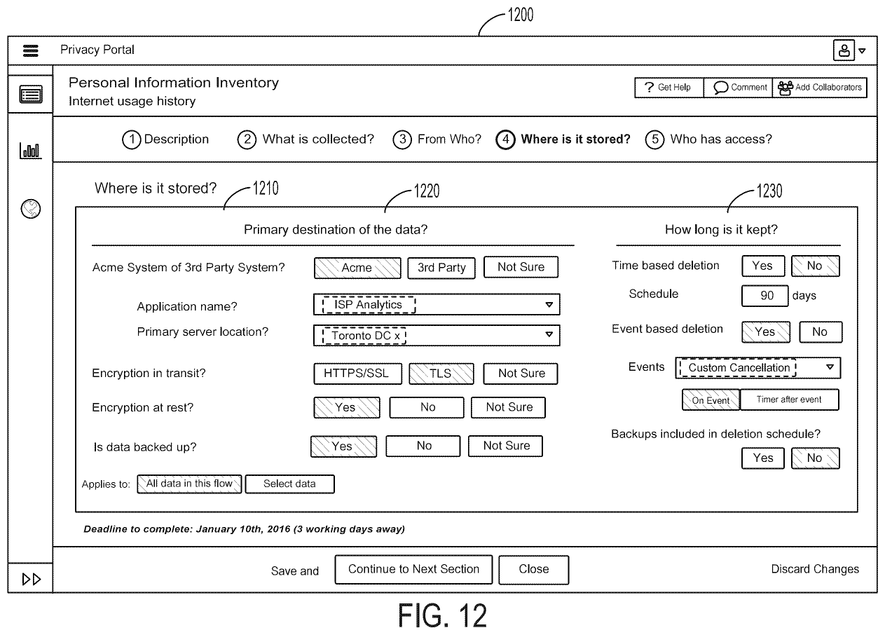

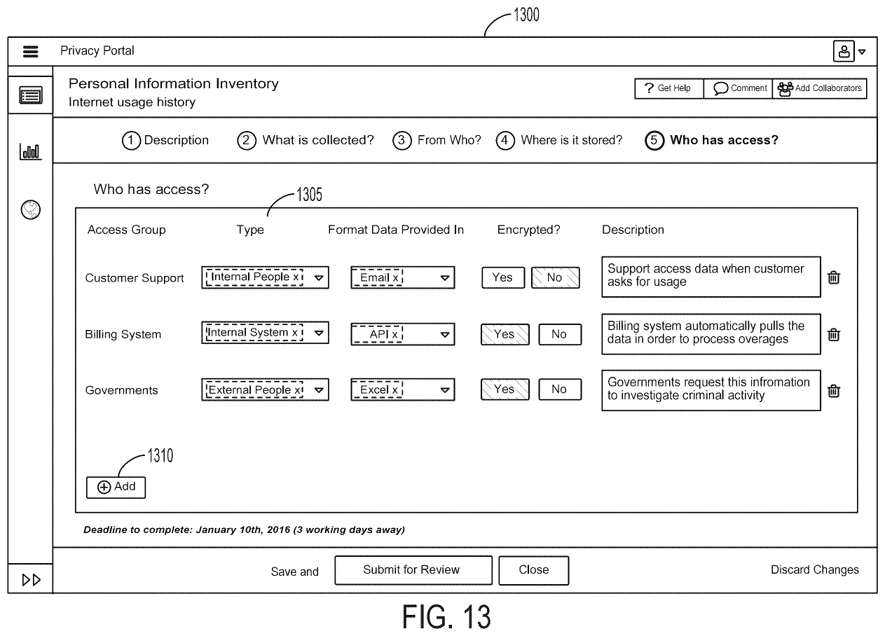

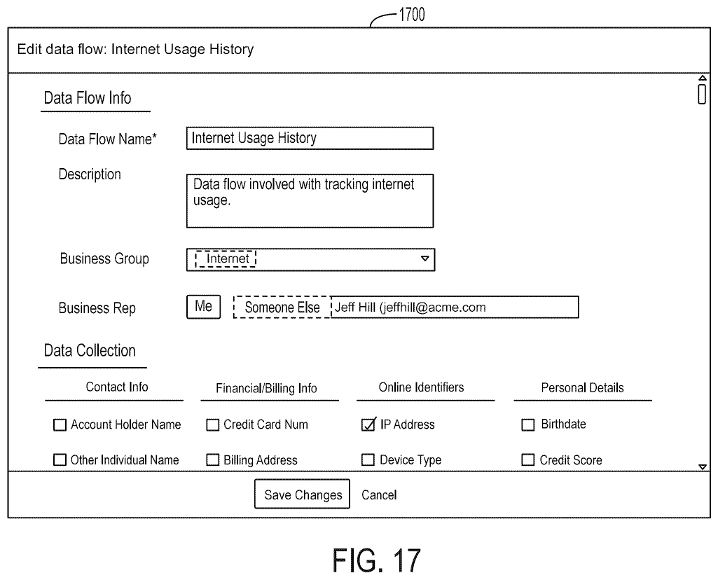

In exemplary embodiments, the Communications Module can also, in response to a user request (e.g., depressing the “comment” button show in FIG. 9, FIG. 10, FIG. 11, FIG. 12, FIG. 13, FIG. 16), instantiate an instant messaging session and overlay the instant messaging session over one or more portions of a GUI, including a GUI in which a user is presented with prompts to enter or select information. An example of this instant messaging overlay feature orchestrated by the Communications Module is shown in FIG. 17. While a real-time message session may be generated, off-line users may still be able to see the messages when they are back on-line.

The Communications Module may facilitate the generation of alerts that indicate that one or more emails or instant messages await a collaborator.

If campaign data inputs have been assigned to one or more collaborators, but those collaborators have not input the data yet, the Communications Module, may facilitate the sending of an electronic message (such as an email) alerting the collaborators and owners that they have not yet supplied their designated portion of campaign data.

### Exemplary User Experience

In the exemplary embodiments of the system for operationalizing compliance, adding a campaign (i.e., data flow) comprises gathering information that includes several phases: (1) a description of the campaign; (2) the personal data to be collected as part of the campaign; (3) who the personal data relates to; (4) where the personal data be stored; and (5) who will have access to the indicated personal data.

### A. FIG. 8: Campaign Record Creation and Collaborator Assignment

FIGS. 8-17 provide examples of graphical user interfaces that can be used in gathering information for a campaign involving privacy. Similar graphical user interfaces can be used in gathering information for a campaign involving use of AI. FIG. 8 illustrates an example of the first phase of information gathering to add a campaign. In FIG. 8, a description entry dialog 800 may have several fillable/editable fields and drop-down selectors. In this example, the user may fill out the name of the campaign in the Short Summary (name) field 805, and a description of the campaign in the Description field 810. The user may enter or select the name of the business group (or groups) that will be accessing personal data for the campaign in the Business Group field 815. The user may select the primary business representative responsible for the campaign (i.e., the campaign's owner), and designate him/herself, or designate someone else to be that owner by entering that selection through the Someone Else field 820. Similarly, the user may designate him/herself as the privacy office representative owner for the campaign, or select someone else from the second Someone Else field 825. At any point, a user assigned as the owner may also assign others the task of selecting or answering any question related to the campaign. The user may also enter one or more tag words associated with the campaign in the Tags field 830. After entry, the tag words may be used to search for campaigns, or used to filter for campaigns (for example, under Filters 845). The user may assign a due date in a Due Date field 835 for completing the campaign entry, and turn reminders for the campaign on or off. The user may save and continue, or assign and close.

In example embodiments, some of the fields may be filled in by a user, with suggest-as-you-type display of possible field entries (e.g., Business Group field 815), and/or may include the ability for the user to select items from a drop-down selector (e.g., drop-down selectors 840a, 840b, 840c). The system may also allow some fields to stay hidden or unmodifiable to certain designated viewers or categories of users. For example, the purpose behind a campaign may be hidden from anyone who is not the chief privacy officer of the company, or the retention schedule may be configured so that it cannot be modified by anyone outside of the organization‘s’ legal department.

### B. FIG. 9: Collaborator Assignment Notification and Description Entry

Moving to FIG. 9, in example embodiments, if another business representative (owner), or another privacy office representative has been assigned to the campaign (e.g., John Doe in FIG. 8), the system may send a notification (e.g., an electronic notification) to the assigned individual, letting them know that the campaign has been assigned to him/her. FIG. 9 shows an example notification 900 sent to John Doe that is in the form of an email message. The email informs him that the campaign “Internet Usage Tracking” has been assigned to him, and provides other relevant information, including the deadline for completing the campaign entry and instructions to log in to the system to complete the campaign (data flow) entry (which may be done, for example, using a suitable “wizard” program). The user that assigned John ownership of the campaign may also include additional comments 905 to be included with the notification 900. Also included may be an option to reply to the email if an assigned owner has any questions.

In this example, if John selects the hyperlink Privacy Portal 910, he is able to access the system, which displays a landing page 915. The landing page 915 displays a Getting Started section 920 to familiarize new owners with the system, and also display an “About This Data Flow” section 930 showing overview information for the campaign.

### C. FIG. 10: What Personal Data is Collected

Moving to FIG. 10, after the first phase of campaign addition (i.e., description entry phase), the system may present the user (who may be a subsequently assigned business representative or privacy officer) with a dialog 1000 from which the user may enter in the type of personal data being collected.

In addition, questions are described generally as transitional questions, but the questions may also include one or more smart questions in which the system is configured to: (1) pose an initial question to a user and, (2) in response to the user's answer satisfying certain criteria, presenting the user with one or more follow-up questions. For example, in FIG. 10, if the user responds with a choice to add personal data, the user may be additionally presented follow-up prompts, for example, the select personal data window overlaying screen 1005 that includes commonly used selections may include, for example, particular elements of an individual's contact information (e.g., name, address, email address), Financial/Billing Information (e.g., credit card number, billing address, bank account number), Online Identifiers (e.g., IP Address, device type, MAC Address), Personal Details (Birthdate, Credit Score, Location), or Telecommunication Data (e.g., Call History, SMS History, Roaming Status). The System 100 is also operable to pre-select or automatically populate choices—for example, with commonly-used selections, some of the boxes may already be checked. The user may also use a search/add tool 1010 to search for other selections that are not commonly used and add another selection. Based on the selections made, the user may be presented with more options and fields. For example, if the user selected “Subscriber ID” as personal data associated with the campaign, the user may be prompted to add a collection purpose under the heading Collection Purpose 1015, and the user may be prompted to provide the business reason why a Subscriber ID is being collected under the “Describe Business Need” heading 1020.

### D. FIG. 11: Who Personal Data is Collected From

As displayed in the example of FIG. 11, the third phase of adding a campaign may relate to entering and selecting information regarding who the personal data is gathered from. As noted above, the personal data may be gathered from, for example, one or more Subjects 300. In the exemplary “Collected From” dialog 1100, a user may be presented with several selections in the “Who Is It Collected From” section 1105. These selections may include whether the personal data was to be collected from an employee, customer, or other entity. Any entities that are not stored in the system may be added. The selections may also include, for example, whether the data was collected from a current or prospective subject (e.g., a prospective employee may have filled out an employment application with his/her social security number on it). Additionally, the selections may include how consent was given, for example through an end user license agreement (EULA), on-line Opt-in prompt, Implied consent, or an indication that the user is not sure. Additional selections may include whether the personal data was collected from a minor, and where the subject is located.

### E. FIG. 12: Where is the Personal Data Stored

FIG. 12 shows an example “Storage Entry” dialog screen 1200, which is a graphical user interface that a user may use to indicate where particular sensitive information is to be stored within the system. From this section 1210, a user may specify, in this case for the Internet Usage History campaign, the primary destination of the personal data 1220 and how long the personal data is to be kept 1230. The personal data may be housed by the organization (in this example, an entity called “Acme”) or a third party. The user may specify an application associated with the personal data's storage (in this example, ISP Analytics), and may also specify the location of computing systems (e.g., servers) that will be storing the personal data (e.g., a Toronto data center). Other selections indicate whether the data will be encrypted and/or backed up.

The system also allows the user to select whether the destination settings are applicable to all the personal data of the campaign, or just select data (and if so, which data). In FIG. 12, the user may also select, and input options related to the retention of the personal data collected for the campaign (e.g., How Long Is It Kept 1230). The retention options may indicate, for example, that the campaign's personal data should be deleted after a per-determined period of time has passed (e.g., on a particular date), or that the campaign's personal data should be deleted in accordance with the occurrence of one or more specified events (e.g., in response to the occurrence of a particular event, or after a specified period of time passes after the occurrence of a particular event), and the user may also select whether backups should be accounted for in any retention schedule. For example, the user may specify that any backups of the personal data should be deleted (or, alternatively, retained) when the primary copy of the personal data is deleted.

F. FIG. 13: Who and What Systems have Access to Personal Data

FIG. 13 describes an example Access entry dialog screen 1300. As part of the process of adding a campaign or data flow, the user may specify in the “Who Has Access” section 1305 of the dialog screen 1300. In the example shown, the Customer Support, Billing, and Government groups within the organization are able to access the Internet Usage History personal data collected by the organization. Within each of these access groups, the user may select the type of each group, the format in which the personal data was provided, and whether the personal data is encrypted. The access level of each group may also be entered. The user may add additional access groups via the Add Group button 1310.

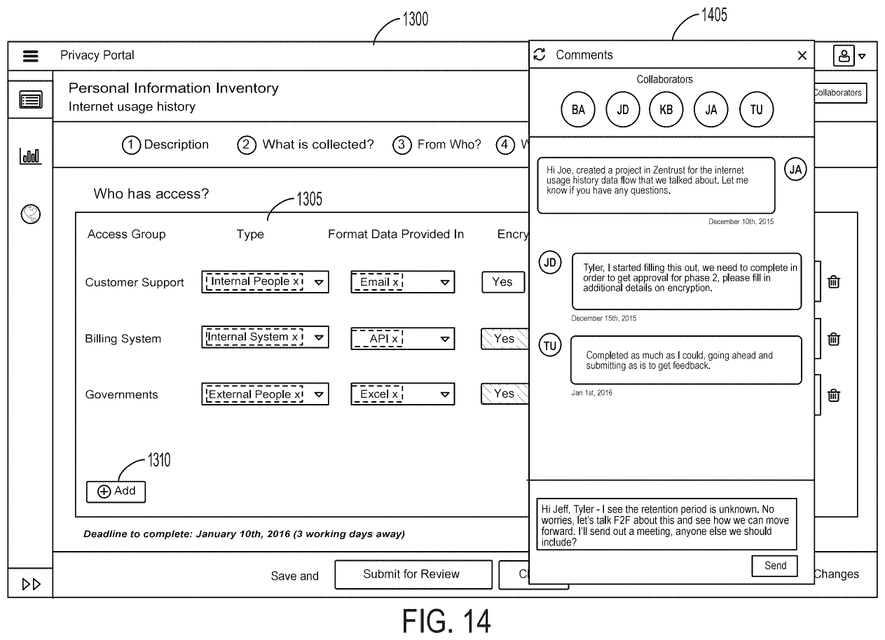

### G. Facilitating Entry of Campaign Data, Including Chat Shown in FIG. 14

As mentioned above, to facilitate the entry of data collected through the example GUIs shown in FIGS. 8 through 12, in exemplary embodiments, the system is adapted to allow the owner of a particular campaign (or other user) to assign certain sections of questions, or individual questions, related to the campaign to contributors other than the owner. This may eliminate the need for the owner to contact other users to determine information that they do not know and then enter the information into the system themselves. Rather, in various embodiments, the system facilitates the entry of the requested information directly into the system by the assigned users.

In exemplary embodiments, after the owner assigns a respective responsible party to each question or section of questions that need to be answered in order to fully populate the data flow, the system may automatically contact each user (e.g., via an appropriate electronic message) to inform the user that they have been assigned to complete the specified questions and/or sections of questions, and provide those users with instructions as to how to log into the system to enter the data. The system may also be adapted to periodically follow up with each user with reminders until the user completes the designated tasks. As discussed elsewhere herein, the system may also be adapted to facilitate real-time text or voice communications between multiple collaborators as they work together to complete the questions necessary to define the data flow. Together, these features may reduce the amount of time and effort needed to complete each data flow.

To further facilitate collaboration, as shown FIG. 14, in exemplary embodiments, the System 100 is operable to overlay an instant messaging session over a GUI in which a user is presented with prompts to enter or select information. In FIG. 14, a communications module is operable to create an instant messaging session window 1405 that overlays the Access entry dialog screen 1300. In exemplary embodiments, the Communications Module, in response to a user request (e.g., depressing the “comment” button show in FIG. 9, FIG. 10, FIG. 11, FIG. 12, FIG. 13, FIG. 16), instantiates an instant messaging session and overlays the instant messaging session over one or more portions of the GUI.

### H: FIG. 15: Campaign Inventory Page

After new campaigns have been added, for example using the exemplary processes explained in regard to FIGS. 8-13, the users of the system may view their respective campaign or campaigns, depending on whether they have access to the campaign. The chief privacy officer, or another privacy office representative, for example, may be the only user that may view all campaigns. A listing of all of the campaigns within the system may be viewed on, for example, inventory page 1500 (see below). Further details regarding each campaign may be viewed via, for example, campaign information page 1600, which may be accessed by selecting a particular campaign on the inventory page 1500. And any information related to the campaign may be edited or added through, for example, the edit campaign dialog 1700 screen. Certain fields or information may not be editable, depending on the particular user's level of access. A user may also add a new campaign using a suitable user interface, such as the graphical user interface shown in FIG. 15 or FIG. 16.

In example embodiments, the System 100 (and more particularly, the Main Compliance Module 400) may use the history of past entries to suggest selections for users during campaign creation and entry of associated data. As an example, in FIG. 10, if most entries that contain the term “Internet” and have John Doe as the business rep assigned to the campaign have the items Subscriber ID, IP Address, and MAC Address selected, then the items that are commonly used may display as pre-selected items the Subscriber ID, IP address, and MAC Address each time a campaign is created having Internet in its description and John Doe as its business rep.

FIG. 15 describes an example embodiment of an inventory page 1500 that may be generated by the Main Compliance Module 400. The inventory page 1500 may be represented in a graphical user interface. Each of the graphical user interfaces (e.g., webpages, dialog boxes, etc.) presented in this application may be, in various embodiments, an HTML-based page capable of being displayed on a web browser (e.g., Firefox, Internet Explorer, Google Chrome, Opera, etc.), or any other computer-generated graphical user interface operable to display information, including information having interactive elements (e.g., an iOS, Mac OS, Android, Linux, or Microsoft Windows application). The webpage displaying the inventory page 1500 may include typical features such as a scroll-bar, menu items, as well as buttons for minimizing, maximizing, and closing the webpage. The inventory page 1500 may be accessible to the organization's chief privacy officer, or any other of the organization's personnel having the need, and/or permission, to view personal data.

Still referring to FIG. 15, inventory page 1500 may display one or more campaigns listed in the column heading Data Flow Summary 1505, as well as other information associated with each campaign, as described herein. Some of the exemplary listed campaigns include Internet Usage History 1510, Customer Payment Information, Call History Log, Cellular Roaming Records, etc. A campaign may represent, for example, a business operation that the organization is engaged in may require the use of personal data, which may include the personal data of a customer. In the campaign Internet Usage History 1510, for example, a marketing department may need customers' on-line browsing patterns to run analytics. Examples of more information that may be associated with the Internet Usage History 1510 campaign will be presented in FIG. 4 and FIG. 5. In example embodiments, clicking on (i.e., selecting) the column heading Data Flow Summary 1505 may result in the campaigns being sorted either alphabetically, or reverse alphabetically.

The inventory page 1500 may also display the status of each campaign, as indicated in column heading Status 1515. Exemplary statuses may include “Pending Review”, which means the campaign has not been approved yet, “Approved,” meaning the data flow associated with that campaign has been approved, “Audit Needed,” which may indicate that a privacy audit of the personal data associated with the campaign is needed, and “Action Required,” meaning that one or more individuals associated with the campaign must take some kind of action related to the campaign (e.g., completing missing information, responding to an outstanding message, etc.). In certain embodiments, clicking on (i.e., selecting) the column heading Status 1515 may result in the campaigns being sorted by status.

The inventory page 1500 of FIG. 15 may list the “source” from which the personal data associated with a campaign originated, under the column heading “Source” 1520. The sources may include one or more of the subjects 100 in example FIG. 1. As an example, the campaign “Internet Usage History” 1510 may include a customer's IP address or MAC address. For the example campaign “Employee Reference Checks,” the source may be a particular employee. In example embodiments, clicking on (i.e., selecting) the column heading Source 1520 may result in the campaigns being sorted by source.

The inventory page 1500 of FIG. 15 may also list the “destination” of the personal data associated with a particular campaign under the column heading Destination 1525. Personal data may be stored in any of a variety of places, for example on one or more storage devices 280 that are maintained by a particular entity at a particular location. Different custodians may maintain one or more of the different storage devices. By way of example, referring to FIG. 15, the personal data associated with the campaign Internet Usage History 1510 may be stored in a repository located at the Toronto data center, and the repository may be controlled by the organization (e.g., Acme corporation) or another entity, such as a vendor of the organization that has been hired by the organization to analyze the customer's internet usage history. Alternatively, storage may be with a department within the organization (e.g., its marketing department). In example embodiments, clicking on (i.e., selecting) the column heading Destination 1525 may result in the campaigns being sorted by destination.

On the inventory page 1500, the column heading Access 1530 may show the number of transfers that the personal data associated with a campaign has undergone. In example embodiments, clicking on (i.e., selecting) the column heading “Access” 1530 may result in the campaigns being sorted by Access.

The column with the heading Audit 1535 shows the status of any privacy audits associated with the campaign. Privacy audits may be pending, in which an audit has been initiated but yet to be completed. The audit column may also show for the associated campaign how many days have passed since a privacy audit was last conducted for that campaign. (e.g., 140 days, 360 days). If no audit for a campaign is currently required, an “OK” or some other type of indication of compliance (e.g., a “thumbs up” indicia) may be displayed for that campaign's audit status. Campaigns may also be sorted based on their privacy audit status by selecting or clicking on the heading Audit 1535.

In example inventory page 1500, an indicator under the heading Risk 1540 may also display an indicator as to the Risk Level associated with the personal data for a particular campaign. As described earlier, a risk assessment may be made for each campaign based on one or more factors that may be obtained by the system. The indicator may, for example, be a numerical score (e.g., Risk Level of the campaign), or, as in the example shown in FIG. 15, it may be arrows that indicate the Overall Risk Assessment for the campaign. The arrows may be of different shades, or different colors (e.g., red arrows indicating “high risk” campaigns, yellow arrows indicating “medium risk” campaigns, and green arrows indicating “low risk” campaigns). The direction of the arrows—for example, pointing upward or downward, may also provide a quick indication of Overall Risk Assessment for users viewing the inventory page 1500. Each campaign may be sorted based on the Risk Level associated with the campaign.

The example inventory page 1500 may comprise a filter tool, indicated by Filters 1545, to display only the campaigns having certain information associated with them. For example, as shown in FIG. 15, under Collection Purpose 1550, checking the boxes “Commercial Relations,” “Provide Products/Services”, “Understand Needs,” “Develop Business & Ops,” and “Legal Requirement” will result the display under the Data Flow Summary 1505 of only the campaigns that meet those selected collection purpose requirements.

From example inventory page 1500, a user may also add a campaign by selecting (i.e., clicking on) Add Data Flow button 1555. Once this selection has been made, the system initiates a routine to guide the user in a phase-by-phase manner through the process of creating a new campaign (further details herein). An example of the multi-phase GUIs in which campaign data associated with the added privacy campaign may be input and associated with the privacy campaign record is described in FIG. 8-13 above.

From the example inventory page 1500, a user may view the information associated with each campaign in more depth, or edit the information associated with each campaign. To do this, the user may, for example, click on or select the name of the campaign (i.e., click on Internet Usage History 1510). As another example, the user may select a button displayed on screen indicating that the campaign data is editable (e.g., edit button 1560).

### I: FIG. 16: Campaign Information Page and Data Flow Diagram

FIG. 16 shows an example of information associated with each campaign being displayed in a campaign information page 1600. Campaign information page 1600 may be accessed by selecting (i.e., clicking on), for example, the edit button 1560. In this example, Personal Data Collected section 1605 displays the type of personal data collected from the customer for the campaign Internet Usage History. The type of personal data, which may be stored as data elements associated with the Internet Usage History campaign digital record entry. The type of information may include, for example, the customer's Subscriber ID, which may be assigned by the organization (e.g., a customer identification number, customer account number). The type of information may also include data associated with a customer's premises equipment, such as an IP Address, MAC Address, URL History (i.e., websites visited), and Data Consumption (i.e., the number of megabytes or gigabytes that the user has download).

Still referring to FIG. 16, the “About this Data Flow” section 1610 displays relevant information concerning the campaign, such as the purpose of the campaign. In this example, a user may see that the Internet Usage History campaign is involved with the tracking of internet usage from customers in order to bill appropriately, manage against quotas, and run analytics. The user may also see that the business group that is using the sensitive information associated with this campaign is the Internet group. A user may further see that the next privacy audit is scheduled for Jun. 10, 2016, and that the last update of the campaign entry was Jan. 2, 2015. The user may also select the “view history” hyperlink to display the history of the campaign.

FIG. 16 also depicts an example of a Data Flow Diagram 1615 generated by the system, based on information provided for the campaign. The Data Flow Diagram 1615 may provide the user with a large amount of information regarding a particular campaign in a single compact visual. In this example, for the campaign Internet Usage History, the user may see that the source of the personal data is the organization's customers. In example embodiments, as illustrated, hovering the cursor (e.g., using a touchpad, or a mouse) over the term “Customers” may cause the system to display the type of sensitive information obtained from the respective consumers, which may correspond with the information displayed in the “Personal Data Collected” section 1605.

In various embodiments, the Data Flow Diagram 1615 also displays the destination of the data collected from the User (in this example, an Internet Usage Database), along with associated parameters related to backup and deletion. The Data Flow Diagram 1615 may also display to the user which department(s) and what system(s) have access to the personal data associated with the campaign. In this example, the Customer Support Department has access to the data, and the Billing System may retrieve data from the Internet Usage Database to carry out that system's operations. In the Data Flow Diagram 1615, one or more security indicators may also be displayed. They may include, for example, an “eye” icon to indicate that the data is confidential, a “lock” icon to indicate that the data, and/or a particular flow of data, is encrypted, or an “unlocked lock” icon to indicate that the data, and/or a particular flow of data, is not encrypted. In the example shown in FIG. 16, the dotted arrow lines generally depict respective flows of data, and the locked or unlocked lock symbols indicate whether those data flows are encrypted or unencrypted.

Campaign information page 1600 may also facilitate communications among the various personnel administrating the campaign and the personal data associated with it. Collaborators may be added through the Collaborators button 1625. The system may draw information from, for example, an active directory system, to access the contact information of collaborators.

If Comment button 1630 is selected, a real-time communication session (e.g., an instant messaging session) among all (or some) of the collaborators may be instantiated and overlaid on top of the page 1600. This may be helpful, for example, in facilitating population of a particular page of data by multiple users. In example embodiments, the Collaborators button 1625 and Comment button 1630 may be included on any graphical user interface described herein, including dialog boxes in which information is entered or selected. Likewise, any instant messaging session may be overlaid on top of a webpage or dialog box. The system may also use the contact information to send one or more users associated with the campaign periodic updates, or reminders. For example, if the deadline to finish entering the campaign data associated with a campaign is upcoming in three days, the business representative of that assigned campaign may be sent a message reminding him or her that the deadline is in three days.

Like inventory page 1500, campaign information page 1600 also allows for campaigns to be sorted based on risk (e.g., Sort by Risk 1635). Thus, for example, a user is able to look at the information for campaigns with the highest risk assessment.

### J: FIG. 17: Edit Campaign Dialog

FIG. 17 depicts an example of a dialog box—the edit campaign dialog 1700. The edit campaign dialog 1700 may have editable fields associated with a campaign. In this example, the information associated with the Internet Usage History campaign may be edited via this dialog. This includes the ability for the user to change the name of the campaign, the campaign's description, the business group, the current owner of the campaign, and the particular personal data that is associated with the campaign (e.g., IP address, billing address, credit score, etc.). In example embodiments, the edit campaign dialog 1700 may also allow for the addition of more factors, checkboxes, users, etc.

The system 100 also includes a Historical Record Keeping Module, wherein every answer, change to answer, as well as assignment/re-assignment of owners and collaborators is logged for historical record keeping.

### Additional Aspects of System

1. Standardized and Customized Assessment of Vendors' Compliance with Privacy and/or Security Policies and/or Policies Involving the Use of AI

In particular embodiments, the system may be adapted to: (1) facilitate the assessment of one or more vendors' compliance with one or more privacy and/or security policies, as well as policies involving the use of AI; and (2) allow organizations (e.g., companies or other organizations) who do business with the vendors to create, view and/or apply customized criteria to information periodically collected by the system to evaluate each vendor's compliance with one or more of the company's specific privacy and/or security policies and/or policies involving the use of AI. In various embodiments, the system may also flag any assessments, projects, campaigns, and/or data flows that the organization has documented and maintained within the system if those data flows are associated with a vendor that has its rating changed so that the rating meets certain criteria (e.g., if the vendor's rating falls below a predetermined threshold).

In particular embodiments:
The system may include an online portal and community that includes a listing of all supported vendors.
An appropriate party (e.g., the participating vendor or a member of the on-line community) may use the system to submit an assessment template that is specific to a particular vendor.
If the template is submitted by the vendor itself, the template may be tagged in any appropriate way as “official.”
An instance for each organization using the system (i.e., customer) is integrated with this online community/portal so that the various assessment templates can be directly fed into that organization's instance of the system if the organization wishes to use it.
Vendors may subscribe to a predetermined standardized assessment format.
Assessment results may also be stored in the central community/portal.
A third party privacy and/or security policy compliance assessor and/or third party AI use policy compliance assessor, on a schedule, may (e.g., periodically) complete the assessment of the vendor.
Each organization using the system can subscribe to the results (e.g., once they are available).
Companies can have one or more customized rules set up within the system for interpreting the results of assessments in their own unique way. For example:
Each customer can weight each question within an assessment as desired and set up addition/multiplication logic to determine an aggregated risk score that takes into account the customized weightings given to each question within the assessment.
Based on new assessment results—the system may notify each customer if the vendor's rating falls, improves, or passes a certain threshold.
The system can flag any assessments, projects, campaigns, and/or data flows that the customer has documented and maintained within the system if those data flows are associated with a vendor that has its rating changed.
   2. Policy Compliance System that Facilitates Communications with Regulators (Including Translation Aspect)

In particular embodiments, the system is adapted to interface with the computer systems of regulators (e.g., government regulatory agencies) that are responsible for approving campaigns. This may, for example, allow the regulators to review campaign information directly within particular instances of the system and, in some embodiments, approve the campaigns electronically.

In various embodiments, the system may implement this concept by:
Exporting relevant data regarding the campaign, from an organization's instance of the system (e.g., customized version of the system) in standardized format (e.g., PDF or Word) and sending the extracted data to an appropriate regulator for review (e.g., in electronic or paper format).
Either regular provides the format that the system codes to, or the organization associated with the system provides a format that the regulators are comfortable with.
Send secure link to regulator that gives them access to comment and leave feedback
Gives the regulator direct access to the organization's instance of the system with a limited and restricted view of just the projects and associated audit and commenting logs the organization needs reviewed.
Regulator actions are logged historically, and the regulator can leave guidance, comments, and questions, etc.
Have portal for regulator that securely links to the systems of their constituents.

### Details:

When submitted—the PIAs are submitted with requested priority-standard or expedited.
DPA specifies how many expedited requests individuals are allowed to receive.
Either the customer or DPA can flag a PIA or associated comments/guidance on the PIA with “needs translation” and that can trigger an automated or manual language translation.
Regulator could be a DPA “data protection authority” in any EU country, or other country with similar concept like FTC in US, or OPC in Canada.
   3. Systems/Methods for Measuring the Privacy and/or Use of AI Maturity of a Business Group within an Organization.

In particular embodiments, the system is adapted for automatically measuring the privacy and/or use of AI of a business group, or other group, within a particular organization that is using the system. This may provide an automated way of measuring the privacy and/or user of AI maturity, and one or more trends of change in privacy and/or use of AI maturity of the organization, or a selected sub-group of the organization.

In various embodiments, the organization using the system can customize one or more algorithms used by the system to measure the privacy and/or use of AI maturity of a business group (e.g., by specifying one or more variables and/or relative weights for each variable in calculating a privacy maturity score for the group). The following are examples of variables that may be used in this process:
Issues/Risks found in submitted assessments that are unmitigated or uncaught prior to the assessment being submitted
   % of assessments with high issues/total assessments
   % with medium
   % with low
Size and type of personal data and/or AI used by the group
   Total assessments done
   Number of projects/campaigns with personal data and/or AI
   Amount of personal data and/or level of AI being used
   Volume of data transfers to internal and external parties
Training of the people in the group
   Number or % of individuals who have watched training, readings, or videos
   Number or % of individuals who have completed quizzes or games for training
   Number or % of individuals who have attended privacy and/or AI educational events either internally or externally
   Number or % of individuals who are members of IAPP
   Number or % of individuals who have been specifically trained in privacy and/or AI technology either internally or externally, formally (e.g., IAPP certification) or informally
   Usage of an online version of the system, or mobile training or communication portal that customer has implemented
Other factors
   4. Automated Assessment of Compliance (Scan App or Website to Determine Behavior/Compliance with Privacy Policies and/or Policies on AI Use)

In various embodiments, instead of determining whether an organization complies with the defined parameters of a campaign by, for example, conducting an audit as described above (e.g., by asking users to answer questions regarding the campaign, such as “what is collected” “what cookies are on your website”, “what AI functionality is being performed on your website,” etc.), the system may be configured to automatically determine whether the organization is complying with one or more aspects of the policy.

For example, during the audit process, the system may obtain a copy of a software application (e.g., an “app”) that is collecting and/or using sensitive user information and/or using AI, and then automatically analyze the app to determine whether the operation of the app is complying with the terms of the campaign that govern use of the app.

Similarly, the system may automatically analyze a website that is collecting and/or using sensitive user information and/or using AI to determine whether the operation of the web site is complying with the terms of the campaign that govern use of the web site.

In regard to various embodiments of the automatic application-analyzing embodiment referenced above:
The typical initial questions asked during an audit may be replaced by a request to “Upload your app here”.
   After the app is uploaded to the system, the system detects what privacy permissions and data the app is collecting from users and/or what AI functionality is performed by the app.
   This is done by having the system use static or behavioral analysis of the application, or by having the system integrate with a third party system or software (e.g., Veracode), which executes the analysis.
   During the analysis of the app, the system may detect, for example, whether the app is using location services to detect the location of the user's mobile device. In another example, the system may detect whether the app is using some type of machine-learning algorithm to perform AI functionality.
   In response to determining that the app is collecting one or more specified types of sensitive information (e.g., the location of the user's mobile device) and/or using a certain type of AI functionality, the system may automatically request follow up information from the user by posing one or more questions to the user, such as:
      For what business reason is the data being collected?
      For what purpose is the AI being performed?
      How is the user's consent given to obtain the data?
      How is the AI developed and/or maintained?
      Would users be surprised that the data is being collected and/or the AI is being used?
      Is the data encrypted at rest and/or in motion?
      What would happen if the system did not collect this data or use the AI? What business impact would it have?
      In various embodiments, the system is adapted to allow each organization to define these follow-up questions, but the system asks the questions (e.g., the same questions, or a customized list of questions) for each issue that is found in the app.
   In various embodiments, after a particular app is scanned a first time, when the app is scanned, the system may only detect and analyze any changes that have been made to the app since the previous scan of the app.
   In various embodiments, the system is adapted to (optionally) automatically monitor (e.g., continuously monitor) one or more online software application marketplaces (such as Microsoft, Google, or Apple's App Store) to determine whether the application has changed. If so, the system may, for example: (1) automatically scan the application as discussed above; and (2) automatically notify one or more designated individuals (e.g., privacy office representatives) that an app was detected that the business failed to perform an assessment on prior to launching the application.

In regard to various embodiments of the automatic application-analyzing embodiment referenced above:
The system prompts the user to enter the URL of the website to be analyzed, and, optionally, the URL to the privacy policy that applies to the web site.
The system then scans the website for functionality such as machine-learning algorithms, voice to text technology, cookies, and/or other tracking mechanisms such as fingerprinting technologies and/or 3rd party SDKs.
   The system may then optionally ask the user to complete a series of one or more follow-up questions for each of these items found during the scan of the website.
   This may help the applicable office craft a privacy policy and/or responsible AI use policy to be put on the website to disclose the use of the tracking technologies, use of SDKs on the website, use of AI functionality on the website, and/or like.
The system may then start a continuous monitoring of the website site to detect whether any new AI technology, cookies, SDKs, or tracking technologies are used. In various embodiments, the system is configured to, for example, generate an alert to an appropriate individual (e.g., a designated privacy officer) to inform them of the change to the website. Personnel such as a privacy officer or an ethics officer may use this information, for example, to determine whether to modify the policy for the website or to coordinate discontinuing use of the new AI technology, cookies, tracking technologies and/or SDK's.
In various embodiments, the system may also auto-detect whether any changes have been made to the policy or the location of the policy link on the page and, in response to auto-detecting such changes, trigger an audit of the project.
It should be understood that the above methods of automatically assessing behavior and/or compliance with one or more policies may be done in any suitable way (e.g., ways other than website scanning and app scanning). For example, the system may alternatively, or in addition, automatically detect, scan and/or monitor any appropriate technical system(s) (e.g., computer system and/or system component or software), cloud services, apps, websites and/or data structures, etc.
   5. System Integration with DLP Tools.

DLP tools are traditionally used by information security professionals. Various DLP tools discover where confidential, sensitive, and/or personal information is stored and use various techniques to automatically discover sensitive data within a particular computer system—for example, in emails, on a particular network, in databases, etc. DLP tools can detect the data, what type of data, the amount of data, and whether the data is encrypted. This may be valuable for security professionals, but these tools are typically not useful for privacy professionals because the tools typically cannot detect certain privacy attributes that are required to be known to determine whether an organization is in compliance with particular privacy policies.

For example, traditional DLP tools cannot typically answer the following questions:
Who was the data collected from (data subject)?
Where are those subjects located?
Are they minors?
How was consent to use the data received?
What is the use of the data?
Is the use consistent with the use specified at the time of consent?
What country is the data stored in and/or transferred to?
Etc.
In various embodiments, the system is adapted to integrate with appropriate DLP and/or data discovery tools (e.g., INFORMATICA) and, in response to data being discovered by those tools, to show each area of data that is discovered as a line-item in a system screen via integration.
   The system may do this, for example, in a manner that is similar to pending transactions in a checking account that have not yet been reconciled.
A designated privacy officer may then select one of those—and either match it up (e.g., reconcile it) with an existing data flow or campaign in the system OR trigger a new assessment to be done on that data to capture the privacy attributes and data flow.

### 6. System for Generating an Organization's Data Map by Campaign, by System, or by Individual Data Attributes.

In particular embodiments, the system may be adapted to allow users to specify various criteria, and then to display, to the user, any data maps that satisfy the specified criteria. For example, the system may be adapted to display, in response to an appropriate request: (1) all of a particular customer's data flows that are stored within the system; (2) all of the customer's data flows that are associated with a particular campaign; and/or (3) all of the customer's data flows that involve a particular address.

Similarly, the system may be adapted to allow personnel such as privacy officers to document and input the data flows into the system in any of a variety of different ways, including:
Document by process
   The user initiates an assessment for a certain business project and captures the associated data flows (including the data elements related to the data flows and the systems they are stored in).
Document by element
   The user initiates an audit of a data element—such as SSN—and tries to identify all data structures associated with the organization that include the SSN. The system may then document this information (e.g., all of the organization's systems and business processes that involve the business processes.)
Document by system.
   The user initiates an audit of a database, and the system records, in memory, the results of the audit.
      7. Policy Compliance System that Allows Users to Attach Emails to Individual Campaigns.

Personnel such as, for example, privacy officers and/or ethics officers frequently receive emails (or other electronic messages) that are associated with an existing assessment or campaign, or a potential future assessment. For record keeping and auditing purposes, the personnel may wish to maintain those emails in a central storage location, and not in email. In various embodiments, the system is adapted to allow users to automatically attach the email to an existing assessment, data flow, and/or campaign. Alternatively or additionally, the system may allow a user to automatically store emails within a data store associated with the system, and to store the emails as “unassigned,” so that they may later be assigned to an existing assessment, data flow, and/or campaign.
In various embodiments, the system is adapted to allow a user to store an email using:
   a browser plugin-extension that captures webmail;
   a Plug-in directly with office 365 or google webmail (or other suitable email application);
   a Plug-in with email clients on computers such as Outlook;
   via an integrated email alias that the email is forwarded to; or
   any other suitable configuration

### 8. Various Aspects of Related Mobile Applications

In particular embodiments, the system may use a mobile app (e.g., that runs on a particular mobile device associated by a user) to collect data from a user. The mobile app may be used, for example, to collect answers to screening questions. The app may also be adapted to allow users to easily input data documenting and/or reporting a privacy incident and/or misuse of AI. For example, the app may be adapted to assist a user in using their mobile device to capture an image of an incident (e.g., a screen shot documenting that data has been stored in an improper location, or that a printout of sensitive information has been left in a public workspace within an organization.)

The mobile app may also be adapted to provide incremental training to individuals. For example, the system may be adapted to provide incremental training to a user (e.g., in the form of the presentation of short lessons on privacy and/or AI use). Training sessions may be followed by short quizzes that are used to allow the user to assess their understanding of the information and to confirm that they have completed the training.

9. Automatic Generation of Personal Data Inventory and/or AI Use Inventory for an Organization

In particular embodiments, the system is adapted to generate and display an inventory of the personal data that an organization collects and stores within its systems (or other systems) and/or AI used by the organization. As discussed above, in various embodiments, the system is adapted to conduct impact assessments for new and existing campaigns. During an impact assessment for a particular campaign, the system may ask one or more users a series of impact assessment questions regarding the particular campaign and then store the answers to these questions in the system's memory, or in memory of another system, such a third-party computer server.

For example, such impact assessment questions for a privacy campaign may include questions regarding: (1) what type of data is to be collected as part of the campaign; (2) who the data is to be collected from; (3) where the data is to be stored; (4) who will have access to the data; (5) how long the data will be kept before being deleted from the system's memory or archived; and/or (6) any other relevant information regarding the campaign.

The system may store the above information, for example, in any suitable data structure, such as a database. In particular embodiments, the system may be configured to selectively (e.g., upon request by an authorized user) generate and display a personal data or AI use inventory for the organization that includes, for example, all of the organization's current active campaigns, all of the organization's current and past campaigns, or any other listing of campaigns that, for example, satisfy criteria specified by a user. The system may be adapted to display and/or export the inventory in any suitable format (e.g., in a table, a spreadsheet, or any other suitable format).

### 10. Integrated/Automated Solution for Risk Assessments

Continuing with Concept 9, above, in various embodiments, the system may execute multiple integrated steps to generate a personal data and/or AI use inventory for a particular organization. For example, in a particular embodiment, the system first conducts a Threshold Assessment (TA) by asking a user a relatively short set of questions (e.g., between 1 and 15 questions) to quickly determine whether the risk associated with the campaign may potentially exceed a pre-determined risk threshold (e.g., whether the campaign is a potentially high-risk campaign). The system may do this, for example, by using any of the above techniques to assign a collective risk score to the user's answers to the questions and determining whether the collective risk score exceeds a particular risk threshold value. Alternatively, the system may be configured to determine that the risk associated with the campaign exceeds the risk threshold value if the user answers a particular one or more of the questions in a certain way.

The system may be configured for, in response to the user's answers to one or more of the questions within the Threshold Assessment indicating that the campaign exceeds, or may potentially exceed, a pre-determined risk threshold, presenting the user with a longer set of detailed questions regarding the campaign (e.g., an Impact Assessment). The system may then use the user's answers to this longer list of questions to assess the overall risk of the campaign, for example, as described above.

In particular embodiments, the system may be configured for, in response to the user's answers to one or more of the questions within the Threshold Assessment indicating that the campaign does not exceed, or does not potentially exceed, a pre-determined risk threshold, not presenting the user with a longer set of detailed questions regarding the campaign (e.g., an Impact Assessment). In such a case, the system may simply save an indication to memory that the campaign is a relatively low risk campaign.

Accordingly, in particular embodiments, the system may be adapted to automatically initiate an Impact Assessment if the results of a shorter Threshold Assessment satisfy certain criteria. Additionally, or alternatively, in particular embodiments, the system may be adapted to allow personnel to manually initiate an Impact Assessment for a particular campaign.

In particular embodiments, built into the Threshold Assessment and the Impact Assessment are the data mapping questions and/or sub-questions of how the personal data obtained through the campaign will be collected, used, stored, accessed, retained, and/or transferred, etc. and/or how the AI is being used. In particular embodiments: (1) one or more of these questions are asked in the Threshold Assessment; and (2) one or more of the questions are asked in the Impact Assessment. In such embodiments, the system may obtain the answers to each of these questions, as captured during the Threshold Assessment and the Impact Assessment, and then use the respective answers to generate the end-to-end data flow for the relevant campaign.

The system may then link all of the data flows across all of the organization's campaigns together in order to show a complete evergreen version of the personal data and/or AI use inventory of the organization. Thus, the system may efficiently generate the inventory of an organization (e.g., through the use of reduced computer processing power) by automatically gathering the data needed to prepare the inventory while conducting Threshold Assessments and Impact Assessments.

Automated Approach to Demonstrating Privacy by Design and/or Responsible AI Use by Design

Privacy by design is a documented approach to managing privacy risks. Likewise, AI use by design is a documented approach to managing risks associated with using AI for various purposes. One of the primary concepts is evaluating impacts, and making appropriate changes during the design phase of a project, before the project goes live. Organizations have embraced the concept, but have struggled with how to operationalize and demonstrate that they are doing this.

In various embodiments, the system is adapted to automate this with the following capabilities: (1) initial assessment; (2) gap analysis/recommendations; and/or (3) final/updated assessment. These capabilities are discussed in greater detail below.

### Initial Assessment

In various embodiments, when a business team within a particular organization is planning to begin a campaign, the system presents the business team with a set of assessment questions that are designed to help personnel for the organization such as one or more members of the organization's privacy team and/or ethics team to understand what the business team's plans are, and to understand whether the campaign may have an impact on the organization. The questions may also include a request for the business team to provide the “go-live” date for the campaign. In response to receiving the answers to these questions, the system stores the answers to the system's memory and makes the answers available to proper personnel such as the organization's privacy team and/or ethics team. The system may also add the “go-live” date to one or more electronic calendars (e.g., the system's electronic docket).

### Gap Analysis/Recommendations

After the system receives the answers to the questions, personnel such as one or more members of the privacy team and/or ethics team may review the answers to the questions. The personnel may then enter, into the system, guidance and/or recommendations regarding the campaign. In particular embodiments, the system automatically reminds one or more members of the business team to implement the personnel's recommendations before the go-live date. The system may also implement one or more audits (e.g., as described above) to make sure that the business team incorporates the personnel's recommendations before the “go-live” date.

### Final/Updated Assessment

Once the mitigation steps and recommendations are complete, the system may (e.g., automatically) conduct an updated review to assess the updated impact and risks.

### Reporting and Historical Logging Capabilities

In particular embodiments, the system includes unique reporting and historical logging capabilities to automate Privacy-by-Design and/or Responsible-AI-Use-by-Design reporting. In various embodiments, the system is adapted to: (1) measure/analyze the initial assessment answers from the business team; (2) measure recommendations for the campaign; (3) measure any changes that were implemented prior to the go-live date; (4) automatically differentiate between: (a) substantive changes, such as, for example, the addition of encryption, anonymization, or minimizations and/or procedural changes to maintaining machine-learning algorithms used for certain AI functionality; and (b) non-substantive changes, such as spelling correction.

The system may also be adapted to generate a privacy-by-design and/or responsible-AI-use-by-design report showing that: (1) projects are evaluated prior to go-live; and (2) substantive recommendations are made and implemented prior to go-live. This may be useful in documenting that privacy-by-design and/or responsible-AI-use-by-design is being effectively implemented for a particular campaign.

System for Preventing Individuals from Trying to Game the System

As discussed above, in particular embodiments, the system is adapted to display a series of threshold questions for particular campaigns and to use conditional logic to assess whether to present additional, follow-up questions to the user. There may be situations in which a user may answer, or attempt to answer, one or more of the threshold questions incorrectly (e.g., dishonestly) in an attempt to avoid needing to answer additional questions. This type of behavior can present serious potential problems for the organization because the behavior may result in risks associated with a particular campaign being hidden due to the incorrect answer or answers.

To address this issue, in various embodiments, the system: (1) maintains a historical record of every button press (e.g., un-submitted system input) that an individual makes when a question is presented to them; and (2) tracks, and saves to memory, each incidence of the individual changing their answer to a question (e.g., (a) before formally submitting the answer by pressing an “enter” key, or other “submit” key on a user interface, such as a keyboard or graphical user interface on a touch-sensitive display screen; or (b) after initially submitting the answer).

The system may also be adapted to automatically determine whether a particular question (e.g., threshold question) is a “critical” question that, if answered in a certain way, would cause the conditional logic trigger to present the user with one or more follow-up questions. For example, the system may, in response to receiving the user's full set of answers to the threshold questions, automatically identify any individual question within the series of threshold questions that, if answered in a particular way (e.g., differently than the user answered the question) would have caused the system to display one or more follow up questions. The system may then flag those identified questions, in the system's memory, as “critical” questions.

Alternatively, the system may be adapted to allow a user (e.g., a privacy officer of an organization) who is drafting a particular threshold question that, when answered in a particular way, will automatically trigger the system to display one or more follow up questions to the user, to indicate that is a “critical” threshold question. The system may then save this “critical” designation of the question to the system's computer memory.

In various embodiments, the system is configured, for any questions that are deemed “critical” (e.g., either by the system, or manually, as discussed above), to determine whether the user exhibited any abnormal behavior when answering the question. For example, the system may check to see whether the user changed their answer once, or multiple times, before submitting their answer to the question (e.g., by tracking the user's keystrokes while they are answering the threshold question, as described above). As another example, the system may determine whether it took the user longer than a pre-determined threshold amount of time (e.g., 5 minutes, 3 minutes, etc. . . . ) to answer the critical threshold question.

In particular embodiments, the system may be adapted, in response to determining that the user exhibited abnormal behavior when answering the critical threshold question, to automatically flag the threshold question and the user's answer to that question for later follow up by a designated individual or team (e.g., a member of the organization's privacy team). In particular embodiments, the system may also, or alternatively, be adapted to automatically generate and transmit a message to one or more individuals (e.g., the organization's chief privacy officer) indicating that the threshold question may have been answered incorrectly and that follow-up regarding the question may be advisable. After receiving the message, the individual may, in particular embodiments, follow up with the individual who answered the question, or conduct other additional research, to determine whether the question was answered accurately.

### Assessment Module

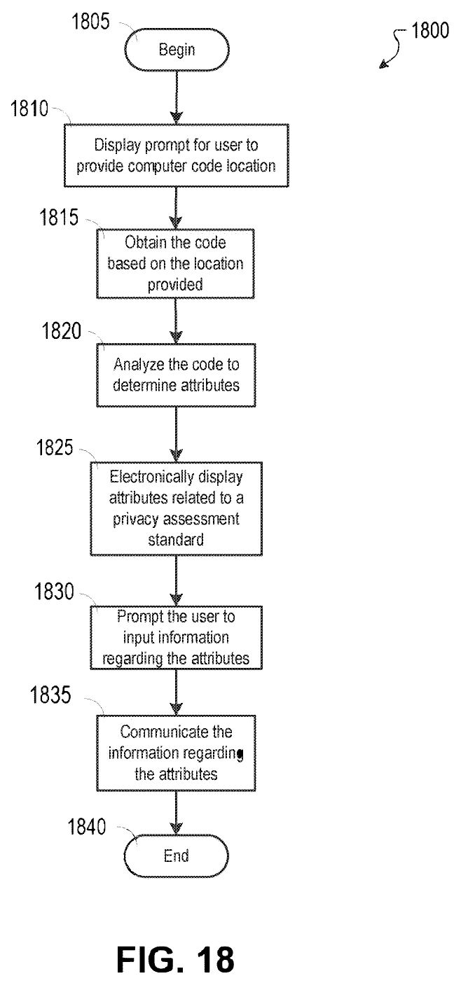

As noted above, the system may include an Assessment Module for automatically performing assessments of computer code. FIG. 18 illustrates an exemplary process 1800, executed by an Assessment Module, for automatically performing assessments of computer code with respect to aspects of the code that may involve, for example, privacy aspects and/or responsible artificial intelligence (AI) use aspects. The process may be executed by one or more computing devices of the System 100. In exemplary embodiments, a server (e.g., server 140) in conjunction with a client computing device having a browser (e.g., computing devices 140, 150, 160, 170, 180, 190) execute the Assessment Module by communicating, as needed, via a network (network 110). In various exemplary embodiments, the Assessment Module may call upon other modules to perform certain functions. In exemplary embodiments, the software may be organized as a single module to perform various computer executable routines.

As mentioned above, disconnects and differences in vernacular might lead to wrong answers to questions during an audit or assessment. To address this issue, in various embodiments, instead of determining whether an organization complies with the defined parameters of a privacy and/or responsible AI use campaign by, for example, conducting an audit as described above (e.g., by asking users to answer questions regarding the campaign, such as: (1) “What personal data is being collected?”; (2) “What historical data is used in generating data sets used for training machine-learning algorithms?”; or (3) “What cookies are being used on the website?”), the system (e.g., by executing the Assessment Module) may be configured to automatically determine whether the organization is complying with one or more aspects of a policy or standard, as well as determine the organization is operating in a manner that does not lead to vulnerabilities of potential occurrences of privacy-related data incidents and/or operation of AI in an unintended, undesired, unfair, and/or unethical manner. For example, during the audit process, the system may: (1) obtain a copy of computer code (e.g., a software application or an “app,” website, and/or the like) that is related to collecting, transferring, storing, processing, and/or the like sensitive user information and/or related to using AI functionality and then (2) automatically analyze the computer code to determine whether the operation of the computer code is complying with the terms of the campaign (the privacy and/or responsible AI use policy at issue) that govern the use of the computer code (and not creating vulnerabilities to privacy-related data incidents and/or AI operating in an unintended, undesired, unfair, and/or unethical manner).

The process of FIG. 18 begins at step 1805. The system then advances to step 1810, where it displays, on a graphical user interface (e.g., a webpage or dialog box), an instruction (e.g., one or more prompts) for a user to provide the location of computer code, which may be, for example, the code for a software application (e.g., a mobile application) or website, or any other computer code. The user may then, for example, browse to the location of a file that includes the computer code for uploading. If the code involved is that for a website, the system may prompt the user to provide the URL of the website.

At step 1815, the Assessment Module may then use the location provided by the user to obtain the computer code (for example, by uploading the file, or obtaining the code directly from a website (e.g., by “scraping” the code from the website)).

Next, at step 1820, the Assessment Module automatically electronically analyzes the computer code to determine a plurality of attributes of the computer code that are related to the use of personal data and/or AI. For instance, privacy-related attributes (features and/or conditions) of the computer code may relate, for example, to the types of personal information the computer code collects and/or accesses. For example, a particular application may have one or more of the following privacy-related attributes: (1) uses location-based services to detect the location of the user's computing device (e.g., services that may determine the precise longitude and latitude of the user's computing device and/or which of a plurality of predetermined geographical areas the computing device is located in—e.g., the particular U.S. State or Zip Code that the user's computing device is located in); (2) places network calls to another country (e.g., a particular designated country, such as China); (3) uses encryption to protect personal data; (4) issues calls to third party software; (5) accesses communications logs (e.g., call logs, email); (6) uses cookies to track user behavior; and/or (7) collects personal data (e.g., a user's social security number, date of birth, credit card number, physical address, mailing address, email address, IP address, Internet browsing habits, purchase history, biometric data (e.g., finger prints, retinal scans, or other biometric data), and/or personal preferences).

The AI-related attributes (features and/or conditions) of the computing code may relate, for example, to technologies used in performing AI functionality that may mimic human intelligence. For example, a particular application may have one or more of the following AI-related attributes: (1) conducts image analysis for performing visual perception such as facial recognition, (2) performs speech recognition for identifying questions to ask a user and/or translating between languages: (3) uses a machine-learning algorithm for predicting preferences of a user; (4) uses a virtual assistant in interacting with users; (5) performs pattern recognition in identifying potential cyberattacks; and/or (6) performs voice-to-text conversion in providing voice search capabilities.

Accordingly, the system may use, for example, static analysis, behavior analysis, or some combination of the two, in performing the analysis and determination. The Assessment Module may integrate with a third-party system or software (e.g., Veracode), which executes the analysis. As an example, for a software application, after the application is uploaded to the system, the system may detect what privacy permissions and data the application is collecting from users. In another example, the system may detect any external calls the application may be making to third parties who are known to provide AI functionality.

In response to determining that the application is collecting one or more specified types of personal data, which may be sensitive information (e.g., the location of the user's mobile device) and/or utilizing certain types of AI functionality, the Assessment Module may automatically request follow up information from the user by posing one or more questions to the user. In the exemplary method of FIG. 18, at step 1825, the system may electronically display to the user a list of the privacy-related attributes and/or AI-related attributes related to the computer code, wherein each displayed attribute may relate to a privacy assessment standard (e.g., privacy policy, privacy law) and/or responsible AI use assessment standard (e.g., responsible AI use policy). For example, code related to the collection of personal data such as a person's IP address, may be governed by particular privacy laws.

At step 1830, the system may electronically display one or more prompts to the user, wherein each prompt informs the user to input information regarding the attributes. Questions posed by the prompts may include, for example: (1) “For what reason and/or purpose is the data being collected (or the AI being used for)?”; (2) “How is application user's consent given to obtain the data (or is consent requested for use of the AI)?”; (3) “Would application users be surprised that the data is being collected (or the use of the AI)?”; (4) “Is the data encrypted at rest and/or in motion?”; (5) “What would happen if the system did not collect this data (or use this AI)?”; (6) “What business impact would it have to not collect this data (or perform this AI)?”; (7) “Where is the data stored”; (8) “What types of networks are used in transferring the data?”; (9) “What data is used in training the AI?”; (10) “What procedures are in place for maintaining the AI?”; (11) “What procedures are in place for monitoring the performance of the AI?”; (12) and/or the like. In various embodiments, the system is adapted to allow users to customize these follow-up questions, but the system asks the questions (e.g., the same questions, or a customized list of questions) for each issue and/or vulnerability concern that is found for the computer code at issue. The system may also collect other relevant comments regarding the computer code.

At step 1835, the information regarding the attributes that were input by the user may be communicated to one or more second users (e.g., one or more software developers, privacy officers, “owners” of the code, or auditors) for an assessment. The information may, for example, help personnel such as a privacy officer work with a software developer to modify the code to comply with one or more policies and/or to eliminate and/or minimize a vulnerability to a privacy-related data incident and/or untended use of AI, or to draft or modify a privacy policy and/or responsible AI use policy to be used on a website that implements the code. At step 1840, the process 1800 may end.

As noted above, in particular embodiments, the system may also, or alternatively, be adapted to scan predetermined software code to automatically determine whether the code, when executed, collects, transfers, stores, processes, and/or the like personal information (e.g., sensitive personal information) and/or uses AI and, if so, what types of personal information are being collected, transferred, stored, processed and/or the like and/or types of AI (e.g., types of AI functionality) are being used. In various embodiments, in response to determining that the code collects, transfers, stores, processes, and/or like certain predetermined types of personal information and/or uses certain predetermined types of AI, the system may associate a particular risk level with the code and/or flag the code to indicate that, before the code is placed into use (e.g., before the code is publicly launched and/or before a non-testing version of the code is launched), the code needs to: (1) be modified to not collect, transfer, store, process, and/or the like (or collect, transfer, store, process, and/or the like in a compliant manner) the one or more types of personal information and/or not use the one or more types of AI; and/or (2) be reviewed and approved by an appropriate individual or group (e.g., the individual or group must approve the code including the attribute). Such risk levels and flags may be communicated to users within the context of a risk assessment system, such as one or more of the systems described in U.S. Provisional Patent Application Ser. No. 62/348,695, entitled “Data Processing Systems and Methods for Operationalizing Privacy Compliance and Assessing the Risk of Various Respective Privacy Campaigns and Related Systems and Methods”, which was filed on Jun. 10, 2016, and which, as noted above, is incorporated herein by reference in its entirety.

### Monitoring Module

In various embodiments, after particular computer code is scanned a first time, if the code is subsequently scanned, the system may only scan the code to determine whether any changes have been made to the code since the immediate previous scan of the code. This may be carried out to determine whether any changes may have been introduced into the computer code that results in the code operating in a manner that is no longer in compliance with applicable policy, operating in a manner that has introduced one or more vulnerabilities to a potential occurrence of a privacy-related data incident, and/or operating in a manner that has introduced one or more uses of AI in an unintended, undesired, unfair, and/or unethical way. If so, the system may, for example, automatically scan the application, as discussed above, to determine whether the code has changed to add any additional privacy-related attributes and/or AI-related attributes. The system may then, for example, automatically notify one or more designated individuals (e.g., privacy office representatives and/or ethics office representatives) to indicate that a new instance (e.g., version) of the application was detected and also inform the one or more designated individuals as to whether the new instance of the code added any additional privacy-related attributes and/or AI-related attributes since the immediate previous version of the code. In particular embodiments, the notification may also indicate whether the new instance of the application was released without an assessment having been performed on the new instance.

In particular embodiments, when configuring the desired operation of the Monitoring Module, a user may specify that, if the system identifies a new instance of a particular piece of code and determines that the new instance of the code has added one or more additional privacy-related attributes and/or AI-related attributes, the system automatically prompts a user (e.g., as discussed above) for information regarding the newly-added privacy-related attributes and/or AI-related attributes. The system may then use this information as discussed above (e.g., it may send the information to a privacy officer, ethics officers, or other individual who is responsible for the privacy aspects and/or AI aspects of the computer code).

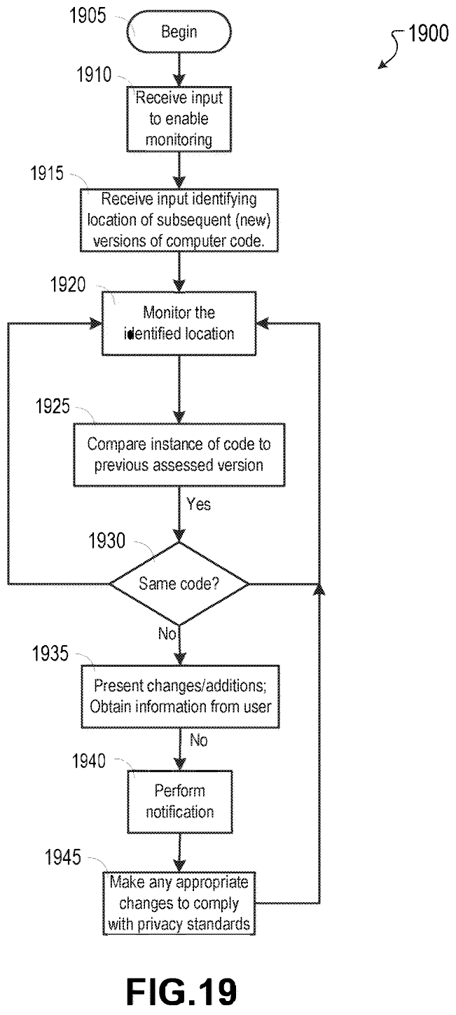

Various steps executed by the Monitoring Module are shown in the flowchart of FIG. 19. Turning to this figure, the process 1900 begins at step 1905. Next, at step 1910, the system may receive an electronic input from the user indicating that they wish to have the system monitor particular computer code for changes.

At step 1915, the system prompts for and receives from the user an electronic input identifying the location of the new versions of computer code. In various embodiments, the system is adapted to (optionally) automatically monitor (e.g., continuously monitor) locations that may be one or more online software application marketplaces (such as the Microsoft Store, the Google Play Store, or Apple's App Store) to determine whether the application has changed (e.g., a new version of the application is available).

In various embodiments in which the computer code comprises a website, the location may be a website's URL, and the Monitoring Module may prompt the user to enter the URL of the website to be analyzed. For example, the Monitoring Module may prompt the user to “Provide the URL of the Website to be Monitored.”

While the system may analyze every directory or level in the website, the system may, optionally, separately monitor, for changes in the content of a web page that includes the privacy policy and/or responsible AI use policy that applies to the website.

For example, often an organization's privacy team (privacy office), ethics team, and/or legal department may provide web developers with the terms of the privacy policy and/or response AI use policy. However, it is not uncommon for an organization's marketing team or outside creative agency to take it upon themselves to make changes by rewording the policy, or repositioning content on a particular web page. Because the location, placement, wording, and/or content of privacy policies and/or responsible AI use policies may be governed by law, there is reason to monitor changes to both the content of such policies and their placement on related web pages to ensure maintaining compliance with the applicable policy. For example, monitoring the privacy page of a website may be beneficial in Mexico, which requires the content of the policy to contain the word “privacy” and for that word to be displayed in the bottom right hand portion of the policy page.

In addition, changes may be made that affect the functioning, capabilities, and/or the like of the computer code that can lead to introducing vulnerabilities to a potential occurrence of a privacy-related data incident and/or use of AI in a manner that is unintended, undesired, unfair, and/or unethical. For example, instead of rewording the privacy policy, the organization's marketing department may introduce a tracking mechanism, such as a cookie, on the website to collect personal data of visitors to the website. Here, the tracking mechanism may be configured to collect the personal data of visitors and transfer the collected personal data over an unsecured network (e.g., the Internet) without being encrypted to be stored on a system of the organization so that the personal data can then be used by the marketing department. Accordingly, as a result of improperly implementing the change to the website, the change may have opened up the organization to a vulnerability of experiencing a privacy-related data incident.

In another example, the organization's website administrator may introduce a virtual assistant that interacts with visitors to the website to assist the visitors in locating certain content provided through the website. Here, the virtual assistant may use a machine-learning algorithm in identifying (e.g., predicting) questions to ask visitors to help in identifying what content may be of interest to the visitors. However, the machine-learning algorithm may not have been properly trained and as a result, may be exhibiting biased behavior with respect to certain types of visitors who may interact with the virtual assistant. Therefore, as a result of the improperly trained machine-learning algorithm, the change to the website involving introducing the virtual assistant may have opened up the organization to using AI in a manner that is viewed as unfair and/or unethical.

At step 1920, the Monitoring Module monitors the identified location for new instances (e.g., potential new versions) of the computer code. If the system detects a new instance of the computer code located in the identified location, it compares the obtained instance of computer code to a previous assessed instance of the computer code (e.g., the most recent version of the computer code that was previously assessed by the system). During this scanning, the Monitoring Module may also determine any privacy-related attributes and/or AI-related attributes of the computer code. For example, in the case of a website, the Monitoring Module may monitor the specified website site for cookies, and/or for whether other tracking mechanisms, such as fingerprinting technologies and/or 3rd party SDKs, are used. In another example, the Monitoring Module may monitor the specified website for use of AI technologies such as virtual assistants, voice recognition, image recognition, etc.

At step 1925, the Monitoring Module uses the analyzed information to compare the instance of the code that was obtained with a previously assessed instance of the computer code. At 1930, the Monitoring Module determines whether the currently-obtained instance of the computer code is different than the previously assessed instance of the computer code (which would be indicative of a new version of the code). In various embodiments related to monitoring of a privacy policy link and/or responsible AI use policy link, the Monitoring Module may also auto-detect whether any changes have been made to the privacy policy and/or responsible AI use policy or the location of the privacy policy link and/or responsible AI use policy link on the page.

If no differences are detected, then the process 1900 may proceed back to step 1920 wherein the Monitoring Module monitors for new instances of computer code again. If there is a difference between the obtained instance and the immediate previously assessed instance of the computer code, then at 1935, the system may notify a user that a change in computer code has been detected and prompt the user to obtain information regarding the new instance of the computer code (e.g., the reason for the new instance, whether the new instance is necessary, etc.).

Alternatively, at step 1935, the Monitoring Module may automatically analyze the computer code and electronically present the user with a list of differences between the obtained instance of the computer code and the previous assessed instance of the computer code. For example, the Monitoring Module may prompt the user for information regarding the privacy-related attributes and/or AI-related attributes that have changed or been added. For example, the privacy-related attributes and/or AI-related attributes that have changed may be related to new functionality that has been added to the computer code that involves collecting and/or access personal data and/or performing AI functionality. Therefore, the Monitoring Module may prompt the user for information regarding the new functionality. In various embodiments, the Monitoring Module may ask the user to complete a series of one or more follow-up questions for each of these changed or added privacy-related attributes and/or AI-related attributes found during the scan of the application, or website. For example, the system may ask the reason the new privacy-related attribute and/or AI-related attribute is in the code, whether the code may be changed back to eliminate the attribute, etc.

At 1940, any information obtained from step 1935 may be communicated to one or more second users (e.g., one or more software developers, privacy officers, ethics officers, or auditors) for use in further privacy-related and/or AI use-related decision-making as described above. In various embodiments, the system is configured to, for example, generate an alert to an appropriate individual (e.g., a designated privacy officer and/or ethical officer) to inform them of the change(s) to the computer code and provide them with the obtained information regarding the changes as described above.

At 1945, appropriate changes to the code may be made to comply with privacy and/or responsible AI use standards and/or to eliminate and/or minimize one or more vulnerabilities to privacy-related data incidents or use of AI in an unintended, undesired, and/or inappropriate (e.g., unfair and/or unethical) manner if the campaign owners decide that the computer code is noncompliant, has introduced the vulnerabilities, and/or has introduced the unintended, undesired and/or inappropriate use of the AI. The privacy officer and/or ethics officer may use this information, for example, to determine whether to modify the privacy policy and/or responsible AI use policy for the website or to coordinate discontinuing use of the new tracking technologies and/or SDKs, discontinuing use of the new AI, and, in response to auto-detecting such changes, trigger an audit of the project.

### Exemplary User Experience

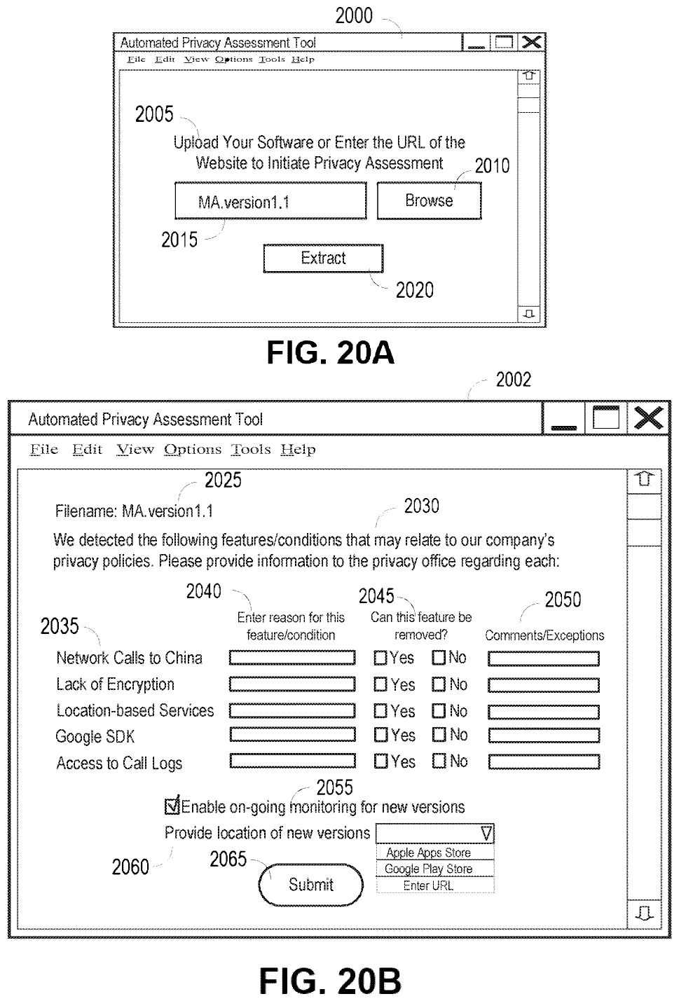

FIGS. 20A and 20B illustrates an example of a graphical user interface (GUI) for performing automated privacy assessments. A similar type of graphical user interface can be used in performing automated responsible AI use assessments. The method includes displaying on an Assessment GUI 2000 (e.g., a webpage or dialog box) an instruction 2005 (or prompts) for a user to provide the location of computer code, which may be, for example, a software application (e.g., a mobile application, a database application), or a website. For example, the system may prompt a user with an “Upload Your Software or Enter the URL of the Website to Initiate Privacy Assessment” message. The user may use the browse button 2010 to browse to the location of a file that includes the computer code for uploading. When the file is selected, the name of the file may appear in a computer code entry field 2015 so as to display to the user the file that will be uploaded. If the code involved is a website, the user may provide the URL of the website for which the privacy assessment is desired. Once the user selects the “Extract” button 2020, the system electronically obtains the computer code. The “Extract” button 2020 may, alternatively, bear another label, such as “Import,” “Upload,”, “Obtain,” etc.

The system then automatically electronically analyzes the computer code to determine one or more attributes of the computer code. The attributes (features and/or conditions) of the computer code may relate to location-based services, network calls to another country (e.g., China), encryption (or lack thereof), third party software (e.g., libraries, SDKs), access to communications logs (e.g., call logs, email), tracking (e.g., cookies), and personal data collection (wherein the personal data may be a social security number, date of birth, credit card number, physical address, mailing address, email address, IP address, Internet browsing habits, purchase history, biometric data (e.g., finger prints or retinal scans), and personal preferences. The system may use, for example, static analysis, behavior analysis, or some combination of the two, to make the analysis and determination.

Next, as shown in illustrative FIG. 20B, the system may electronically display to the user, in assessment GUI 2000, a list of the attributes related to the computer code, wherein each displayed attribute relates to a privacy assessment standard (e.g., privacy policy, privacy law). The assessment GUI 2000 may display, for example, an identifier (e.g., a file name) associated with the computer code 2025 that was assessed (if the assessment involved a website, the URL of the website may be displayed). The assessment GUI 2000 may also display some informative indication 2030 to the user that the analysis revealed certain features or conditions (e.g., attributes) of the code that may have an impact on one or more of the company's privacy polies (or relevant privacy laws). In example 20B, the system may electronically display a list of attributes 2035, along with a plurality of prompts to the user, wherein each prompt informs the user to input information regarding the attributes, and other relevant comments. As mentioned above, a user may be prompted to answer a plurality of questions, including for each attribute. In the exemplary embodiment show in FIG. 20B, the user is presented with a prompt 2040 to enter the reason the code has the attribute, a prompt 2045 to select whether the attribute may be eliminated (e.g., check “Yes” or “No”), and a prompt 2050 to enter in any comments or exceptions relating to the attribute. Each prompt may have one or more entry fields, check boxes, and the like, associated with it. The information regarding the attributes that was input by the user may be communicated to one or more second users (e.g., software developers, privacy office personnel, or auditors) for an assessment. In the example shown, the user may select the submit button 2065 to communicate this information.

In the example shown in FIG. 20B, prior to selecting the submit button 2065, a user of the system (e.g., or software developer, a privacy office team member, or auditor,) may respond to the prompt 2055 by electing to automatically monitor subsequent computer code versions of the code by selecting the check box associated with the prompt 2055. The system may display a prompt 2060 asking for the user to input the location of the new versions of computer code. In various embodiments, a drop-down selector may be used to facilitate entering the location, which may be an on-line application store, such as the Microsoft Store, Google Play Store, Apple App Store, or in the case of a website, a URL. The system then periodically (or in the alternative, continuously) monitors the identified location for any instances (e.g., potential new versions) of the computer code. The system then compares code obtained from the location to a previous assessed version of the computer code.

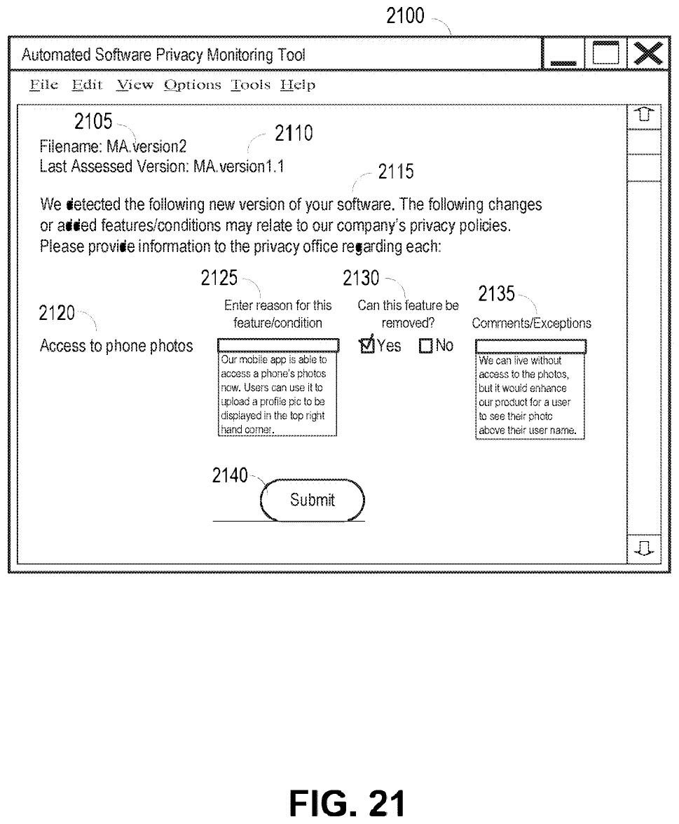

### FIG. 21: Collaborator Assignment Notification and Description Entry

Referring to FIG. 21, if an obtained instance of computer code is different than the immediate previously privacy-assessed version of the computer code, then the system may display a GUI 2100 that shows the results of the analysis and prompts for and obtains information regarding any new or changed attributes discovered. Again, a similar GUI can be used for showing the results of an analysis conducted for assessing a version of the computer code with respect to use of AI functionality. The GUI 2100 may display the name 2105 of the new version (if a name and version number was detected), as well as the name 2110 of the previous version of the computer code. The GUI 2100 may provide an informative statement 2115 indicating, for example, “We detected the following new version of your software. The following changes or added features/conditions may relate to our company's privacy policies. Please provide information to the privacy office regarding each.” In various exemplary embodiments, the monitoring module may simply ask the user for information regarding the new version of computer code (e.g., the reason for the new code). The system may display a prompt that states, for example, “We have detected a new version of software from the original. Please let us know what has changed.”

The system may also, after analyzing the computer code for differences, present the user with a list of differences, and obtain information regarding the attributes that have changed or been added. In FIG. 21, the system may electronically display a list of attributes 2120 (here, only one attribute is listed-“Access to phone photos”), along with a plurality of prompts to the user, where each prompt informs the user to input information regarding the attributes, and other relevant comments. As mentioned above, numerous questions may be prompted, including for each attribute. In the exemplary embodiment shown in FIG. 21, the user is presented with a prompt 2125 to enter the reason the attribute is in the code, a prompt 2130 to select whether the attribute may be eliminated (e.g., check “Yes” or “No”), and a prompt 2135 to enter in any comments or exceptions relating to the attribute. Each prompt may have one or more entry fields, check boxes, and the like, associated with it. The information regarding the attributes that was input by the user may be communicated (e.g., notified, alerted, etc.) to one or more second users (e.g., privacy office personnel, auditors, etc.) for an assessment. In the example shown, the user may select the submit button 2140 to communicate this information to the one or more second users (e.g., privacy office personnel, auditors, etc.) for use in determining how to move forward in accordance with the applicable privacy policies.

### Data Model Generation and Population

### Overview

A data model generation and population system, according to particular embodiments, is configured to generate a data model (e.g., one or more data models) that maps one or more relationships between and/or among a plurality of data assets utilized by a corporation or other entity (e.g., individual, organization, etc.) in the context, for example, of one or more business processes. In particular embodiments, each of the plurality of data assets (e.g., data systems) may include, for example, any entity that collects, processes, contains, and/or transfers data (e.g., such as a software application, “internet of things” computerized device, database, website, data-center, server, etc.). For example, a first data asset may include any software or device (e.g., server or servers) utilized by a particular entity for such data collection, processing, transfer, storage, etc.

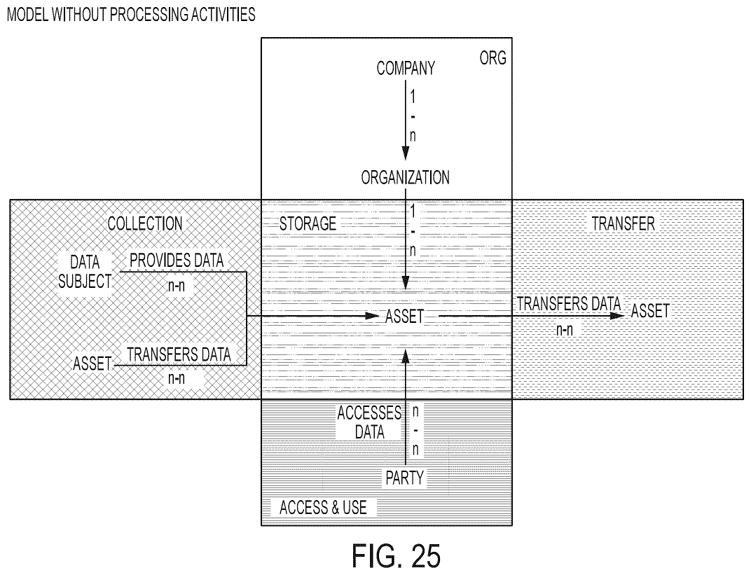

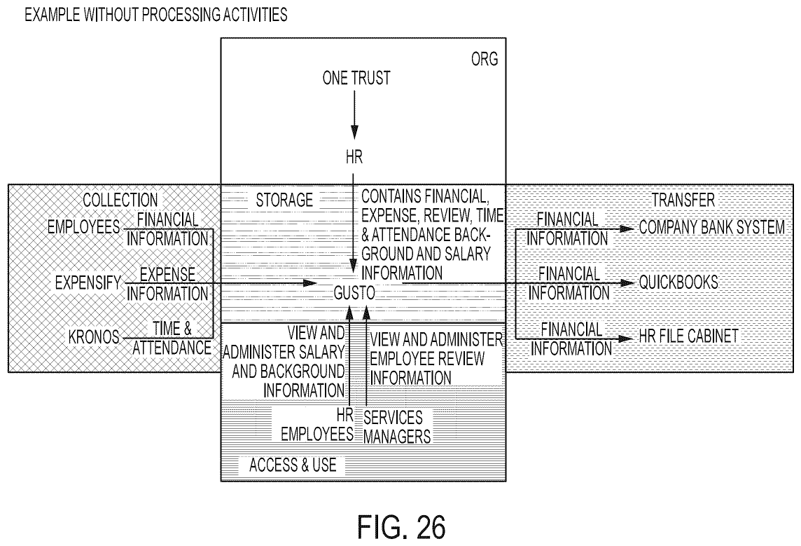

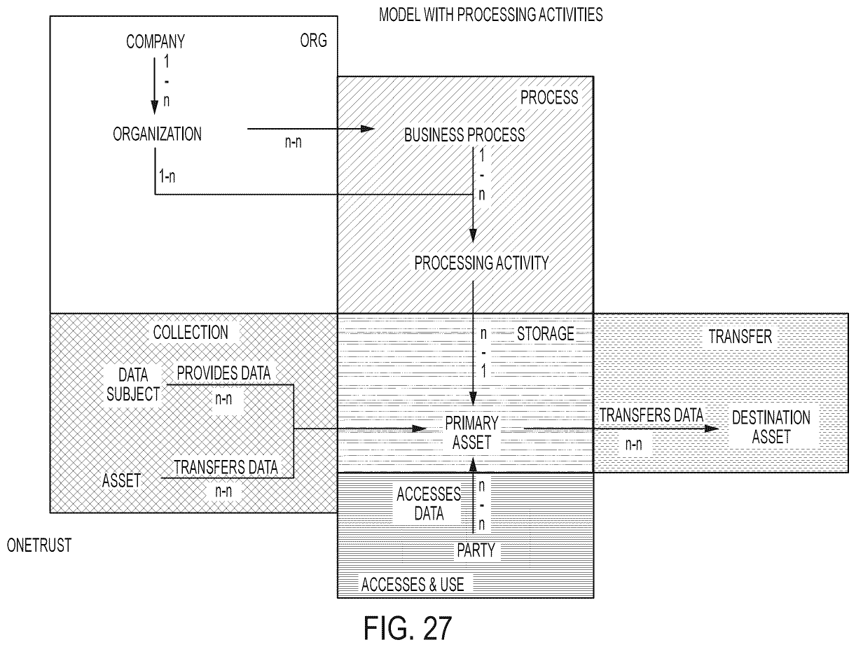

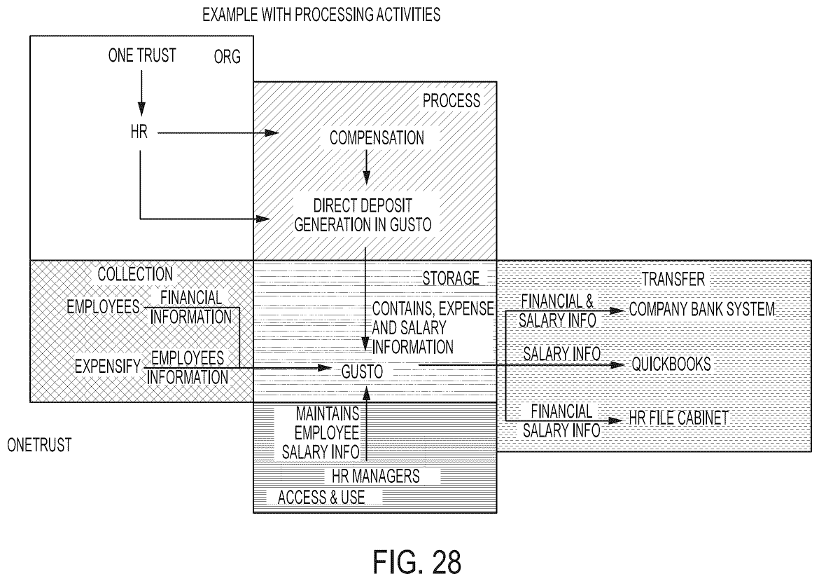

As shown in FIGS. 25 and 26, in various embodiments, the data model may store the following information: (1) the organization that owns and/or uses a particular data asset (a primary data asset, which is shown in the center of the data model in FIG. 25); (2) one or more departments within the organization that are responsible for the data asset; (3) one or more software applications that collect data (e.g., personal data) for storage in and/or use by the data asset (e.g., or one or more other suitable collection assets from which the personal data that is collected, processed, stored, etc. by the primary data asset is sourced); (4) one or more particular data subjects (or categories of data subjects) that information is collected from for use by the data asset; (5) one or more particular types of data that are collected by each of the particular applications for storage in and/or use by the data asset; (6) one or more individuals (e.g., particular individuals or types of individuals) that are permitted to access and/or use the data stored in, or used by, the data asset; (7) which particular types of data each of those individuals are allowed to access and use; and (8) one or more data assets (destination assets) that the data is transferred to for other use, and which particular data is transferred to each of those data assets. As shown in FIGS. 27 and 28, the system may also optionally store information regarding, for example, which business processes and processing activities utilize the data asset.

In particular embodiments, the data model stores this information for each of a plurality of different data assets and may include links between, for example, a portion of the model that provides information for a first particular data asset and a second portion of the model that provides information for a second particular data asset.

In various embodiments, the data model generation and population system may be implemented in the context of any suitable privacy management system that is configured to ensure compliance with one or more legal or industry standards related to the collection and/or storage of private information. In various embodiments, a particular organization, sub-group, or other entity may initiate a privacy campaign or other activity (e.g., processing activity) as part of its business activities. In such embodiments, the privacy campaign may include any undertaking by a particular organization (e.g., such as a project or other activity) that includes the collection, entry, and/or storage (e.g., in memory) of any personal data associated with one or more individuals. In particular embodiments, a privacy campaign may include any project undertaken by an organization that includes the use of personal data, or any other activity that could have an impact on the privacy of one or more individuals.

In any embodiment described herein, personal data may include, for example: (1) the name of a particular data subject (which may be a particular individual); (2) the data subject's address; (3) the data subject's telephone number; (4) the data subject's e-mail address; (5) the data subject's social security number; (6) information associated with one or more of the data subject's credit accounts (e.g., credit card numbers); (7) banking information for the data subject; (8) location data for the data subject (e.g., their present or past location); (9) internet search history for the data subject; and/or (10) any other suitable personal information, such as other personal information discussed herein. In particular embodiments, such personal data may include one or more cookies (e.g., where the individual is directly identifiable or may be identifiable based at least in part on information stored in the one or more cookies).

In particular embodiments, when generating a data model, the system may, for example: (1) identify one or more data assets associated with a particular organization; (2) generate a data inventory for each of the one or more data assets, where the data inventory comprises information such as: (a) one or more processing activities associated with each of the one or more data assets, (b) transfer data associated with each of the one or more data assets (data regarding which data is transferred to/from each of the data assets, and which data assets, or individuals, the data is received from and/or transferred to, (c) personal data associated with each of the one or more data assets (e.g., particular types of data collected, stored, processed, etc. by the one or more data assets), and/or (d) any other suitable information; and (3) populate the data model using one or more suitable techniques.

In particular embodiments, the one or more techniques for populating the data model may include, for example: (1) obtaining information for the data model by using one or more questionnaires associated with a particular privacy campaign, processing activity, etc.; (2) using one or more intelligent identity scanning techniques discussed herein to identify personal data stored by the system and map such data to a suitable data model, data asset within a data model, etc.; (3) obtaining information for the data model from a third-party application (or other application) using one or more application programming interfaces (API); and/or (4) using any other suitable technique.

In particular embodiments, the system is configured to generate and populate a data model substantially on the fly (e.g., as the system receives new data associated with particular processing activities). In still other embodiments, the system is configured to generate and populate a data model based at least in part on existing information stored by the system (e.g., in one or more data assets), for example, using one or more suitable scanning techniques described herein.

As may be understood in light of this disclosure, a particular organization may undertake a plurality of different privacy campaigns, processing activities, etc. that involve the collection and storage of personal data. In some embodiments, each of the plurality of different processing activities may collect redundant data (e.g., may collect the same personal data for a particular individual more than once), and may store data and/or redundant data in one or more particular locations (e.g., on one or more different servers, in one or more different databases, etc.). In this way, a particular organization may store personal data in a plurality of different locations which may include one or more known and/or unknown locations. By generating and populating a data model of one or more data assets that are involved in the collection, storage and processing of such personal data, the system may be configured to create a data model that facilitates a straightforward retrieval of information stored by the organization as desired. For example, in various embodiments, the system may be configured to use a data model in substantially automatically responding to one or more data access requests by an individual (e.g., or other organization). In still other embodiments, such data model generation and population may improve the functionality of an entity's computing systems by enabling a more streamlined retrieval of data from the system and eliminating redundant storage of identical data. Various embodiments of a system for generating and populating a data model are described more fully below.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

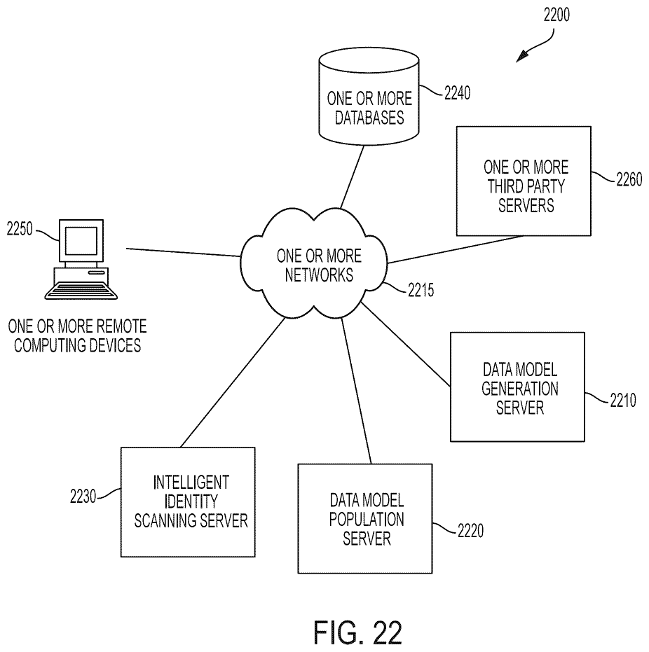

FIG. 22 is a block diagram of a Data Model Generation and Population System 2200 according to a particular embodiment. In various embodiments, the Data Model Generation and Population System 2200 is part of a privacy compliance system (also referred to as a privacy management system), or other system, which may, for example, be associated with a particular organization and be configured to aid in compliance with one or more legal or industry regulations related to the collection and storage of personal data. In some embodiments, the Data Model Generation and Population System 2200 is configured to: (1) generate a data model based on one or more identified data assets, where the data model includes a data inventory associated with each of the one or more identified data assets; (2) identify populated and unpopulated aspects of each data inventory; and (3) populate the unpopulated aspects of each data inventory using one or more techniques such as intelligent identity scanning, questionnaire response mapping, APIs, etc.

As may be understood from FIG. 22, the Data Model Generation and Population System 2200 includes one or more computer networks 2215, a Data Model Generation Server 2210, a Data Model Population Server 2220, an Intelligent Identity Scanning Server 2230, One or More Databases 2240 or other data structures, one or more remote computing devices 2250 (e.g., a desktop computer, laptop computer, tablet computer, smartphone, etc.), and One or More Third Party Servers 2260. In particular embodiments, the one or more computer networks 2215 facilitate communication between the Data Model Generation Server 2210, Data Model Population Server 2220, Intelligent Identity Scanning Server 2230, One or More Databases 2240, one or more remote computing devices 2250 (e.g., a desktop computer, laptop computer, tablet computer, smartphone, etc.), and One or More Third Party Servers 2260. Although in the embodiment shown in FIG. 22, the Data Model Generation Server 2210, Data Model Population Server 2220, Intelligent Identity Scanning Server 2230, One or More Databases 2240, one or more remote computing devices 2250 (e.g., a desktop computer, laptop computer, tablet computer, smartphone, etc.), and One or More Third Party Servers 2260 are shown as separate servers, it should be understood that in other embodiments, one or more of these servers and/or computing devices may comprise a single server, a plurality of servers, one or more cloud-based servers, or any other suitable configuration.

The one or more computer networks 2215 may include any of a variety of types of wired or wireless computer networks such as the Internet, a private intranet, a public switch telephone network (PSTN), or any other type of network. The communication link between The Intelligent Identity Scanning Server 2230 and the One or More Third Party Servers 2260 may be, for example, implemented via a Local Area Network (LAN) or via the Internet. In other embodiments, the One or More Databases 2240 may be stored either fully or partially on any suitable server or combination of servers described herein.

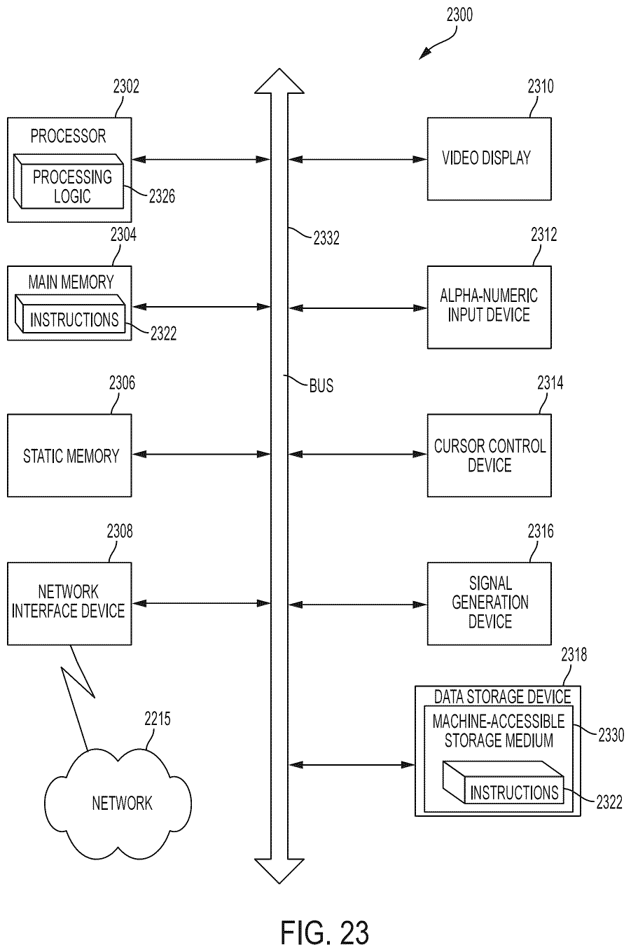

FIG. 23 illustrates a diagrammatic representation of a computer 2300 that can be used within the Data Model Generation and Population System 2200, for example, as a client computer (e.g., one or more remote computing devices 2250 shown in FIG. 22), or as a server computer (e.g., Data Model Generation Server 2210 shown in FIG. 22). In particular embodiments, the computer 2300 may be suitable for use as a computer within the context of the Data Model Generation and Population System 2200 that is configured to generate a data model and map one or more relationships between one or more pieces of data that make up the model.

In particular embodiments, the computer 2300 may be connected (e.g., networked) to other computers in a LAN, an intranet, an extranet, and/or the Internet. As noted above, the computer 2300 may operate in the capacity of a server or a client computer in a client-server network environment, or as a peer computer in a peer-to-peer (or distributed) network environment. The Computer 2300 may be a personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 2300 includes a processing device 2302, a main memory 2304 (e.g., read-only memory (ROM), flash memory, dynamic random access memory (DRAM) such as synchronous DRAM (SDRAM) or Rambus DRAM (RDRAM), etc.), static memory 2306 (e.g., flash memory, static random access memory (SRAM), etc.), and a data storage device 2318, which communicate with each other via a bus 2332.

The processing device 2302 represents one or more general-purpose processing devices such as a microprocessor, a central processing unit, or the like. More particularly, the processing device 2302 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 2302 may also be one or more special-purpose processing devices such as an application specific integrated circuit (ASIC), a field programmable gate array (FPGA), a digital signal processor (DSP), network processor, or the like. The processing device 2302 may be configured to execute processing logic 2326 for performing various operations and steps discussed herein.

The computer 2300 may further include a network interface device 2308. The computer 2300 also may include a video display unit 2310 (e.g., a liquid crystal display (LCD) or a cathode ray tube (CRT)), an alphanumeric input device 2312 (e.g., a keyboard), a cursor control device 2314 (e.g., a mouse), and a signal generation device 2316 (e.g., a speaker).

The data storage device 2318 may include a non-transitory computer-accessible storage medium 2330 (also known as a non-transitory computer-readable storage medium or a non-transitory computer-readable medium) on which is stored one or more sets of instructions (e.g., software instructions 2322) embodying any one or more of the methodologies or functions described herein. The software instructions 2322 may also reside, completely or at least partially, within main memory 2304 and/or within processing device 2302 during execution thereof by computer 2300—main memory 2304 and processing device 2302 also constituting computer-accessible storage media. The software instructions 2322 may further be transmitted or received over a network 2215 via network interface device 2308.

While the computer-accessible storage medium 2330 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium that is capable of storing, encoding, or carrying a set of instructions for execution by the computer and that cause the computer to perform any one or more of the methodologies of the present invention. The term “computer-accessible storage medium” should accordingly be understood to include, but not be limited to, solid-state memories, optical and magnetic media, etc.

### Exemplary System Platform

Various embodiments of a Data Model Generation and Population System 2200 may be implemented in the context of any suitable system (e.g., a privacy compliance system). For example, the Data Model Generation and Population System 2200 may be implemented to analyze a particular company or other organization's data assets to generate a data model for one or more processing activities, privacy campaigns, etc. undertaken by the organization. In particular embodiments, the system may implement one or more modules in order to at least partially ensure compliance with one or more regulations (e.g., legal requirements) related to the collection and/or storage of personal data. Various aspects of the system's functionality may be executed by certain system modules, including a Data Model Generation Module 2400, Data Model Population Module 3200, Data Population Questionnaire Generation Module 3300, Intelligent Identity Scanning Module 4700, and Data Subject Access Request Fulfillment Module 5000. These modules are discussed in greater detail below.

Although these modules are presented as a series of steps, it should be understood in light of this disclosure that various embodiments of the Data Model Generation Module 2400, Data Model Population Module 3200, Data Population Questionnaire Generation Module 3300, Intelligent Identity Scanning Module 4700, and Data Subject Access Request Fulfillment Module 5000 described herein may perform the steps described below in an order other than the order in which they are presented. In still other embodiments, the Data Model Generation Module 2400, Data Model Population Module 3200, Data Population Questionnaire Generation Module 3300, Intelligent Identity Scanning Module 4700, and Data Subject Access Request Fulfillment Module 5000 may omit certain steps described below. In various other embodiments, the Data Model Generation Module 2400, Data Model Population Module 3200, Data Population Questionnaire Generation Module 3300, Intelligent Identity Scanning Module 4700, and Data Subject Access Request Fulfillment Module 5000 may perform steps in addition to those described (e.g., such as one or more steps described with respect to one or more other modules, etc.).

### Data Model Generation Module

In particular embodiments, a Data Model Generation Module 2400 is configured to: (1) generate a data model (e.g., a data inventory) for one or more data assets utilized by a particular organization; (2) generate a respective data inventory for each of the one or more data assets; and (3) map one or more relationships between one or more aspects of the data inventory, the one or more data assets, etc. within the data model. In particular embodiments, a data asset (e.g., data system, software application, etc.) may include, for example, any entity that collects, processes, contains, and/or transfers data (e.g., such as a software application, “internet of things” computerized device, database, website, data-center, server, etc.). For example, a first data asset may include any software or device (e.g., server or servers) utilized by a particular entity for such data collection, processing, transfer, storage, etc.

In particular embodiments, a particular data asset, or collection of data assets, may be utilized as part of a particular data processing activity (e.g., direct deposit generation for payroll purposes). In various embodiments, a data model generation system may, on behalf of a particular organization (e.g., entity), generate a data model that encompasses a plurality of processing activities. In other embodiments, the system may be configured to generate a discrete data model for each of a plurality of processing activities undertaken by an organization.

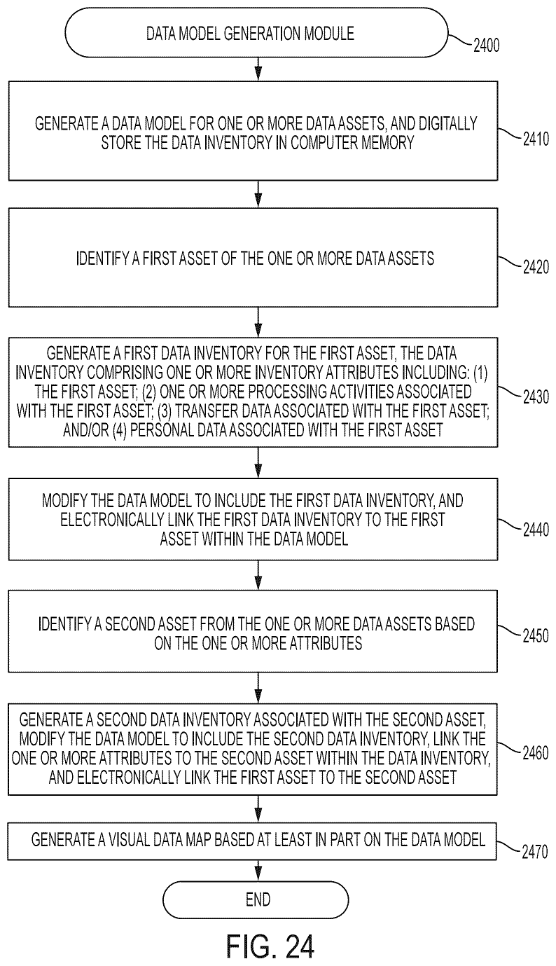

Turning to FIG. 24, in particular embodiments, when executing the Data Model Generation Module 2400, the system begins, at Step 2410, by generating a data model for one or more data assets and digitally storing the data model in computer memory. The system may, for example, store the data model in the One or More Databases 2240 described above (or any other suitable data structure). In various embodiments, generating the data model comprises generating a data structure that comprises information regarding one or more data assets, attributes and other elements that make up the data model. As may be understood in light of this disclosure, the one or more data assets may include any data assets that may be related to one another. In particular embodiments, the one or more data assets may be related by virtue of being associated with a particular entity (e.g., organization). For example, the one or more data assets may include one or more computer servers owned, operated, or utilized by the entity that at least temporarily store data sent, received, or otherwise processed by the particular entity.

In still other embodiments, the one or more data assets may comprise one or more third party assets which may, for example, send, receive and/or process personal data on behalf of the particular entity. These one or more data assets may include, for example, one or more software applications (e.g., such as Expensify to collect expense information, QuickBooks to maintain and store salary information, etc.).

Continuing to step 2420, the system is configured to identify a first data asset of the one or more data assets. In particular embodiments, the first data asset may include, for example, any entity (e.g., system) that collects, processes, contains, and/or transfers data (e.g., such as a software application, “internet of things” computerized device, database, website, data-center, server, etc.). For example, the first data asset may include any software or device utilized by a particular organization for such data collection, processing, transfer, etc. In various embodiments, the first data asset may be associated with a particular processing activity (e.g., the first data asset may make up at least a part of a data flow that relates to the collection, storage, transfer, access, use, etc. of a particular piece of data (e.g., personal data)). Information regarding the first data asset may clarify, for example, one or more relationships between and/or among one or more other data assets within a particular organization. In a particular example, the first data asset may include a software application provided by a third party (e.g., a third party vendor) with which the particular entity interfaces for the purpose of collecting, storing, or otherwise processing personal data (e.g., personal data regarding customers, employees, potential customers, etc.).

In particular embodiments, the first data asset is a storage asset that may, for example: (1) receive one or more pieces of personal data form one or more collection assets; (2) transfer one or more pieces of personal data to one or more transfer assets; and/or (3) provide access to one or more pieces of personal data to one or more authorized individuals (e.g., one or more employees, managers, or other authorized individuals within a particular entity or organization). In a particular embodiment, the first data asset is a primary data asset associated with a particular processing activity around which the system is configured to build a data model associated with the particular processing activity.

In particular embodiments, the system is configured to identify the first data asset by scanning a plurality of computer systems associated with a particular entity (e.g., owned, operated, utilized, etc. by the particular entity). In various embodiments, the system is configured to identify the first data asset from a plurality of data assets identified in response to completion, by one or more users of one or more questionnaires.

Advancing to Step 2430, the system generates a first data inventory of the first data asset. The data inventory may comprise, for example, one or more inventory attributes associated with the first data asset such as, for example: (1) one or more processing activities associated with the first data asset; (2) transfer data associated with the first data asset (e.g., how and where the data is being transferred to and/or from); (3) personal data associated with the first data asset (e.g., what type of personal data is collected and/or stored by the first data asset; how, and from where, the data is collected, etc.); (4) storage data associated with the personal data (e.g., whether the data is being stored, protected and deleted); and (5) any other suitable attribute related to the collection, use, and transfer of personal data. In other embodiments, the one or more inventory attributes may comprise one or more other pieces of information such as, for example: (1) the type of data being stored by the first data asset; (2) an amount of data stored by the first data asset; (3) whether the data is encrypted; (4) a location of the stored data (e.g., a physical location of one or more computer servers on which the data is stored); etc. In particular other embodiments, the one or more inventory attributes may comprise one or more pieces of information technology data related to the first data asset (e.g., such as one or more pieces of network and/or infrastructure information, IP address, MAC address, etc.).

In various embodiments, the system may generate the data inventory based at least in part on the type of first data asset. For example, particular types of data assets may have particular default inventory attributes. In such embodiments, the system is configured to generate the data inventory for the first data asset, which may, for example, include one or more placeholder fields to be populated by the system at a later time. In this way, the system may, for example, identify particular inventory attributes for a particular data asset for which information and/or population of data is required as the system builds the data model.

As may be understood in light of this disclosure, the system may, when generating the data inventory for the first data asset, generate one or more placeholder fields that may include, for example: (1) the organization (e.g., entity) that owns and/or uses the first data asset (a primary data asset, which is shown in the center of the data model in FIG. 25); (2) one or more departments within the organization that are responsible for the first data asset; (3) one or more software applications that collect data (e.g., personal data) for storage in and/or use by the first data asset (e.g., or one or more other suitable collection assets from which the personal data that is collected, processed, stored, etc. by the first data asset is sourced); (4) one or more particular data subjects (or categories of data subjects) that information is collected from for use by the first data asset; (5) one or more particular types of data that are collected by each of the particular applications for storage in and/or use by the first data asset; (6) one or more individuals (e.g., particular individuals or types of individuals) that are permitted to access and/or use the data stored in, or used by, the first data asset; (7) which particular types of data each of those individuals are allowed to access and use; and (8) one or more data assets (destination assets) that the data is transferred to from the first data asset, and which particular data is transferred to each of those data assets.

As may be understood in light of this disclosure, the system may be configured to generate the one or more placeholder fields based at least in part on, for example: (1) the type of the first data asset; (2) one or more third party vendors utilized by the particular organization; (3) a number of collection or storage assets typically associated with the type of the first data asset; and/or (4) any other suitable factor related to the first data asset, its one or more inventory attributes, etc. In other embodiments, the system may substantially automatically generate the one or more placeholders based at least in part on a hierarchy and/or organization of the entity for which the data model is being built. For example, a particular entity may have a marketing division, legal department, human resources department, engineering division, or other suitable combination of departments that make up an overall organization. Other particular entities may have further subdivisions within the organization. When generating the data inventory for the first data asset, the system may identify that the first data asset will have both an associated organization and subdivision within the organization to which it is assigned. In this example, the system may be configured to store an indication in computer memory that the first data asset is associated with an organization and a department within the organization.

Next, at Step 2440, the system modifies the data model to include the first data inventory and electronically links the first data inventory to the first data asset within the data model. In various embodiments, modifying the data model may include configuring the data model to store the data inventory in computer memory, and to digitally associate the data inventory with the first data asset in memory.

FIGS. 25 and 26 show a data model according to a particular embodiment. As shown in these figures, the data model may store the following information for the first data asset: (1) the organization that owns and/or uses the first data asset; (2) one or more departments within the organization that are responsible for the first data asset; (3) one or more applications that collect data (e.g., personal data) for storage in and/or use by the first data asset; (4) one or more particular data subjects that information is collected from for use by the first data asset; (5) one or more collection assets from which the first asset receives data (e.g., personal data); (6) one or more particular types of data that are collected by each of the particular applications (e.g., collection assets) for storage in and/or use by the first data asset; (7) one or more individuals (e.g., particular individuals, types of individuals, or other parties) that are permitted to access and/or use the data stored in or used by the first data asset; (8) which particular types of data each of those individuals are allowed to access and use; and (9) one or more data assets (destination assets) the data is transferred to for other use, and which particular data is transferred to each of those data assets. As shown in FIGS. 27 and 28, the system may also optionally store information regarding, for example, which business processes and processing activities utilize the first data asset.

As noted above, in particular embodiments, the data model stores this information for each of a plurality of different data assets and may include one or more links between, for example, a portion of the model that provides information for a first particular data asset and a second portion of the model that provides information for a second particular data asset.

Advancing to Step 2450, the system next identifies a second data asset from the one or more data assets. In various embodiments, the second data asset may include one of the one or more inventory attributes associated with the first data asset (e.g., the second data asset may include a collection asset associated with the first data asset, a destination asset or transfer asset associated with the first data asset, etc.). In various embodiments, as may be understood in light of the exemplary data models described below, a second data asset may be a primary data asset for a second processing activity, while the first data asset is the primary data asset for a first processing activity. In such embodiments, the second data asset may be a destination asset for the first data asset as part of the first processing activity. The second data asset may then be associated with one or more second destination assets to which the second data asset transfers data. In this way, particular data assets that make up the data model may define one or more connections that the data model is configured to map and store in memory.

Returning to Step 2460, the system is configured to identify one or more attributes associated with the second data asset, modify the data model to include the one or more attributes, and map the one or more attributes of the second data asset within the data model. The system may, for example, generate a second data inventory for the second data asset that comprises any suitable attribute described with respect to the first data asset above. The system may then modify the data model to include the one or more attributes and store the modified data model in memory. The system may further, in various embodiments, associate the first and second data assets in memory as part of the data model. In such embodiments, the system may be configured to electronically link the first data asset with the second data asset. In various embodiments, such association may indicate a relationship between the first and second data assets in the context of the overall data model (e.g., because the first data asset may serve as a collection asset for the second data asset, etc.).

Next, at Step 2470, the system may be further configured to generate a visual representation of the data model. In particular embodiments, the visual representation of the data model comprises a data map. The visual representation may, for example, include the one or more data assets, one or more connections between the one or more data assets, the one or more inventory attributes, etc.

In particular embodiments, generating the visual representation (e.g., visual data map) of a particular data model (e.g., data inventory) may include, for example, generating a visual representation that includes: (1) a visual indication of a first data asset (e.g., a storage asset), a second data asset (e.g., a collection asset), and a third data asset (e.g., a transfer asset); (2) a visual indication of a flow of data (e.g., personal data) from the second data asset to the first data asset (e.g., from the collection asset to the storage asset); (3) a visual indication of a flow of data (e.g., personal data) from the first data asset to the third data asset (e.g., from the storage asset to the transfer asset); (4) one or more visual indications of a risk level associated with the transfer of personal data; and/or (5) any other suitable information related to the one or more data assets, the transfer of data between/among the one or more data assets, access to data stored or collected by the one or more data assets, etc.

In particular embodiments, the visual indication of a particular asset may comprise a box, symbol, shape, or other suitable visual indicator. In particular embodiments, the visual indication may comprise one or more labels (e.g., a name of each particular data asset, a type of the asset, etc.). In still other embodiments, the visual indication of a flow of data may comprise one or more arrows. In particular embodiments, the visual representation of the data model may comprise a data flow, flowchart, or other suitable visual representation.

In various embodiments, the system is configured to display (e.g., to a user) the generated visual representation of the data model on a suitable display device.

### Exemplary Data Models and Visual Representations of Data Models (e.g., Data Maps)

FIGS. 25-31 depict exemplary data models according to various embodiments of the system described herein. FIG. 25, for example, depicts an exemplary data model that does not include a particular processing activity (e.g., that is not associated with a particular processing activity). As may be understood from the data model shown in this figure, a particular data asset (e.g., a primary data asset) may be associated with a particular company (e.g., organization), or organization within a particular company, sub-organization of a particular organization, etc. In still other embodiments, the particular asset may be associated with one or more collection assets (e.g., one or more data subjects from whom personal data is collected for storage by the particular asset), one or more parties that have access to data stored by the particular asset, one or more transfer assets (e.g., one or more assets to which data stored by the particular asset may be transferred), etc.

As may be understood from FIG. 25, a particular data model for a particular asset may include a plurality of data elements. When generating the data model for the particular asset, a system may be configured to substantially automatically identify one or more types of data elements for inclusion in the data model, and automatically generate a data model that includes those identified data elements (e.g., even if one or more of those data elements must remain unpopulated because the system may not initially have access to a value for the particular data element). In such cases, the system may be configured to store a placeholder for a particular data element until the system is able to populate the particular data element with accurate data.

As may be further understood from FIG. 25, the data model shown in FIG. 25 may represent a portion of an overall data model. For example, in the embodiment shown in this figure, the transfer asset depicted may serve as a storage asset for another portion of the data model. In such embodiments, the transfer asset may be associated with a respective one or more of the types of data elements described above. In this way, the system may generate a data model that may build upon itself to comprise a plurality of layers as the system adds one or more new data assets, attributes, etc.

As may be further understood from FIG. 25, a particular data model may indicate one or more parties that have access to and/or use of the primary asset (e.g., storage asset). In such embodiments, the system may be configured to enable the one or more parties to access one or more pieces of data (e.g., personal data) stored by the storage asset.

As shown in FIG. 25, the data model may further comprise one or more collection assets (e.g., one or more data assets or individuals from which the storage asset receives data such as personal data). In the exemplary data model (e.g., visual data map) shown in this figure, the collection assets comprise a data subject (e.g., an individual that may provide data to the system for storage in the storage asset) and a collection asset (e.g., which may transfer one or more pieces of data that the collection asset has collected to the storage asset).

FIG. 26 depicts a portion of an exemplary data model that is populated for the primary data asset Gusto. Gusto is a software application that, in the example shown in FIG. 26, may serve as a human resources service that contains financial, expense, review, time and attendance, background, and salary information for one or more employees of a particular organization (e.g., GeneriTech). In the example of FIG. 26, the primary asset (e.g., Gusto) may be utilized by the HR (e.g., Human Resources) department of the particular organization (e.g., GeneriTech). Furthermore, the primary asset, Gusto, may collect financial information from one or more data subjects (e.g., employees of the particular organization), receive expense information transferred from Expensify (e.g., expensing software), and receive time and attendance data transferred from Kronos (e.g., timekeeping software). In the example shown in FIG. 26, access to the information collected and/or stored by Gusto may include, for example: (1) an ability to view and administer salary and background information by HR employees, and (2) an ability to view and administer employee review information by one or more service managers. In the example shown in this figure, personal and other data collected and stored by Gusto (e.g., salary information, etc.) may be transferred to a company banking system, to QuickBooks, and/or to an HR file cabinet.

As may be understood from the example shown in FIG. 26, the system may be configured to generate a data model based around Gusto that illustrates a flow of personal data utilized by Gusto. The data model in this example illustrates, for example, a source of personal data collected, stored and/or processed by Gusto, a destination of such data, an indication of who has access to such data within Gusto, and an organization and department responsible for the information collected by Gusto. In particular embodiments, the data model and accompanying visual representation (e.g., data map) generated by the system as described in any embodiment herein may be utilized in the context of compliance with one or more record keeping requirements related to the collection, storage, and processing of personal data.

FIGS. 27 and 28 depict an exemplary data model and related example that is similar, in some respects, to the data model and example of FIGS. 25 and 26. In the example shown in FIGS. 27 and 28, the exemplary data model and related example include a specific business process and processing activity that is associated with the primary asset (Gusto). In this example, the business process is compensation, and the specific processing activity is direct deposit generation in Gusto. As may be understood from this figure, the collection and transfer of data related to the storage asset of Gusto is based on a need to generate direct deposits through Gusto in order to compensate employees. Gusto generates the information needed to conduct a direct deposit (e.g., financial and salary information) and then transmits this information to: (1) a company bank system for execution of the direct deposit; (2) Quickbooks for use in documenting the direct deposit payment; and (3) HR File cabinet for use in documenting the salary info and other financial information.

As may be understood in light of this disclosure, when generating such a data model, particular pieces of data (e.g., data attributes, data elements) may not be readily available to the system. In such embodiment, the system is configured to identify a particular type of data, create a placeholder for such data in memory, and seek out (e.g., scan for and populate) an appropriate piece of data to further populate the data model. For example, in particular embodiments, the system may identify Gusto as a primary asset and recognize that Gusto stores expense information. The system may then be configured to identify a source of the expense information (e.g., Expensify).

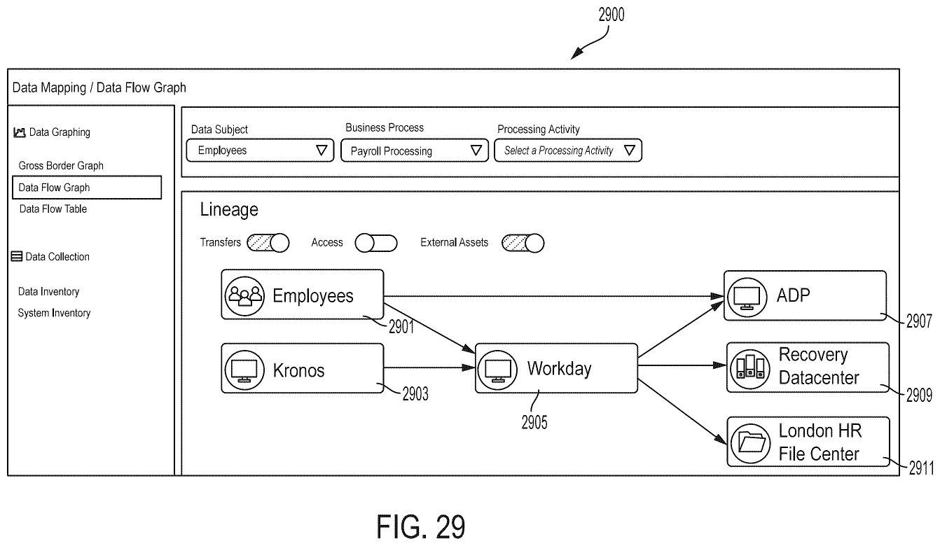

FIG. 29 depicts an exemplary screen display 2900 that illustrates a visual representation (e.g., visual data map) of a data model (e.g., a data inventory). In the example shown in FIG. 29, the data map provides a visual indication of a flow of data collected from particular data subjects (e.g., employees 2901). As may be understood from this figure, the data map illustrates that three separate data assets receive data (e.g., which may include personal data) directly from the employees 2901. In this example, these three data assets include Kronos 2903 (e.g., a human resources software application), Workday 2905 (e.g., a human resources software application), and ADP 2907 (e.g., a human resources software application and payment processor). As shown in FIG. 29, the transfer of data from the employees 2901 to these assets is indicated by respective arrows.

As further illustrated in FIG. 29, the data map indicates a transfer of data from Workday 2905 to ADP 2907 as well as to a Recovery Datacenter 2909 and a London HR File Center 2911. As may be understood in light of this disclosure, the Recovery Datacenter 2909 and London HR File Center 2911 may comprise additional data assets in the context of the data model illustrated by the data map shown in FIG. 29. The Recover Datacenter 2909 may include, for example, one or more computer servers (e.g., backup servers). The London HR File Center 2911 may include, for example, one or more databases (e.g., such as the One or More Databases 2240 shown in FIG. 22). As shown in FIG. 29, each particular data asset depicted in the data map may be shown along with a visual indication of the type of data asset. For example, Kronos 2903, Workday 2905, and ADP 2907 are depicted adjacent a first icon type (e.g., a computer monitor), while Recover Datacenter 2909 and London HR File Center 2911 are depicted adjacent a second and third icon type respectively (e.g., a server cluster and a file folder). In this way, the system may be configured to visually indicate, via the data model, particular information related to the data model in a relatively minimal manner.

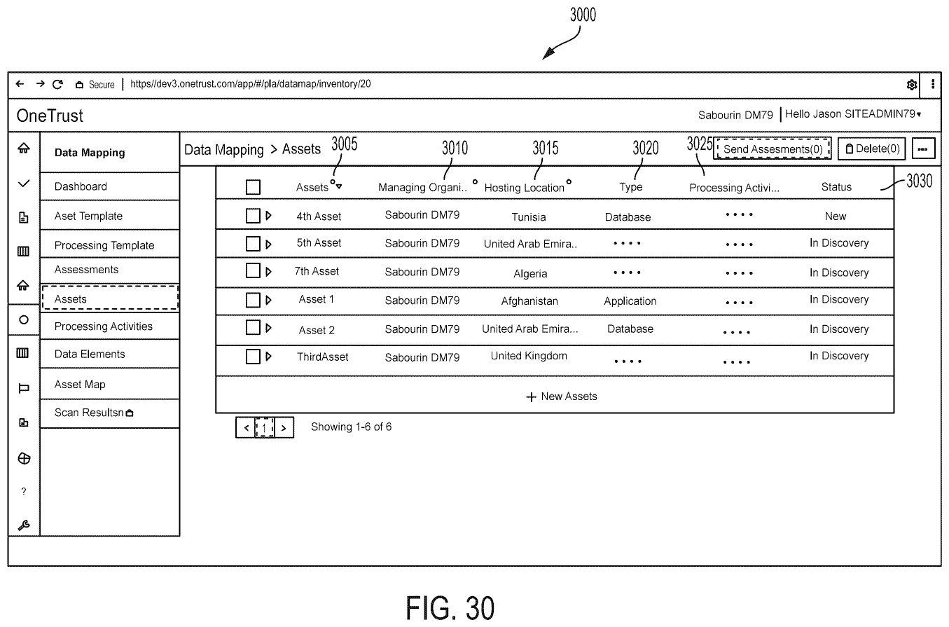

FIG. 30 depicts an exemplary screen display 3000 that illustrates a data map of a plurality of assets 3005 in tabular form (e.g., table form). As may be understood from this figure, a table that includes one or more inventory attributes of each particular asset 3005 in the table may indicate, for example: (1) a managing organization 3010 of each respective asset 3005; (2) a hosting location 3015 of each respective asset 3005 (e.g., a physical storage location of each asset 3005); (3) a type 3020 of each respective asset 3005, if known (e.g., a database, software application, server, etc.); (4) a processing activity 3025 associated with each respective asset 3005; and/or (5) a status 3030 of each particular data asset 3005. In various embodiments, the status 3030 of each particular asset 3005 may indicate a status of the asset 3005 in the discovery process. This may include, for example: (1) a “new” status for a particular asset that has recently been discovered as an asset that processes, stores, or collects personal data on behalf of an organization (e.g., discovered via one or more suitable techniques described herein); (2) an “in discovery” status for a particular asset for which the system is populating or seeking to populate one or more inventory attributes, etc.

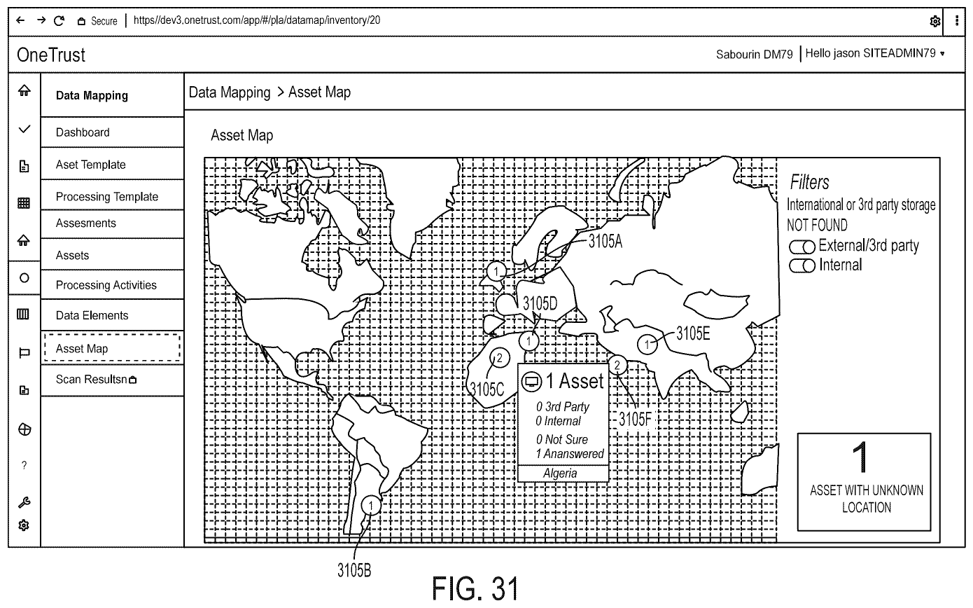

FIG. 31 depicts an exemplary data map 3100 that includes an asset map of a plurality of data assets 3105A-F, which may, for example, be utilized by a particular entity in the collection, storage, and/or processing of personal data. As may be understood in light of this disclosure, the plurality of data assets 3105A-F may have been discovered using any suitable technique described herein (e.g., one or more intelligent identity scanning techniques, one or more questionnaires, one or more application programming interfaces, etc.). In various embodiments, a data inventory for each of the plurality of data assets 3105A-F may define, for each of the plurality of data assets 3105A-F a respective inventory attribute related to a storage location of the data asset.

As may be understood from this figure, the system may be configured to generate a map that indicates a location of the plurality of data assets 3105A-F for a particular entity. In the embodiment shown in this figure, locations that contain a data asset are indicated by circular indicia that contain the number of assets present at that location. In the embodiment shown in this figure, the locations are broken down by country. In particular embodiments, the asset map may distinguish between internal assets (e.g., first party servers, etc.) and external/third party assets (e.g., third party owned servers or software applications that the entity utilizes for data storage, transfer, etc.).

In some embodiments, the system is configured to indicate, via the visual representation, whether one or more assets have an unknown location (e.g., because the data model described above may be incomplete with regard to the location). In such embodiments, the system may be configured to: (1) identify the asset with the unknown location; (2) use one or more data modeling techniques described herein to determine the location (e.g., such as pinging the asset, generating one or more questionnaires for completion by a suitable individual, etc.); and (3) update a data model associated with the asset to include the location.

### Data Model Population Module

In particular embodiments, a Data Model Population Module 3200 is configured to: (1) determine one or more unpopulated inventory attributes in a data model; (2) determine one or more attribute values for the one or more unpopulated inventory attributes; and (3) modify the data model to include the one or more attribute values.

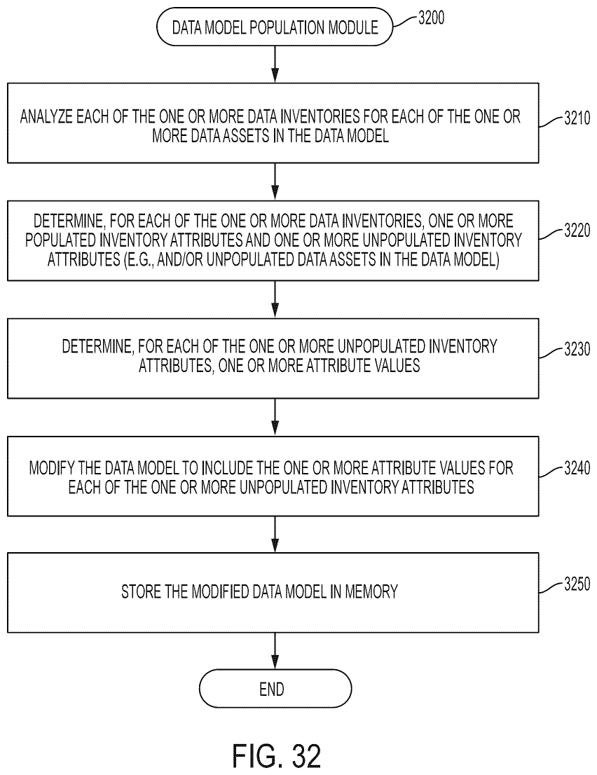

Turning to FIG. 32, in particular embodiments, when executing the Data Model Population Module 3200, the system begins, at Step 3210, by analyzing one or more data inventories for each of the one or more data assets in the data model. The system may, for example, identify one or more particular data elements (e.g., inventory attributes) that make up the one or more data inventories. The system may, in various embodiments, scan one or more data structures associated with the data model to identify the one or more data inventories. In various embodiments, the system is configured to build an inventory of existing (e.g., known) data assets and identify inventory attributes for each of the known data assets.

Continuing to Step 3220, the system is configured to determine, for each of the one or more data inventories, one or more populated inventory attributes and one or more unpopulated inventory attributes (e.g., and/or one or more unpopulated data assets within the data model). As a particular example related to an unpopulated data asset, when generating and populating a data model, the system may determine that, for a particular asset, there is a destination asset. In various embodiments, the destination asset may be known (e.g., and already stored by the system as part of the data model). In other embodiments, the destination asset may be unknown (e.g., a data element that comprises the destination asset may comprise a placeholder or other indication in memory for the system to populate the unpopulated inventory attribute (e.g., data element).

As another particular example, a particular storage asset may be associated with a plurality of inventory assets (e.g., stored in a data inventory associated with the storage asset). In this example, the plurality of inventory assets may include an unpopulated inventory attribute related to a type of personal data stored in the storage asset. The system may, for example, determine that the type of personal data is an unpopulated inventory asset for the particular storage asset.

Returning to Step 3230, the system is configured to determine, for each of the one or more unpopulated inventory attributes, one or more attribute values. In particular embodiments, the system may determine the one or more attribute values using any suitable technique (e.g., any suitable technique for populating the data model). In particular embodiments, the one or more techniques for populating the data model may include, for example: (1) obtaining data for the data model by using one or more questionnaires associated with a particular privacy campaign, processing activity, etc.; (2) using one or more intelligent identity scanning techniques discussed herein to identify personal data stored by the system and then map such data to a suitable data model; (3) using one or more application programming interfaces (API) to obtain data for the data model from another software application; and/or (4) using any other suitable technique. Exemplary techniques for determining the one or more attribute values are described more fully below. In other embodiments, the system may be configured to use such techniques or other suitable techniques to populate one or more unpopulated data assets within the data model.

Next, at Step 3240, the system modifies the data model to include the one or more attribute values for each of the one or more unpopulated inventory attributes. The system may, for example, store the one or more attributes values in computer memory, associate the one or more attribute values with the one or more unpopulated inventory attributes, etc. In still other embodiments, the system may modify the data model to include the one or more data assets identified as filling one or more vacancies left within the data model by the unpopulated one or more data assets.

Continuing to Step 3250, the system is configured to store the modified data model in memory. In various embodiments, the system is configured to store the modified data model in the One or More Databases 2240, or in any other suitable location. In particular embodiments, the system is configured to store the data model for later use by the system in the processing of one or more data subject access requests. In other embodiments, the system is configured to store the data model for use in one or more privacy impact assessments performed by the system.

### Data Model Population Questionnaire Generation Module

In particular embodiments, a Data Population Questionnaire Generation Module 3300 is configured to generate a questionnaire (e.g., one or more questionnaires) comprising one or more questions associated with one or more particular unpopulated data attributes, and populate the unpopulated data attributes based at least in part on one or more responses to the questionnaire. In other embodiments, the system may be configured to populate the unpopulated data attributes based on one or more responses to existing questionnaires.

In various embodiments, the one or more questionnaires may comprise one or more processing activity questionnaires (e.g., privacy impact assessments, data privacy impact assessments, etc.) configured to elicit one or more pieces of data related to one or more undertakings by an organization related to the collection, storage, and/or processing of personal data (e.g., processing activities). In particular embodiments, the system is configured to generate the questionnaire (e.g., a questionnaire template) based at least in part on one or more processing activity attributes, data asset attributes (e.g., inventory attributes), or other suitable attributes discussed herein.

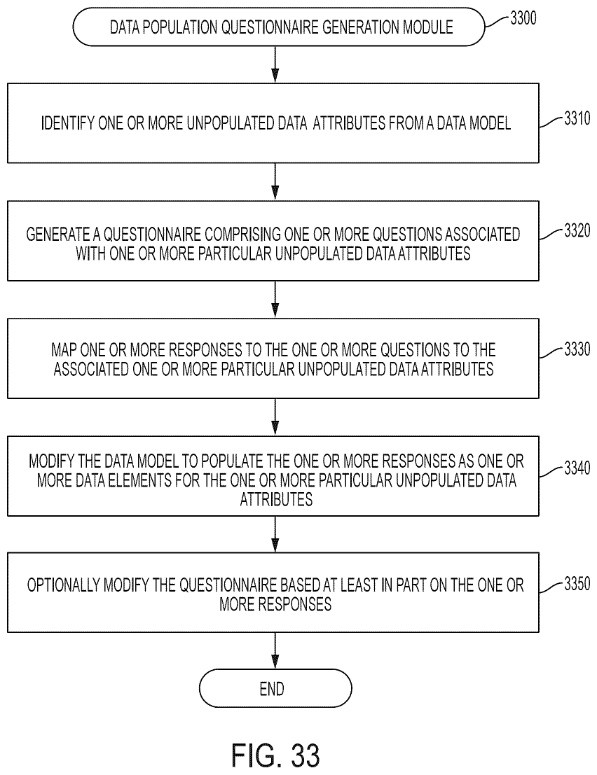

Turning to FIG. 33, in particular embodiments, when executing the Data Population Questionnaire Generation Module 3300, the system begins, at Step 3310, by identifying one or more unpopulated data attributes from a data model. The system may, for example, identify the one or more unpopulated data attributes using any suitable technique described above. In particular embodiments, the one or more unpopulated data attributes may relate to, for example, one or more processing activity or asset attributes such as: (1) one or more processing activities associated with a particular data asset; (2) transfer data associated with the particular data asset (e.g., how and where the data stored and/or collected by the particular data asset is being transferred to and/or from); (3) personal data associated with the particular data assets asset (e.g., what type of personal data is collected and/or stored by the particular data asset; how, and from where, the data is collected, etc.); (4) storage data associated with the personal data (e.g., whether the data is being stored, protected and deleted); and (5) any other suitable attribute related to the collection, use, and transfer of personal data by one or more data assets or via one or more processing activities. In other embodiments, the one or more unpopulated inventory attributes may comprise one or more other pieces of information such as, for example: (1) the type of data being stored by the particular data asset; (2) an amount of data stored by the particular data asset; (3) whether the data is encrypted by the particular data asset; (4) a location of the stored data (e.g., a physical location of one or more computer servers on which the data is stored by the particular data asset); etc.

Continuing to Step 3320, the system generates a questionnaire (e.g., a questionnaire template) comprising one or more questions associated with one or more particular unpopulated data attributes. As may be understood in light of the above, the one or more particulate unpopulated data attributes may relate to, for example, a particular processing activity or a particular data asset (e.g., a particular data asset utilized as part of a particular processing activity). In various embodiments, the one or more questionnaires comprise one or more questions associated with the unpopulated data attribute. For example, if the data model includes an unpopulated data attribute related to a location of a server on which a particular asset stores personal data, the system may generate a questionnaire associated with a processing activity that utilizes the asset (e.g., or a questionnaire associated with the asset). The system may generate the questionnaire to include one or more questions regarding the location of the server.

Returning to Step 3330, the system maps one or more responses to the one or more questions to the associated one or more particular unpopulated data attributes. The system may, for example, when generating the questionnaire, associate a particular question with a particular unpopulated data attribute in computer memory. In various embodiments, the questionnaire may comprise a plurality of question/answer pairings, where the answer in the question/answer pairings maps to a particular inventory attribute for a particular data asset or processing activity.

In this way, the system may, upon receiving a response to the particular question, substantially automatically populate the particular unpopulated data attribute. Accordingly, at Step 3340, the system modifies the data model to populate the one or more responses as one or more data elements for the one or more particular unpopulated data attributes. In particular embodiments, the system is configured to modify the data model such that the one or more responses are stored in association with the particular data element (e.g., unpopulated data attribute) to which the system mapped it at Step 3330. In various embodiments, the system is configured to store the modified data model in the One or More Databases 2240, or in any other suitable location. In particular embodiments, the system is configured to store the data model for later use by the system in the processing of one or more data subject access requests. In other embodiments, the system is configured to store the data model for use in one or more privacy impact assessments performed by the system.

Continuing to optional Step 3350, the system may be configured to modify the questionnaire based at least in part on the one or more responses. The system may, for example, substantially dynamically add and/or remove one or more questions to/from the questionnaire based at least in part on the one or more responses (e.g., one or more response received by a user completing the questionnaire). For example, the system may, in response to the user providing a particular inventory attribute or new asset, generates additional questions that relate to that particular inventory attribute or asset. The system may, as the system adds additional questions, substantially automatically map one or more responses to one or more other inventory attributes or assets. For example, in response to the user indicating that personal data for a particular asset is stored in a particular location, the system may substantially automatically generate one or more additional questions related to, for example, an encryption level of the storage, who has access to the storage location, etc.

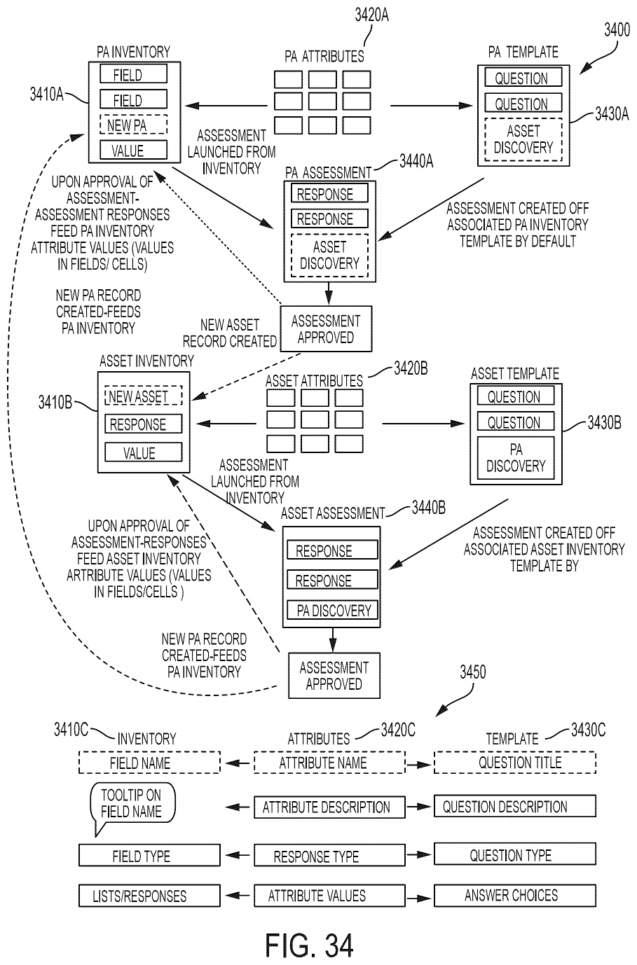

In still other embodiments, the system may modify the data model to include one or more additional assets, data attributes, inventory attributes, etc. in response to one or more questionnaire responses. For example, the system may modify a data inventory for a particular asset to include a storage encryption data element (which specifies whether the particular asset stores particular data in an encrypted format) in response to receiving such data from a questionnaire. Modification of a questionnaire is discussed more fully below with respect to FIG. 34.

### Data Model Population Via Questionnaire Process Flow

FIG. 34 depicts an exemplary process flow 3400 for populating a data model (e.g., modifying a data model to include a newly discovered data asset, populating one or more inventory attributes for a particular processing activity or data asset, etc.). In particular, FIG. 34 depicts one or more exemplary data relationships between one or more particular data attributes (e.g., processing activity attributes and/or asset attributes), a questionnaire template (e.g., a processing activity template and/or a data asset template), a completed questionnaire (e.g., a processing activity assessment and/or a data asset assessment), and a data inventory (e.g., a processing activity inventory and/or an asset inventory). As may be understood from this figure the system is configured to: (1) identify new data assets; (2) generate an asset inventory for identified new data assets; and (3) populate the generated asset inventories. Systems and methods for populating the generated inventories are described more fully below.

As may be understood from FIG. 34, a system may be configured to map particular processing activity attributes 3420A to each of: (1) a processing activity template 3430A; and (2) a processing activity inventory 3410A. As may be understood in light of this disclosure, the processing activity template 3430A may comprise a plurality of questions (e.g., as part of a questionnaire), which may, for example, be configured to elicit discovery of one or more new data assets. The plurality of questions may each correspond to one or more fields in the processing activity inventory 3410A, which may, for example, define one or more inventory attributes of the processing activity.

In particular embodiments, the system is configured to provide a processing activity assessment 3440A to one or more individuals for completion. As may be understood from FIG. 34, the system is configured to launch the processing activity assessment 3440A from the processing activity inventory 3410A and further configured to create the processing activity assessment 3440A from the processing activity template 3430. The processing activity assessment 3440A may comprise, for example, one or more questions related to the processing activity. The system may, in various embodiments, be configured to map one or more responses provided in the processing activity assessment 3440A to one or more corresponding fields in the processing activity inventory 3410A. The system may then be configured to modify the processing activity inventory 3410A to include the one or more responses, and store the modified inventory in computer memory. In various embodiments, the system may be configured to approve a processing activity assessment 3440A (e.g., receive approval of the assessment) prior to feeding the processing activity inventory attribute values into one or more fields and/or cells of the inventory.

As may be further understood from FIG. 34, in response to creating a new asset record (e.g., which the system may create, for example, in response to a new asset discovery via the processing activity assessment 3440A described immediately above, or in any other suitable manner), the system may generate an asset inventory 3410B (e.g., a data asset inventory) that defines a plurality of inventory attributes for the new asset (e.g., new data asset).

As may be understood from FIG. 34, a system may be configured to map particular asset attributes 3420B to each of: (1) an asset template 3430B; and (2) an asset inventory 3410B. As may be understood in light of this disclosure, the asset template 3430B may comprise a plurality of questions (e.g., as part of a questionnaire), which may, for example, be configured to elicit discovery of one or more processing activities associated with the asset and/or one or more inventory attributes of the asset. The plurality of questions may each correspond to one or more fields in the asset inventory 3410B, which may, for example, define one or more inventory attributes of the asset.

In particular embodiments, the system is configured to provide an asset assessment 3440B to one or more individuals for completion. As may be understood from FIG. 34, the system is configured to launch the asset assessment 3440B from the asset inventory 3410B and further configured to create the asset assessment 3440B from the asset template 3430B. The asset assessment 3440B may comprise, for example, one or more questions related to the data asset. The system may, in various embodiments, be configured to map one or more responses provided in the asset assessment 3440B to one or more corresponding fields in the asset inventory 3410B. The system may then be configured to modify the asset inventory 3410B (e.g., and/or a related processing activity inventory 3410A) to include the one or more responses, and store the modified inventory in computer memory. In various embodiments, the system may be configured to approve an asset assessment 3440B (e.g., receive approval of the assessment) prior to feeding the asset inventory attribute values into one or more fields and/or cells of the inventory.

FIG. 34 further includes a detail view 3450 of a relationship between particular data attributes 3420C with an exemplary data inventory 3410C and a questionnaire template 3430C. As may be understood from this detail view 3450, a particular attribute name may map to a particular question title in a template 3430C as well as to a field name in an exemplary data inventory 3410C. In this way, the system may be configured to populate (e.g., automatically populate) a field name for a particular data inventory 3410C in response to a user providing a question title as part of a questionnaire template 3430C. Similarly, a particular attribute description may map to a particular question description in a template 3430C as well as to a tooltip on a fieldname in an exemplary data inventory 3410C. In this way, the system may be configured to provide the tooltip for a particular data inventory 3410C that includes the question description provided by a user as part of a questionnaire template 3430C.

As may be further understood from the detail view 3450 of FIG. 34, a particular response type may map to a particular question type in a template 3430C as well as to a field type in an exemplary data inventory 3410C. A particular question type may include, for example, a multiple choice question (e.g., A, B, C, etc.), a freeform response, an integer value, a drop down selection, etc. A particular field type may include, for example, a memo field type, a numeric field type, an integer field type, a logical field type, or any other suitable field type. A particular data attribute may require a response type of, for example: (1) a name of an organization responsible for a data asset (e.g., a free form response); (2) a number of days that data is stored by the data asset (e.g., an integer value); and/or (3) any other suitable response type.

In still other embodiments, the system may be configured to map a one or more attribute values to one or more answer choices in a template 3430C as well as to one or more lists and/or responses in a data inventory 3410C. The system may then be configured to populate a field in the data inventory 3410C with the one or more answer choices provided in a response to a questionnaire template 3430C with one or more attribute values.

### Exemplary Questionnaire Generation and Completion User Experience

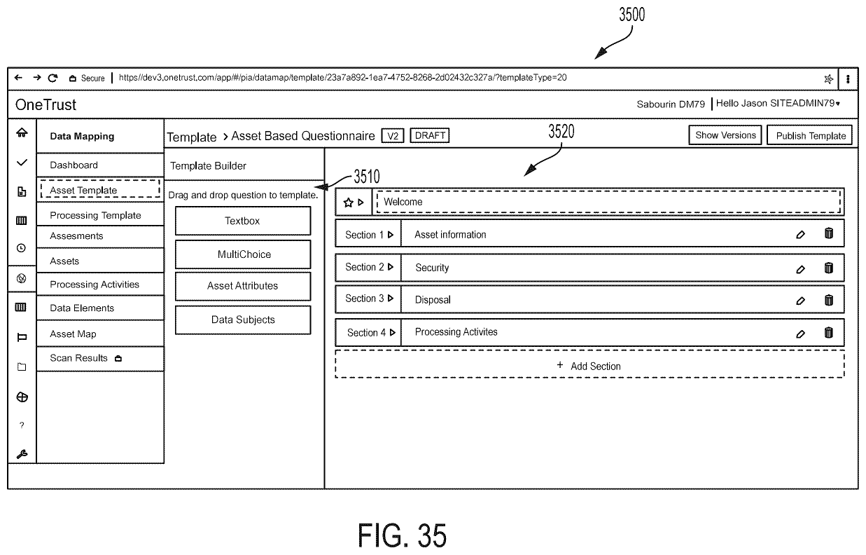

FIGS. 35-46 depict exemplary screen displays that a user may encounter when generating a questionnaire (e.g., one or more questionnaires and/or templates) for populating one or more data elements (e.g., inventory attributes) of a data model for a data asset and/or processing activity. FIG. 35, for example, depicts an exemplary asset based questionnaire template builder 3500. As may be understood from FIG. 35, the template builder may enable a user to generate an asset based questionnaire template that includes one or more sections 3520 related to the asset (e.g., asset information, security, disposal, processing activities, etc.). As may be understood in light of this disclosure, the system may be configured to substantially automatically generate an asset based questionnaire template based at least in part on the one or more unpopulated inventory attributes discussed above. The system may, for example, be configured to generate a template that is configured to populate the one or more unpopulated attributes (e.g., by eliciting responses, via a questionnaire to one or more questions that are mapped to the attributes within the data inventory).

In various embodiments, the system is configured to enable a user to modify a default template (e.g., or a system-created template) by, for example, adding additional sections, adding one or more additional questions to a particular section, etc. In various embodiments, the system may provide one or more tools for modifying the template. For example, in the embodiment shown in FIG. 35, the system may provide a user with a drag and drop question template 3510, from which the user may select a question type (e.g., textbox, multiple choice, etc.).

A template for an asset may include, for example: (1) one or more questions requesting general information about the asset; (2) one or more security-related questions about the asset; (3) one or more questions regarding how the data asset disposes of data that it uses; and/or (4) one or more questions regarding processing activities that involve the data asset. In various embodiments, each of these one or more sections may comprise one or more specific questions that may map to particular portions of a data model (e.g., a data map).

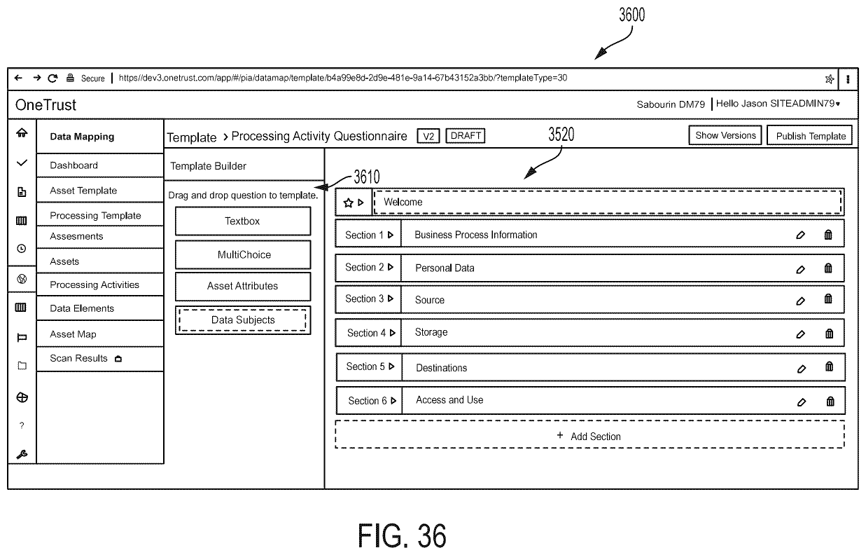

FIG. 36 depicts an exemplary screen display of a processing activity questionnaire template builder 3600. The screen display shown in FIG. 36 is similar to the template builder shown in FIG. 35 with respect to the data asset based template builder. As may be understood from FIG. 36, the template builder may enable a user to generate a processing activity based questionnaire template that includes one or more sections 3620 related to the processing activity (e.g., business process information, personal data, source, storage, destinations, access and use, etc.). As may be understood in light of this disclosure, the system may be configured to substantially automatically generate a processing activity based questionnaire template based at least in part on the one or more unpopulated inventory attributes related to the processing activity (e.g., as discussed above). The system may, for example, be configured to generate a template that is configured to populate the one or more unpopulated attributes (e.g., by eliciting responses, via a questionnaire to one or more questions that are mapped to the attributes within the data inventory).

In various embodiments, the system is configured to enable a user to modify a default template (e.g., or a system-created template) by, for example, adding additional sections, adding one or more additional questions to a particular section, etc. In various embodiments, the system may provide one or more tools for modifying the template. For example, in the embodiment shown in FIG. 36, the system may provide a user with a drag and drop question template 3610, from which the user may select a question type (e.g., textbox, multiple choice, asset attributes, data subjects, etc.). The system may be further configured to enable a user to publish a completed template (e.g., for use in a particular assessment). In other embodiments, the system may be configured to substantially automatically publish the template.

In various embodiments, a template for a processing activity may include, for example: (1) one or more questions related to the type of business process that involves a particular data asset; (2) one or more questions regarding what type of personal data is acquired from data subjects for use by a particular data asset; (3) one or more questions related to a source of the acquired personal data; (4) one or more questions related to how and/or where the personal data will be stored and/or for how long; (5) one or more questions related to one or more other data assets that the personal data will be transferred to; and/or (6) one or more questions related to who will have the ability to access and/or use the personal data.

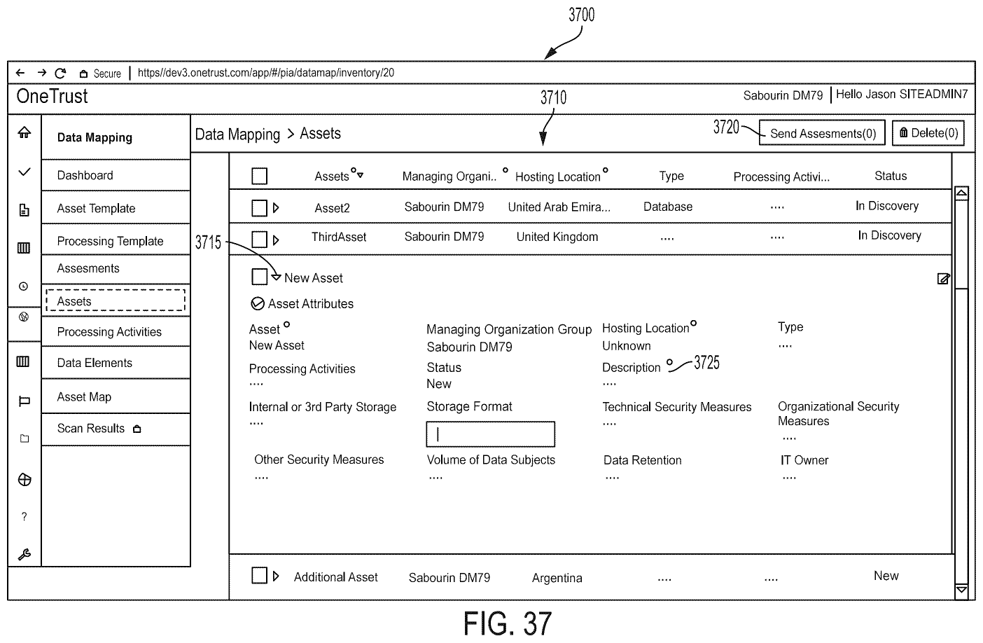

Continuing to FIG. 37, an exemplary screen display 3700 depicts a listing of assets 3710 for a particular entity. These may, for example, have been identified as part of the data model generation system described above. As may be understood from this figure, a user may select a drop down indicator 3715 to view more information about a particular asset. In the exemplary embodiment shown in FIG. 37, the system stores the managing organization group for the “New Asset”, but is missing some additional information (e.g., such as a description 3725 of the asset). In order to fill out the missing inventory attributes for the “New Asset,” the system, in particular embodiments, is configured to enable a user to select a Send Assessment indicia 3720 in order to transmit an assessment related to the selected asset to an individual tasked with providing one or more pieces of information related to the asset (e.g., a manager, or other individual with knowledge of the one or more inventory attributes).

In response to the user selecting the Send Assessment indicia 3720, the system may create the assessment based at least in part on a template associated with the asset, and transmit the assessment to a suitable individual for completion (e.g., and/or transmit a request to the individual to complete the assessment).

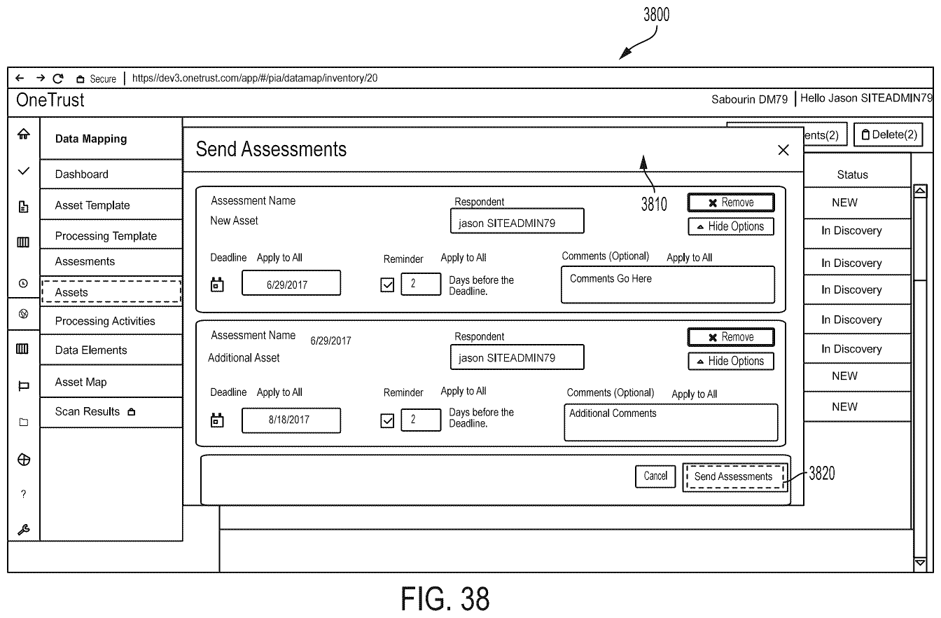

FIG. 38 depicts an exemplary assessment transmission interface 3800 via which a user can transmit one or more assessments for completion. As shown in this figure, the user may assign a respondent, provide a deadline, indicate a reminder time, and provide one or more comments using an assessment request interface 3810. The user may then select a Send Assessment(s) indicia 3820 in order to transmit the assessment.

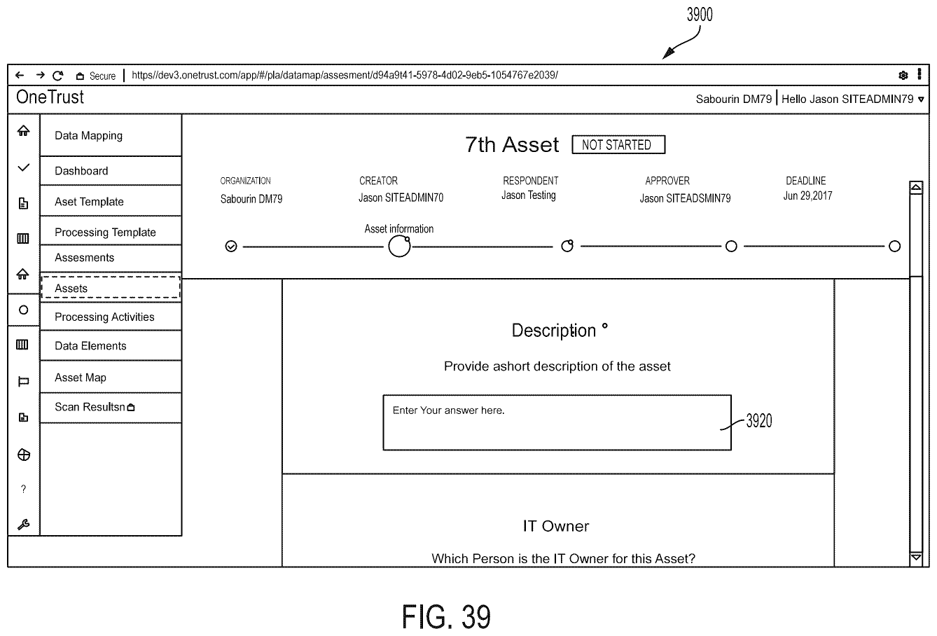

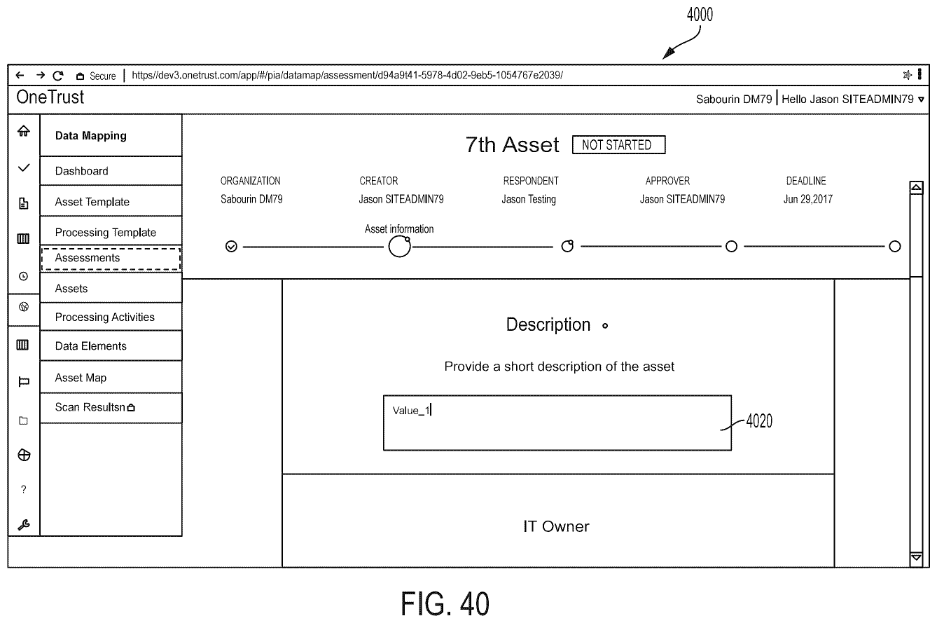

FIG. 39 depicts an exemplary assessment 3900 which a user may encounter in response to receiving a request to complete the assessment as described above with respect to FIGS. 37 and 38. As shown in FIG. 39, the assessment 3900 may include one or more questions that map to the one or more unpopulated attributes for the asset shown in FIG. 37. For example, the one or more questions may include a question related to a description of the asset, which may include a free form text box 3920 for providing a description of the asset. FIG. 40 depicts an exemplary screen display 4000 with the text box 4020 completed, where the description includes a value of “Value_1”. As shown in FIGS. 39 and 40, the user may have renamed “New Asset” (e.g., which may have included a default or placeholder name) shown in FIGS. 37 and 38 to “7th Asset.”

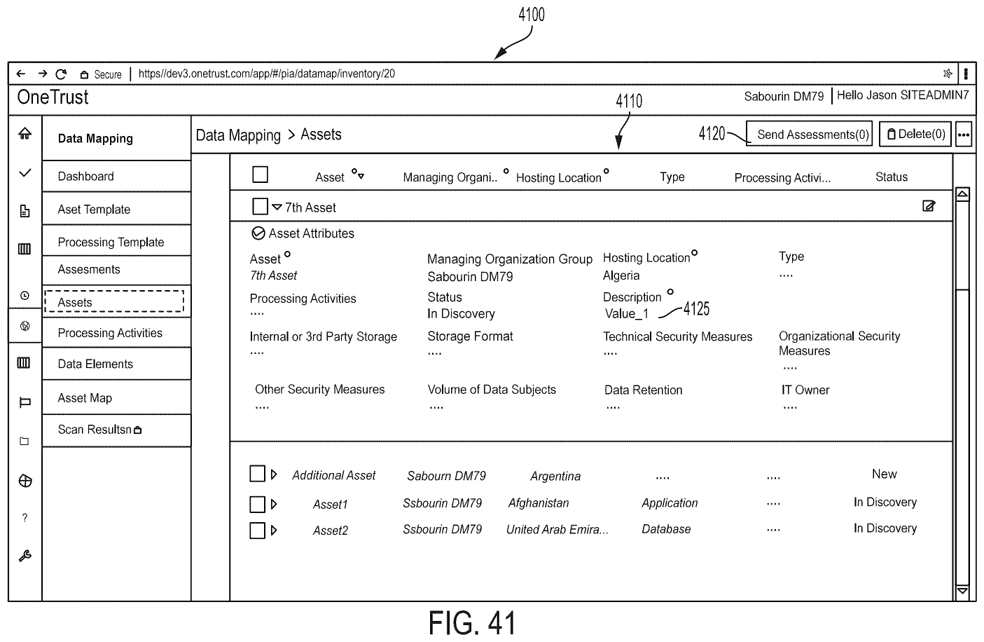

Continuing to FIG. 41, the exemplary screen display 4100 depicts the listing of assets 4110 from FIG. 37 with some additional attributes populated and provides a Send Assessments button 4120. For example, the Description 4125 (e.g., “Value_1”) provided in FIG. 40 has been added to the inventory. As may be understood in light of this disclosure, in response to a user providing the description via the assessment shown in FIGS. 39 and 40, the system may be configured to map the provided description to the attribute value associated with the description of the asset in the data inventory. The system may have then modified the data inventory for the asset to include the description attribute. In various embodiments, the system is configured to store the modified data inventory as part of a data model (e.g., in computer memory).

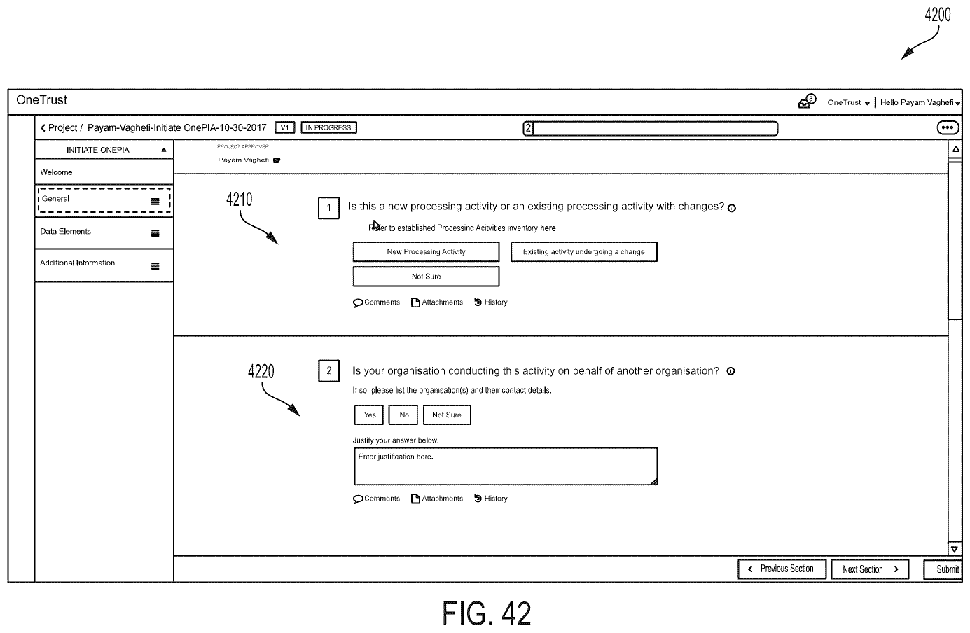

FIGS. 42-45 depict exemplary screen displays showing exemplary questions that make up part of a processing activity questionnaire (e.g., assessment). FIG. 42 depicts an exemplary interface 4200 for responding to a first question 4210 and a second question 4220. As shown in FIG. 42, the first question 4210 relates to whether the processing activity is a new or existing processing activity. The first question 4210 shown in FIG. 42 is a multiple choice question. The second question 4220 relates to whether the organization is conducting the activity on behalf of another organization. As shown in this figure, the second question 4220 includes both a multiple choice portion and a free-form response portion.

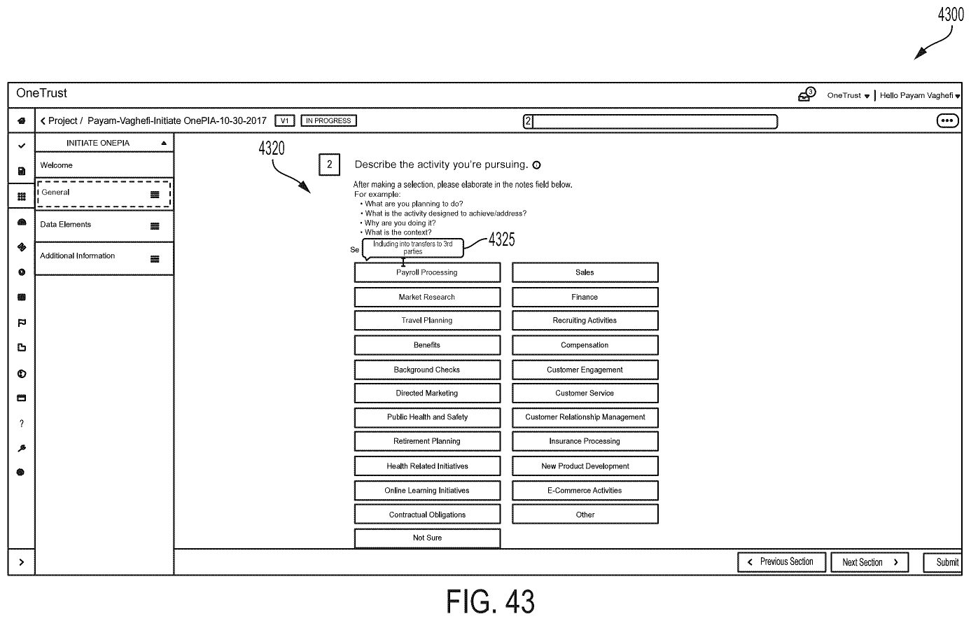

As discussed above, in various embodiments, the system may be configured to modify a questionnaire in response to (e.g., based at least in part on) one or more responses provided by a user completing the questionnaire. In particular embodiments, the system is configured to modify the questionnaire substantially on-the-fly (e.g., as the user provides each particular answer). FIG. 43 depicts an interface 4300 that includes a second question 4320 that differs from the second question 4220 shown in FIG. 42. As may be understood in light of this disclosure, in response to the user providing a response to the first question 4210 in FIG. 42 that indicates that the processing activity is a new processing activity, the system may substantially automatically modify the second question 4220 from FIG. 42 to the second question 4320 from FIG. 43 (e.g., such that the second question 4320 includes one or more follow up questions or requests for additional information based on the response to the first question 4210 in FIG. 42).

As shown in FIG. 43, the second question 4320 requests a description of the activity that is being pursued. In various embodiments (e.g., such as if the user had selected that the processing activity was an existing one), the system may not modify the questionnaire to include the second question 4320 from FIG. 43, because the system may already store information related to a description of the processing activity at issue. In various embodiments, any suitable question described herein may include a tooltip 4325 on a field name (e.g., which may provide one or more additional pieces of information to guide a user's response to the questionnaire and/or assessment).

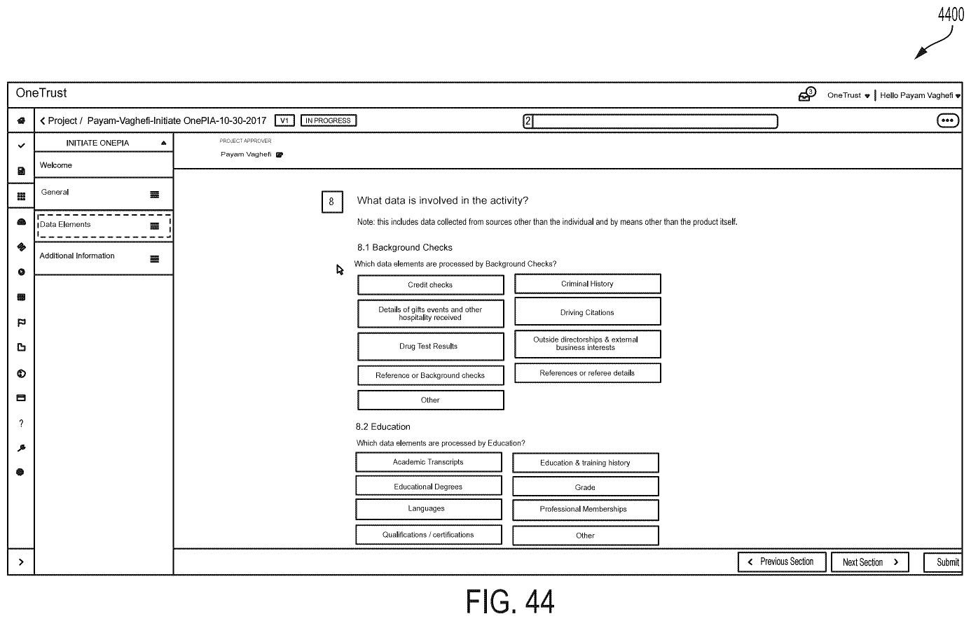

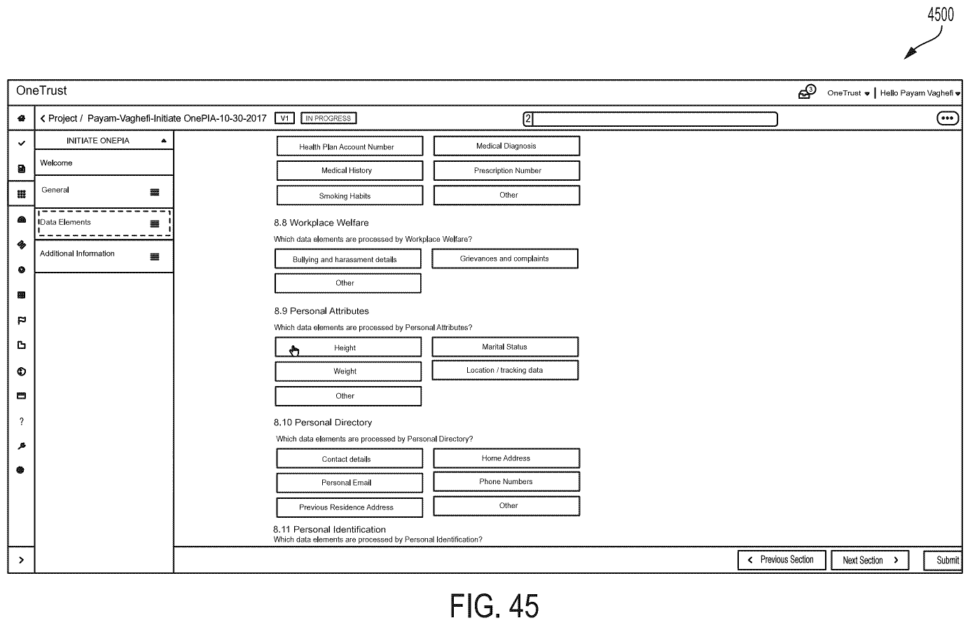

FIGS. 44 and 45 depict additional exemplary assessment questions 4400, 4500. The questions 4400, 4500 shown in these figures relate to, for example, particular data elements processed by various aspects of a processing activity.

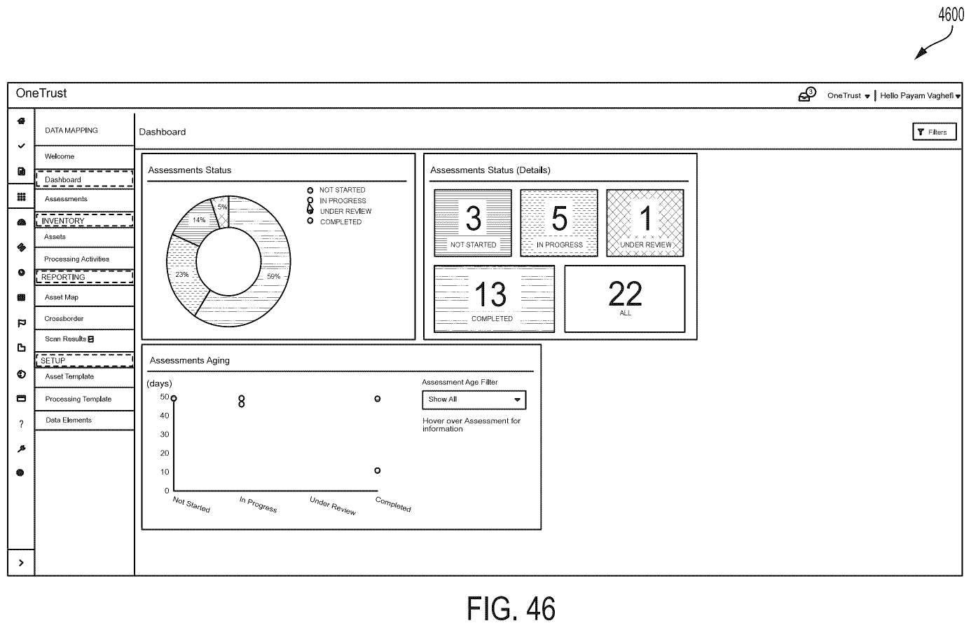

FIG. 46 depicts a dashboard 4600 that includes an accounting of one or more assessments that have been completed, are in progress, or require completion by a particular organization. The dashboard 4600 shown in this figure is configured to provide information relate to the status of one or more outstanding assessments. As may be understood in light of this disclosure, because of the volume of assessment requests, it may be necessary to utilize one or more third party organizations to facilitate a timely completion of one or more assessment requests. In various embodiments, the dashboard may indicate that, based on a fact that a number of assessments are still in progress or incomplete, that a particular data model for an entity, data asset, processing activity, etc. remains incomplete. In such embodiments, an incomplete nature of a data model may raise one or more flags or indicate a risk that an entity may not be in compliance with one or more legal or industry requirements related to the collection, storage, and/or processing of personal data.

### Intelligent Identity Scanning Module

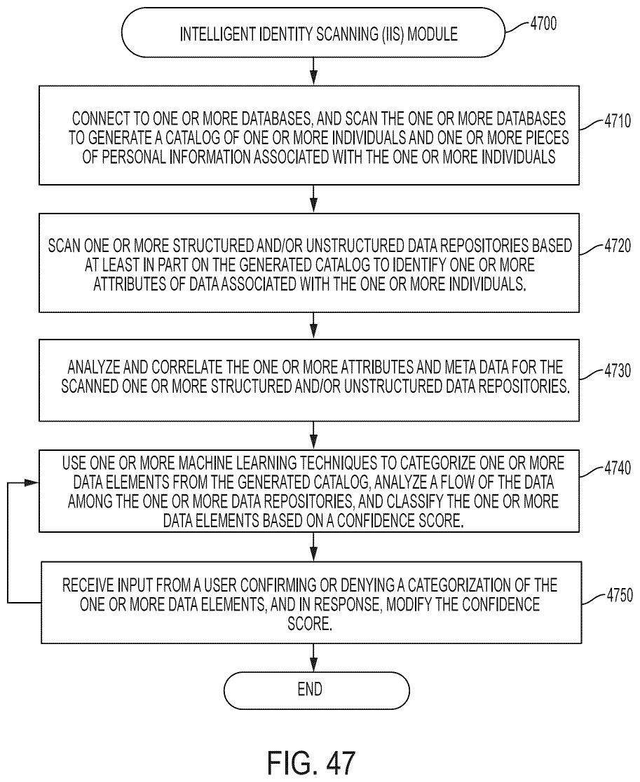

Turning to FIG. 47, in particular embodiments, the Intelligent Identity Scanning Module 4700 is configured to scan one or more data sources to identify personal data stored on one or more network devices for a particular organization, analyze the identified personal data, and classify the personal data (e.g., in a data model) based at least in part on a confidence score derived using one or more machine learning techniques. The confidence score may be and/or comprise, for example, an indication of the probability that the personal data is actually associated with a particular data subject (e.g., that there is at least an 80% confidence level that a particular phone number is associated with a particular individual.)

When executing the Intelligent Identity Scanning Module 4700, the system begins, at Step 4710, by connecting to one or more databases or other data structures, and scanning the one or more databases to generate a catalog of one or more individuals and one or more pieces of personal information associated with the one or more individuals. The system may, for example, be configured to connect to one or more databases associated with a particular organization (e.g., one or more databases that may serve as a storage location for any personal or other data collected, processed, etc. by the particular organization, for example, as part of a suitable processing activity. As may be understood in light of this disclosure, a particular organization may use a plurality of one or more databases (e.g., the One or More Databases 2240 shown in FIG. 22), a plurality of servers (e.g., the One or More Third Party Servers 2260 shown in FIG. 22), or any other suitable data storage location in order to store personal data and other data collected as part of any suitable privacy campaign, privacy impact assessment, processing activity, etc.

In particular embodiments, the system is configured to scan the one or more databases by searching for particular data fields comprising one or more pieces of information that may include personal data. The system may, for example, be configured to scan and identify one of more pieces of personal data such as: (1) name; (2) address; (3) telephone number; (4) e-mail address; (5) social security number; (6) information associated with one or more credit accounts (e.g., credit card numbers); (7) banking information; (8) location data; (9) internet search history; (10) non-credit account data; and/or (11) any other suitable personal information discussed herein. In particular embodiments, the system is configured to scan for a particular type of personal data (e.g., or one or more particular types of personal data).

The system may, in various embodiments, be further configured to generate a catalog of one or more individuals that also includes one or more pieces of personal information (e.g., personal data) identified for the individuals during the scan. The system may, for example, in response to discovering one or more pieces of personal data in a particular storage location, identify one or more associations between the discovered pieces of personal data. For example, a particular database may store a plurality of individuals' names in association with their respective telephone numbers. One or more other databases may include any other suitable information.

The system may, for example, generate the catalog to include any information associated with the one or more individuals identified in the scan. The system may, for example, maintain the catalog in any suitable format (e.g., a data table, etc.).

In still other embodiments, in addition to connecting to a database, the system may be configured to: (1) access an application through one or more application programming interfaces (APIs); (2) use one or more screen scraping techniques on an end user page to identify and analyze each field on the page; and/or (3) connect to any other suitable data structure in order to generate the catalog of individuals and personal information associated with each of the individuals. In some embodiments, the system may be configured to analyze one or more access logs and applications set up through a system active director or SSO portal for which one or more applications might contain certain data for user groups. The system may then be configured to analyze an email environment to identify one or more links to particular business applications, which may, for example, be in use by an entity and contain certain data. In still other embodiments, the system may be configured to analyze one or more system log files (Syslog) from a security environment to capture which particular applications an entity may be using in order to discover such applications.

Continuing to Step 4720, the system is configured to scan one or more structured and/or unstructured data repositories based at least in part on the generated catalog to identify one or more attributes of data associated with the one or more individuals. The system may, for example, be configured to utilize information discovered during the initial scan at Step 4710 to identify the one or more attributes of data associated with the one or more individuals.

For example, the catalog generated at Step 4710 may include a name, address, and phone number for a particular individual. The system may be configured, at Step 4720, to scan the one or more structured and/or unstructured data repositories to identify one or more attributes that are associated with one or more of the particular individual's name, address and/or phone number. For example, a particular data repository may store banking information (e.g., a bank account number and routing number for the bank) in association with the particular individual's address. In various embodiments, the system may be configured to identify the banking information as an attribute of data associated with the particular individual. In this way, the system may be configured to identify particular data attributes (e.g., one or more pieces of personal data) stored for a particular individual by identifying the particular data attributes using information other than the individual's name.

Returning to Step 4730, the system is configured to analyze and correlate the one or more attributes and metadata for the scanned one or more structured and/or unstructured data repositories. In particular embodiments, the system is configured to correlate the one or more attributes with metadata for the associated data repositories from which the system identified the one or more attributes. In this way, the system may be configured to store data regarding particular data repositories that store particular data attributes.

In particular embodiments, the system may be configured to cross-reference the data repositories that are discovered to store one or more attributes of personal data associated with the one or more individuals with a database of known data assets. In particular embodiments, the system is configured to analyze the data repositories to determine whether each data repository is part of an existing data model of data assets that collect, store, and/or process personal data. In response to determining that a particular data repository is not associated with an existing data model, the system may be configured to identify the data repository as a new data asset (e.g., via asset discovery), and take one or more actions (e.g., such as any suitable actions described herein) to generate and populate a data model of the newly discovered data asset. This may include, for example: (1) generating a data inventory for the new data asset; (2) populating the data inventory with any known attributes associated with the new data asset; (3) identifying one or more unpopulated (e.g., unknown) attributes of the data asset; and (4) taking any suitable action described herein to populate the unpopulated data attributes.

In particular embodiments, the system my, for example: (1) identify a source of the personal data stored in the data repository that led to the new asset discovery; (2) identify one or more relationships between the newly discovered asset and one or more known assets; and/or (3) etc.

Continuing to Step 4740, the system is configured to use one or more machine learning techniques to categorize one or more data elements from the generated catalog, analyze a flow of the data among the one or more data repositories, and/or classify the one or more data elements based on a confidence score as discussed below.

Continuing to Step 4750, the system, in various embodiments, is configured to receive input from a user confirming or denying a categorization of the one or more data elements, and, in response, modify the confidence score. In various embodiments, the system is configured to iteratively repeat Steps 4740 and 2650. In this way, the system is configured to modify the confidence score in response to a user confirming or denying the accuracy of a categorization of the one or more data elements. For example, in particular embodiments, the system is configured to prompt a user (e.g., a system administrator, privacy officer, etc.) to confirm that a particular data element is, in fact, associated with a particular individual from the catalog. The system may, in various embodiments, be configured to prompt a user to confirm that a data element or attribute discovered during one or more of the scans above were properly categorized at Step 4740.

In particular embodiments, the system is configured to modify the confidence score based at least in part on receiving one or more confirmations that one or more particular data elements or attributes discovered in a particular location during a scan are associated with particular individuals from the catalog. As may be understood in light of this disclosure, the system may be configured to increase the confidence score in response to receiving confirmation that particular types of data elements or attributes discovered in a particular storage location are typically confirmed as being associated with particular individuals based on one or more attributes for which the system was scanning.

### Exemplary Intelligent Identity Scanning Technical Platforms

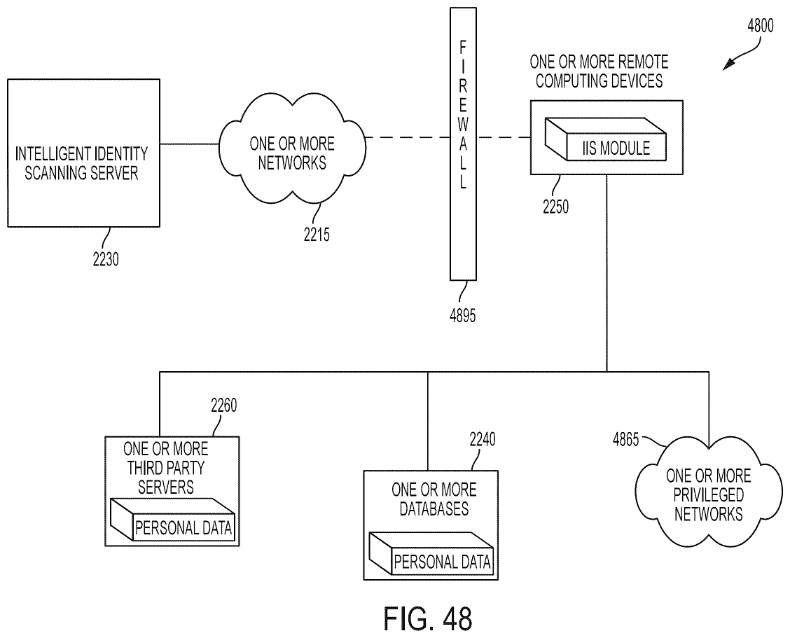

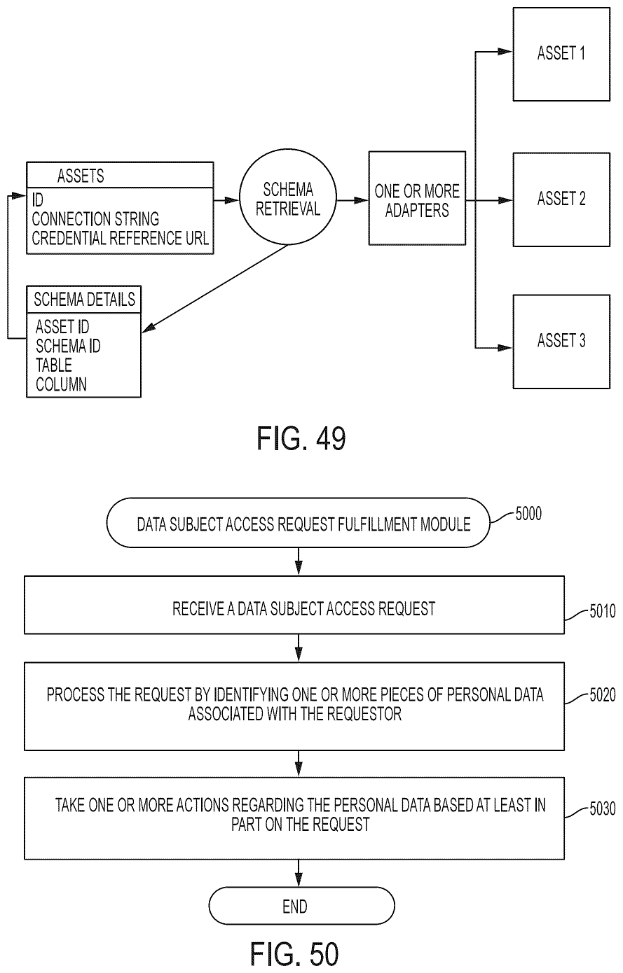

FIG. 48 depicts an exemplary technical platform via which the system may perform one or more of the steps described above with respect to the Intelligent Identity Scanning Module 4700. As shown in the embodiment in this figure, an Intelligent Identity Scanning System 4800 comprises an Intelligent Identity Scanning Server 2230, such as the Intelligent Identity Scanning Server 2230 described above with respect to FIG. 22. The Intelligent Identity Scanning Server 2230 may, for example, comprise a processing engine (e.g., one or more computer processors). In some embodiments, the Intelligent Identity Scanning Server 2230 may include any suitable cloud hosted processing engine (e.g., one or more cloud-based computer servers). In particular embodiments, the Intelligent Identity Scanning Server 2230 is hosted in a Microsoft Azure cloud.

In particular embodiments, the Intelligent Identity Scanning Server 2230 is configured to sit outside one or more firewalls (e.g., such as the firewall 4895 shown in FIG. 48). In such embodiments, the Intelligent Identity Scanning Server 2230 is configured to access One or More Remote Computing Devices 2250 through the Firewall 4895 (e.g., one or more firewalls) via One or More Networks 2215 (e.g., such as any of the One or More Networks 2215 described above with respect to FIG. 22).

In particular embodiments, the One or More Remote Computing Devices 2250 include one or more computing devices that make up at least a portion of one or more computer networks associated with a particular organization. In particular embodiments, the one or more computer networks associated with the particular organization comprise one or more suitable servers, one or more suitable databases, one or more privileged networks, and/or any other suitable device and/or network segment that may store and/or provide for the storage of personal data. In the embodiment shown in FIG. 48, the one or more computer networks associated with the particular organization may comprise One or More Third Party Servers 2260, One or More Databases 2240, etc. In particular embodiments, the One or More Remote Computing Devices 2250 are configured to access one or more segments of the one or more computer networks associated with the particular organization. In some embodiments, the one or more computer networks associated with the particular organization comprise One or More Privileged Networks 4865. In still other embodiments, the one or more computer networks comprise one or more network segments connected via one or more suitable routers, one or more suitable network hubs, one or more suitable network switches, etc.

As shown in FIG. 48, various components that make up one or more parts of the one or more computer networks associated with the particular organization may store personal data (e.g., such as personal data stored on the One or More Third Party Servers 2260, the One or More Databases 2240, etc.). In various embodiments, the system is configured to perform one or more steps related to the Intelligent Identity Scanning Module 4700 in order to identify the personal data for the purpose of generating the catalog of individuals described above (e.g., and/or identify onc or more data assets within the organization's network that store personal data)

As further shown in FIG. 48, in various embodiments, the One or More Remote Computing Devices 2250 may store a software application (e.g., the Intelligent Identity Scanning Module). In such embodiments, the system may be configured to provide the software application for installation on the One or More Remote Computing Devices 2250. In particular embodiments, the software application may comprise one or more virtual machines. In particular embodiments, the one or more virtual machines may be configured to perform one or more of the steps described above with respect to the Intelligent Identity Scanning Module 4700 (e.g., perform the one or more steps locally on the One or More Remote Computing Devices 2250).

In various embodiments, the one or more virtual machines may have the following specifications: (1) any suitable number of cores (e.g., 4, 6, 8, etc.); (2) any suitable amount of memory (e.g., 4 GB, 8 GB, 16 GB etc.); (3) any suitable operating system (e.g., CentOS 7.2); and/or (4) any other suitable specification. In particular embodiments, the one or more virtual machines may, for example, be used for one or more suitable purposes related to the Intelligent Identity Scanning System 4800. These one or more suitable purposes may include, for example, running any of the one or more modules described herein, storing hashed and/or non-hashed information (e.g., personal data, personally identifiable data, catalog of individuals, etc.), storing and running one or more searching and/or scanning engines (e.g., Elasticsearch), etc.

In various embodiments, the Intelligent Identity Scanning System 4800 may be configured to distribute one or more processes that make up part of the Intelligent Identity Scanning Process (e.g., described above with respect to the Intelligent Identity Scanning Module 4700). The one or more software applications installed on the One or more Remote Computing Devices 2250 may, for example, be configured to provide access to the one or more computer networks associated with the particular organization to the Intelligent Identity Scanning Server 2230. The system may then be configured to receive, from the One or more Remote Computing Devices 2250 at the Intelligent Identity Scanning Server 2230, via the Firewall 4895 and One or More Networks 2215, scanned data for analysis.

In particular embodiments, the Intelligent Identity Scanning System 4800 is configured to reduce an impact on a performance of the One or More Remote Computing Devices 2250, One or More Third Party Servers 2260 and other components that make up one or more segments of the one or more computer networks associated with the particular organization. For example, in particular embodiments, the Intelligent Identity Scanning System 4800 may be configured to utilize one or more suitable bandwidth throttling techniques. In other embodiments, the Intelligent Identity Scanning System 4800 is configured to limit scanning (e.g., any of the one or more scanning steps described above with respect to the Intelligent Identity Scanning Module 4700) and other processing steps (e.g., one or more steps that utilize one or more processing resources) to non-peak times (e.g., during the evening, overnight, on weekends and/or holidays, etc.). In other embodiments, the system is configured to limit performance of such processing steps to backup applications and data storage locations. The system may, for example, use one or more sampling techniques to decrease a number of records required to scan during the personal data discovery process.

FIG. 48 depicts an exemplary asset access methodology that the system may utilize in order to access one or more network devices that may store personal data (e.g., or other personally identifiable information). As may be understood from this figure, the system may be configured to access the one or more network devices using a locally deployed software application (e.g., such as the software application described immediately above). In various embodiments, the software application is configured to route identity scanning traffic through one or more gateways, configure one or more ports to accept one or more identity scanning connections, etc.

As may be understood from this figure, the system may be configured to utilize one or more credential management techniques to access one or more privileged network portions. The system may, in response to identifying particular assets or personally identifiable information via a scan, be configured to retrieve schema details such as, for example, an asset ID, Schema ID, connection string, credential reference URL, etc. In this way, the system may be configured to identify and store a location of any discovered assets or personal data during a scan.

### Data Subject Access Request Fulfillment Module

Turning to FIG. 50, in particular embodiments, a Data Subject Access Request Fulfillment Module 5000 is configured to receive a data subject access request, process the request, and fulfill the request based at least in part on one or more request parameters. In various embodiments, an organization, corporation, etc. may be required to provide information requested by an individual for whom the organization stores personal data within a certain time period (e.g., 30 days). As a particular example, an organization may be required to provide an individual with a listing of, for example: (1) any personal data that the organization is processing for an individual, (2) an explanation of the categories of data being processed and the purpose of such processing; and/or (3) categories of third parties to whom the data may be disclosed.

Various privacy and security policies (e.g., such as the European Union's General Data Protection Regulation, and other such policies) may provide data subjects (e.g., individuals, organizations, or other entities) with certain rights related to the data subject's personal data that is collected, stored, or otherwise processed by an organization. These rights may include, for example: (1) a right to obtain confirmation of whether a particular organization is processing their personal data; (2) a right to obtain information about the purpose of the processing (e.g., one or more reasons for which the personal data was collected); (3) a right to obtain information about one or more categories of data being processed (e.g., what type of personal data is being collected, stored, etc.); (4) a right to obtain information about one or more categories of recipients with whom their personal data may be shared (e.g., both internally within the organization or externally); (5) a right to obtain information about a time period for which their personal data will be stored (e.g., or one or more criteria used to determine that time period); (6) a right to obtain a copy of any personal data being processed (e.g., a right to receive a copy of their personal data in a commonly used, machine-readable format); (7) a right to request erasure (e.g., the right to be forgotten), rectification (e.g., correction or deletion of inaccurate data), or restriction of processing of their personal data; and (8) any other suitable rights related to the collection, storage, and/or processing of their personal data (e.g., which may be provided by law, policy, industry or organizational practice, etc.).

As may be understood in light of this disclosure, a particular organization may undertake a plurality of different privacy campaigns, processing activities, etc. that involve the collection and storage of personal data. In some embodiments, each of the plurality of different processing activities may collect redundant data (e.g., may collect the same personal data for a particular individual more than once), and may store data and/or redundant data in one or more particular locations (e.g., on one or more different servers, in one or more different databases, etc.). In this way, a particular organization may store personal data in a plurality of different locations which may include one or more known and/or unknown locations. As such, complying with particular privacy and security policies related to personal data (e.g., such as responding to one or more requests by data subjects related to their personal data) may be particularly difficult (e.g., in terms of cost, time, etc.). In particular embodiments, a data subject access request fulfillment system may utilize one or more data model generation and population techniques (e.g., such as any suitable technique described herein) to create a centralized data map with which the system can identify personal data stored, collected, or processed for a particular data subject, a reason for the processing, and any other information related to the processing.

Turning to FIG. 50, when executing the Data Subject Access Request Fulfillment Module 5000, the system begins, at Step 5010, by receiving a data subject access request. In various embodiments, the system receives the request via a suitable web form. In certain embodiments, the request comprises a particular request to perform one or more actions with any personal data stored by a particular organization regarding the requestor. For example, in some embodiments, the request may include a request to view one or more pieces of personal data stored by the system regarding the requestor. In other embodiments, the request may include a request to delete one or more pieces of personal data stored by the system regarding the requestor. In still other embodiments, the request may include a request to update one or more pieces of personal data stored by the system regarding the requestor. In still other embodiments, the request may include a request based on any suitable right afforded to a data subject, such as those discussed above.

Continuing to Step 5020, the system is configured to process the request by identifying and retrieving one or more pieces of personal data associated with the requestor that are being processed by the system. For example, in various embodiments, the system is configured to identify any personal data stored in any database, server, or other data repository associated with a particular organization. In various embodiments, the system is configured to use one or more data models, such as those described above, to identify this personal data and suitable related information (e.g., where the personal data is stored, who has access to the personal data, etc.). In various embodiments, the system is configured to use intelligent identity scanning (e.g., as described above) to identify the requestor's personal data and related information that is to be used to fulfill the request.

In still other embodiments, the system is configured to use one or more machine learning techniques to identify such personal data. For example, the system may identify particular stored personal data based on, for example, a country in which a website that the data subject request was submitted is based, or any other suitable information.

In particular embodiments, the system is configured to scan and/or search one or more existing data models (e.g., one or more current data models) in response to receiving the request in order to identify the one or more pieces of personal data associated with the requestor. The system may, for example, identify, based on one or more data inventories (e.g., one or more inventory attributes) a plurality of storage locations that store personal data associated with the requestor. In other embodiments, the system may be configured to generate a data model or perform one or more scanning techniques in response to receiving the request (e.g., in order to automatically fulfill the request).

Returning to Step 5030, the system is configured to take one or more actions based at least in part on the request. In some embodiments, the system is configured to take one or more actions for which the request was submitted (e.g., display the personal data, delete the personal data, correct the personal data, etc.). In particular embodiments, the system is configured to take the one or more actions substantially automatically. In particular embodiments, in response a data subject submitting a request to delete their personal data from an organization's systems, the system may: (1) automatically determine where the data subject's personal data is stored; and (2) in response to determining the location of the data (which may be on multiple computing systems), automatically facilitate the deletion of the data subject's personal data from the various systems (e.g., by automatically assigning a plurality of tasks to delete data across multiple business systems to effectively delete the data subject's personal data from the systems). In particular embodiments, the step of facilitating the deletion may comprise, for example: (1) overwriting the data in memory; (2) marking the data for overwrite; (2) marking the data as free (e.g., and deleting a directory entry associated with the data); and/or (3) any other suitable technique for deleting the personal data. In particular embodiments, as part of this process, the system uses an appropriate data model (see discussion above) to efficiently determine where all of the data subject's personal data is stored.

### Data Subject Access Request User Experience

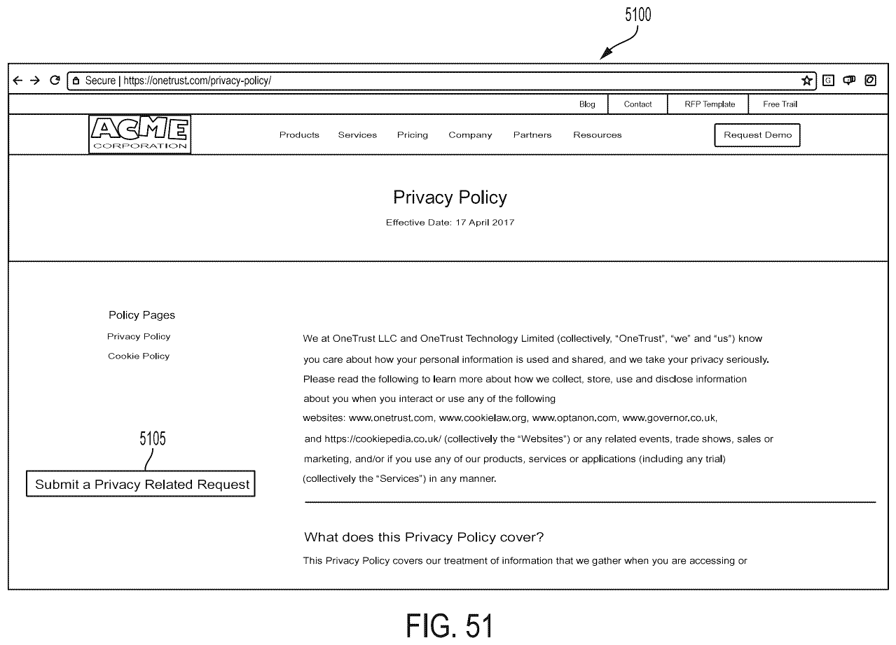

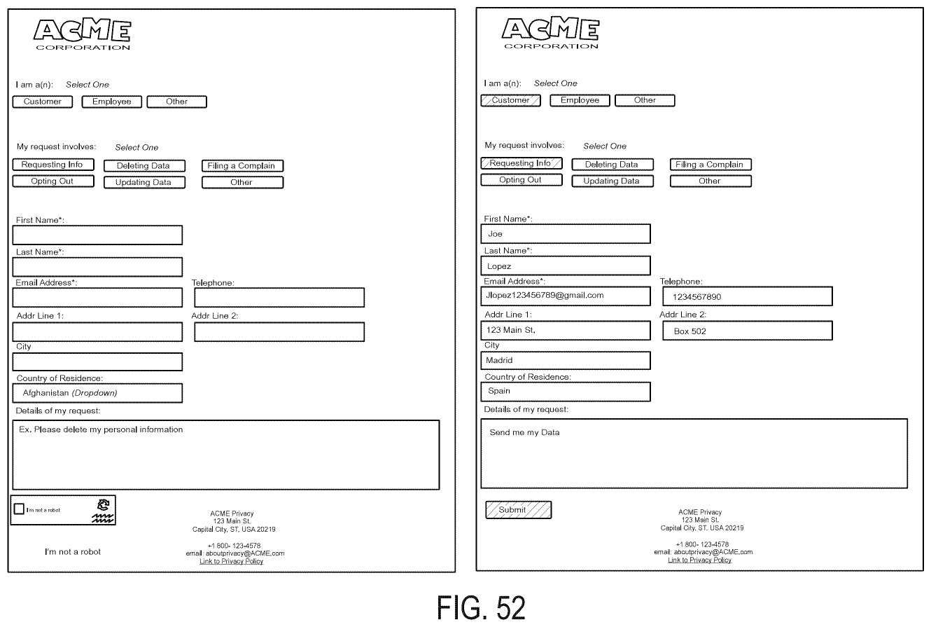

FIGS. 51-52 depict exemplary screen displays that a user may view when submitting a data subject access request. As shown in FIG. 51, a website 5100 associated with a particular organization may include a user-selectable indicia 5105 for submitting a privacy-related request. A user desiring to make such a request may select the indicia 5105 in order to initiate the data subject access request process.

FIG. 52 depicts an exemplary data subject access request form in both an unfilled and filled out state. As shown in this figure, the system may prompt a user to provide information such as, for example: (1) what type of requestor the user is (e.g., employee, customer, etc.); (2) what the request involves (e.g., requesting info, opting out, deleting data, updating data, etc.); (3) first name; (4) last name; (5) email address; (6) telephone number; (7) home address; and/or (8) one or more details associated with the request.

As discussed in more detail above, a data subject may submit a subject access request, for example, to request a listing of any personal information that a particular organization is currently storing regarding the data subject, to request that the personal data be deleted, to opt out of allowing the organization to process the personal data, etc.

### Alternative Embodiments

In particular embodiments, a data modeling or other system described herein may include one or more features in addition to those described. Various such alternative embodiments are described below.

### Processing Activity and Data Asset Assessment Risk Flagging

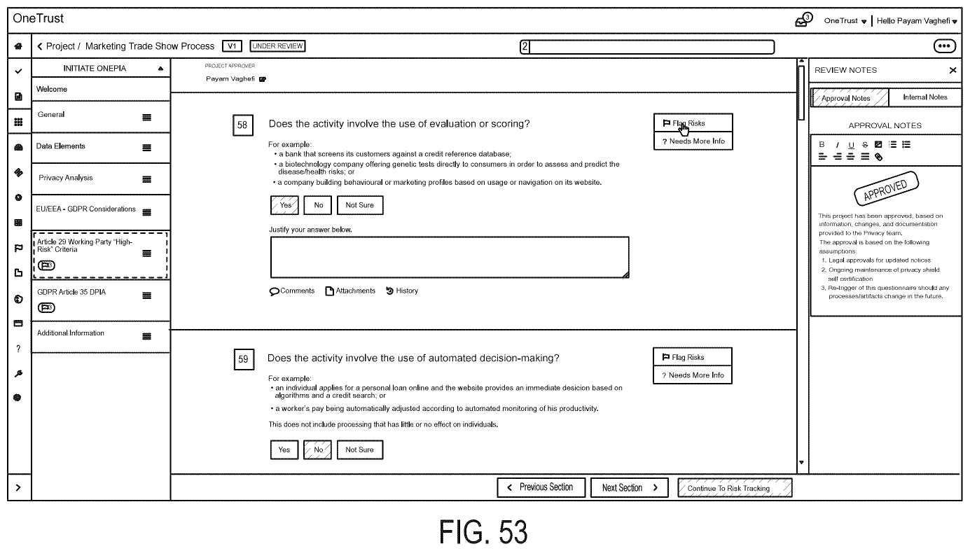

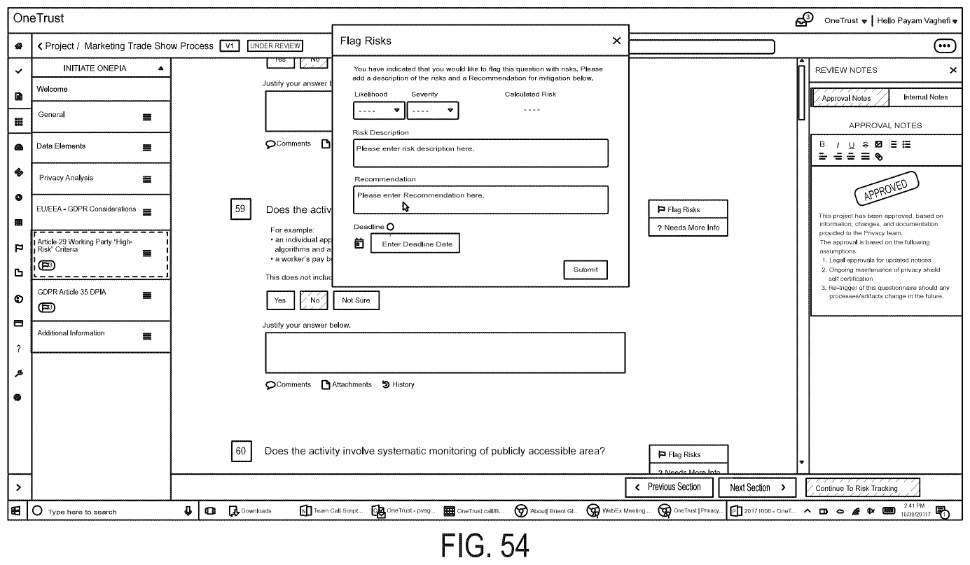

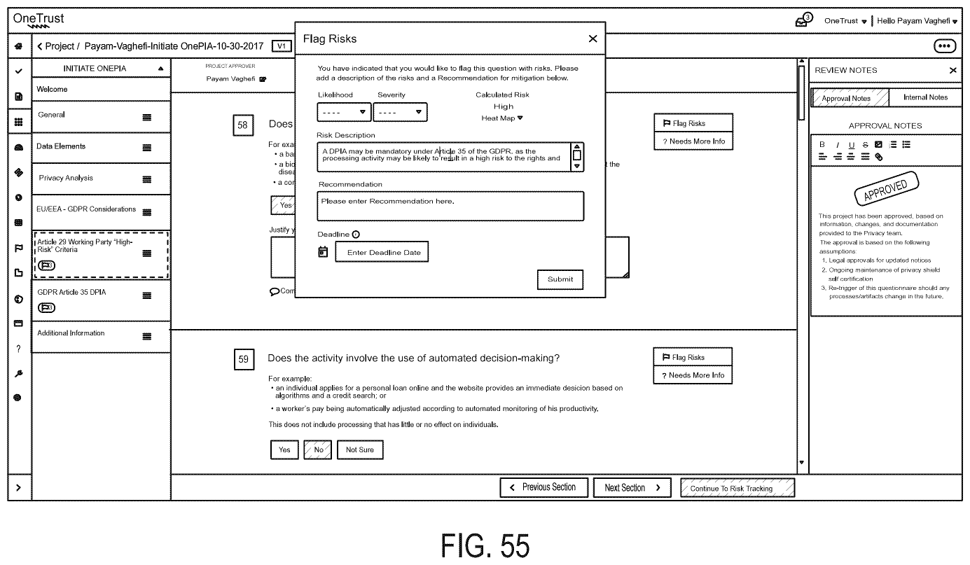

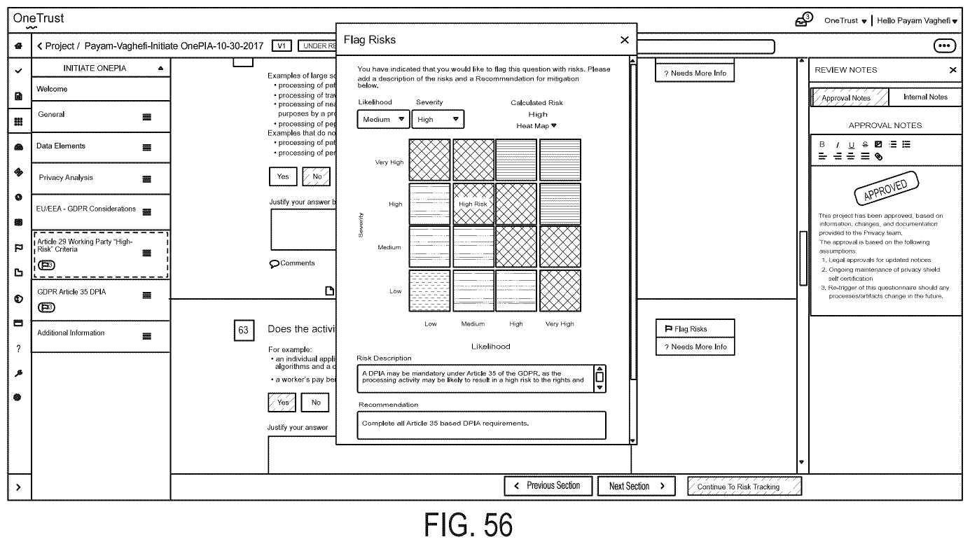

In particular embodiments, the questionnaire template generation system and assessment system described herein may incorporate one or more risk flagging systems. FIGS. 53-56 depict exemplary user interfaces that include risk flagging of particular questions within a processing activity assessment. As may be understood from these figures, a user may select a flag risk indicia to provide input related to a description of risks and mitigation of a risk posed by one or more inventory attributes associated with the question. As shown in these figures, the system may be configured to substantially automatically assign a risk to a particular response to a question in a questionnaire. In various embodiments, the assigned risk is determined based at least in part on the template from which the assessment was generated.

In particular embodiments, the system may utilize the risk level assigned to particular questionnaire responses as part of a risk analysis of a particular processing activity or data asset. Various techniques for assessing the risk of various privacy campaigns are described in U.S. patent application Ser. No. 15/256,419, filed Sep. 2, 2016, entitled “Data processing systems and methods for operationalizing privacy compliance and assessing the risk of various respective privacy campaigns,” which is hereby incorporated herein in its entirety.

### CONCLUSION

Although embodiments above are described in reference to various systems and methods for performing privacy assessments and monitoring new versions of computer code for updated features and conditions that relate to compliance with privacy standards, it should be understood that various aspects of the system described above may be applicable to other privacy-related systems, or to other types of systems, in general. While this specification contains many specific embodiment details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Many modifications and other embodiments of the invention will come to mind to one skilled in the art to which this invention pertains having the benefit of the teachings presented in the foregoing descriptions and the associated drawings. While examples discussed above cover the use of various embodiments in the context of operationalizing privacy compliance and assessing risk of privacy campaigns, various embodiments may be used in any other suitable context. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

1. A method comprising:
identifying a first version of software;
determining that a second version of the software has been released, wherein the second version of the software is configured to perform functionality that the first version of the software is not configured to perform; and
receiving information regarding the functionality for use in conducting an assessment of the software.

2. The method of claim 1, wherein the functionality comprises collecting or accessing personal data.

3. The method of claim 1, wherein determining that the second version of the software has been released further comprises detecting a use of the second version of the software, wherein the use of the second version of the software includes at least one of detecting a location of a user computing device, encrypting data of the user computing device, calling a third-party computer code, modifying a communication log, and tracking a user behavior using a cookie.

4. The method of claim 1, wherein determining that the second version of the software has been released further comprises detecting a performance of the second version of the software, the performance of the second version of the software comprising image analysis, speech recognition, use of a machine-learning algorithm, pattern recognition, or voice-to-text conversion.

5. The method of claim 1, wherein the information regarding the functionality identifies at least one of a reason or purpose for the functionality, data that is used in training the functionality, a procedure used in maintaining the functionality, or a procedure used in monitoring a performance of the functionality.

6. The method of claim 1, further comprising:
determining, based on the information, a type of personal data collected by the software; and
determining, based on at least one of the type of the personal data, a risk rating associated with the software performing the functionality.

7. The method of claim 6, wherein the risk rating provides a measure of the second version of the software performing the functionality in at least one of an unintended manner, an undesired manner, or an inappropriate manner.

8. An apparatus comprising:
one or more processors; and
a memory storing processor-executable instructions that, when executed by the one or more processors, cause the apparatus to:
identify a first version of software;
determine that a second version of the software has been released, wherein the second version of the software is configured to perform functionality that the first version of the software is not configured to perform; and
receive information regarding the functionality for use in conducting an assessment of the software.

9. The apparatus of claim 8, wherein the functionality comprises collecting or accessing personal data.

10. The apparatus of claim 8, wherein the instructions that determine that the second version of the software has been released, when executed by the one or more processors, further cause the apparatus to detect a use of the second version of the software, wherein the use of the second version of the software includes at least one of detecting a location of a user computing device, encrypting data of the user computing device, calling a third-party computer code, modifying a communication log, and tracking a user behavior using a cookie.

11. The apparatus of claim 8, wherein the instructions that determine that the second version of the software has been released, when executed by the one or more processors, further cause the apparatus to detecting a performance of the second version of the software, the performance of the second version of the software comprising image analysis, speech recognition, use of a machine-learning algorithm, pattern recognition, or voice-to-text conversion.

12. The apparatus of claim 8, wherein the information regarding the functionality identifies at least one of a reason or purpose for the functionality, data that is used in training the functionality, a procedure used in maintaining the functionality, or a procedure used in monitoring a performance of the functionality.

13. The apparatus of claim 8, wherein the instructions, when executed by the one or more processors, further cause the apparatus to:
determine, based on the information, a type of personal data collected by the software; and
determine, based on at least one of the type of the personal data, a risk rating associated with the software performing the functionality.

14. The apparatus of claim 13, wherein the risk rating provides a measure of the second version of the software performing the functionality in at least one of an unintended manner, an undesired manner, or an inappropriate manner.

15. One or more non-transitory computer-readable media storing processor-executable instructions that, when executed by at least one processor, cause the at least one processor to:
identify a first version of software;
determine that a second version of the software has been released, wherein the second version of the software is configured to perform functionality that the first version of the software is not configured to perform; and
receive information regarding the functionality for use in conducting an assessment of the software.

16. The one or more non-transitory computer-readable media of claim 15, wherein the functionality comprises collecting or accessing personal data.

17. The one or more non-transitory computer-readable media of claim 15, wherein the instructions that determine that the second version of the software has been released, when executed by the at least one processor, further cause at least one processor to detect a use of the second version of the software, wherein the use of the second version of the software includes at least one of detecting a location of a user computing device, encrypting data of the user computing device, calling a third-party computer code, modifying a communication log, and tracking a user behavior using a cookie.

18. The one or more non-transitory computer-readable media of claim 15, wherein the instructions that determine that the second version of the software has been released, when executed by the at least one processor, further cause the at least one processor to detect a performance of the second version of the software, the performance of the second version of the software comprising image analysis, speech recognition, use of a machine-learning algorithm, pattern recognition, or voice-to-text conversion.

19. The one or more non-transitory computer-readable media of claim 15, wherein the information regarding the functionality identifies at least one of a reason or purpose for the functionality, data that is used in training the functionality, a procedure used in maintaining the functionality, or a procedure used in monitoring a performance of the functionality.

20. The one or more non-transitory computer-readable media of claim 15, wherein the instructions, when executed by the at least one processor, further cause the at least one processor to:
determine, based on the information, a type of personal data collected by the software; and
determine, based on at least one of the type of the personal data, a risk rating associated with the software performing the functionality.
